(19) United States
(12) Patent Application Publication
(10) Pub. No.: US 2026/0219626 A1
(43) Pub. Date: Jul. 30, 2026

(54) IMAGE FORMING APPARATUS

(71) Applicant: CANON KABUSHIKI KAISHA, Tokyo (JP)

(72) Inventors: MOTOHIRO FURUSAWA, Shizuoka (JP); KEN YOKOYAMA, Shizuoka (JP)

(21) Appl. No.: 19/457,293

(22) Filed: Jan. 23, 2026

(30) Foreign Application Priority Data
Jan. 28, 2025 (JP) 2025-012297

(51) Int. Cl. G03G 15/00

(52) U.S. Cl. CPC G03G 15/657; G03G 2215/00675

(57) ABSTRACT

An image forming apparatus includes a transfer unit, a fixing unit, a guide unit, an elastic member, and a regulating member. The guide unit guides a recording material from a transfer position toward a fixing position and includes a guide member movable between a first position and a second position. The elastic member biases the guide member toward the first position. The regulating member regulates movement of the guide member by contacting the guide member at the first position. The guide member includes a pressed portion for receiving a pressing force to move the guide member from the first position to the second position, and a plurality of contacting portions configured to contact the regulating member at different positions in a width direction. The pressed portion and the plurality of contacting portions are formed integrally with the guide member.

### BACKGROUND

### Field of the Technology

The present disclosure relates to an image forming apparatus.

### Description of the Related Art

In general, an image forming apparatus of an electrophotographic type develops an electrostatic latent image formed on a surface of a photosensitive body to form a toner image, transfers the formed toner image onto a recording material, and fixes the transferred toner image on the recording material by heating and pressurizing the toner image with rollers of a fixing apparatus. Especially, in many cases, a conveyance guide is disposed downstream of a transfer position so that the recording material that has passed through the transfer position can be passed to the fixing apparatus in a stable attitude.

A conveyance speed at which the rollers of the fixing apparatus convey recording materials in a sandwiching manner is not always constant due to, for example, thermal expansion of the rollers. When the conveyance speed by the fixing apparatus is slower than a speed of the recording material passing through the transfer position, a recording material is warped between the transfer position and a fixing position. Japanese Patent Laid-Open No. 2000-226136 discloses a configuration in which a position of a conveyance guide is changed by a warping force of recording materials so that the recording materials can be stably guided to a fixing apparatus while absorbing such warp of the recording materials.

However, there remains room for improvement in the disclosed configuration of the conveyance guide.

### SUMMARY

The present disclosure aims to realize an improved mechanism for stably conveying a recording material that has passed through a transfer position toward a fixing apparatus.

One aspect of the present disclosure provides an image forming apparatus comprising: a transfer unit configured to transfer a toner image to a recording material at a transfer position; a fixing unit configured to fix the toner image to the recording material at a fixing position; a guide unit configured to guide the recording material from the transfer position toward the fixing position, the guide unit including a guide member extending in a width direction and a length direction of the guided recording material, the guide member being supported so as to be movable between a first position and a second position in a movement direction that is different from the width direction and the length direction; an elastic member configured to bias the guide member from the second position toward the first position; and at least one regulating member configured to regulate movement of the guide member in the movement direction by contacting the guide member when the guide member is positioned in the first position, wherein the guide member includes a pressed portion configured to receive a pressing force for movement of the guide member from the first position to the second position, and a plurality of contacting portions configured to contact the regulating member at different positions in the width direction, and wherein the pressed portion and the plurality of contacting portions are formed integrally with the guide member.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic cross-sectional view illustrating an example of a schematic configuration of an image forming apparatus in a first embodiment.

FIG. 2 is a partial cross-sectional view illustrating a state where a guide member is at a first position in the first embodiment.

FIG. 3 is a partial cross-sectional view illustrating a state where the guide member is at a second position in the first embodiment.

FIG. 4 is a perspective view illustrating an example of a detailed configuration of the guide member in the first embodiment.

FIG. 5 is a perspective view illustrating an example of a detailed configuration of a conveyance frame unit in the first embodiment.

FIG. 6 is a cross-sectional view illustrating a drive transmission mechanism in the state where the guide member is at the first position in the first embodiment.

FIG. 7 is a cross-sectional view illustrating the drive transmission mechanism in the state where the guide member is at the second position in the first embodiment.

FIG. 8 is a perspective view illustrating an example of a positional relationship between a conveyance guide and a first fixed guide in the first embodiment.

FIG. 9 is a schematic cross-sectional view illustrating an example of a schematic configuration of an image forming apparatus in a second embodiment.

FIG. 10 is a cross-sectional view illustrating how a fixing unit is attached to a housing in the second embodiment.

FIG. 11A is an exploded perspective view illustrating how a conveyance frame unit is positioned in a modified example of the second embodiment.

FIG. 11B is an exploded perspective view illustrating how the conveyance frame unit is positioned in the modified example of the second embodiment.

FIG. 12A is a first perspective view illustrating a first configuration example for mitigating a collision sound in a third embodiment.

FIG. 12B is a second perspective view illustrating the first configuration example for mitigating a collision sound in the third embodiment.

FIG. 13A is a first perspective view illustrating a second configuration example for mitigating a collision sound in the third embodiment.

FIG. 13B is a second perspective view illustrating the second configuration example for mitigating a collision sound in the third embodiment.

FIG. 14A is a first perspective view illustrating a third configuration example for mitigating a collision sound in the third embodiment.

FIG. 14B is a second perspective view illustrating the third configuration example for mitigating a collision sound in the third embodiment.

FIG. 15A is a first perspective view illustrating a fourth configuration example for mitigating a collision sound in the third embodiment.

FIG. 15B is a second perspective view illustrating the fourth configuration example for mitigating a collision sound in the third embodiment.

FIG. 16A is a first perspective view illustrating a first configuration example for mitigating a collision sound in a fourth embodiment.

FIG. 16B is a second perspective view illustrating the first configuration example for mitigating a collision sound in the fourth embodiment.

FIG. 17A is a first perspective view illustrating a second configuration example for mitigating a collision sound in the fourth embodiment.

FIG. 17B is a second perspective view illustrating the second configuration example for mitigating a collision sound in the fourth embodiment.

FIG. 18A is a first perspective view illustrating a third configuration example for mitigating a collision sound in the fourth embodiment.

FIG. 18B is a second perspective view illustrating the third configuration example for mitigating a collision sound in the fourth embodiment.

FIG. 19A is a first perspective view illustrating a fourth configuration example for mitigating a collision sound in the fourth embodiment.

FIG. 19B is a second perspective view illustrating the fourth configuration example for mitigating a collision sound in the fourth embodiment.

FIG. 20A is a first partial perspective view illustrating an example of a configuration of a regulating member in a fifth embodiment.

FIG. 20B is a second partial perspective view illustrating an example of the configuration of the regulating member in the fifth embodiment.

FIG. 21A is a first partial perspective view illustrating an example of a configuration of a regulating member in a sixth embodiment.

FIG. 21B is a second partial perspective view illustrating an example of the configuration of the regulating member in the sixth embodiment.

FIG. 22 is a partial cross-sectional view for describing mounting of a fixing unit to an image forming apparatus in the sixth embodiment.

FIG. 23A is a first partial cross-sectional view illustrating an example of a configuration of a regulating member in a seventh embodiment.

FIG. 23B is a second partial cross-sectional view illustrating an example of the configuration of the regulating member in the seventh embodiment.

FIG. 24 is a first partial cross-sectional view for describing attachment and detachment of a fixing unit to and from an image forming apparatus in the seventh embodiment.

FIG. 25 is a second partial cross-sectional view for describing the attachment and detachment of the fixing unit to and from the image forming apparatus in the seventh embodiment.

FIG. 26 is a partial cross-sectional view related to a comparative example without snap fitting in contrast to FIG. 24.

FIG. 27 is a partial perspective view illustrating an example of a configuration of a guide member in an eighth embodiment.

FIG. 28 is a partial perspective view illustrating an example of a configuration of a guide member according to a modified example of the eighth embodiment.

FIG. 29 is a partial perspective view illustrating a drive transmission mechanism in a state where a guide member is at a first position in a ninth embodiment.

FIG. 30 is a partial perspective view illustrating the drive transmission mechanism in a state where the guide member is at a second position in the ninth embodiment.

FIG. 31 is a schematic cross-sectional view illustrating an example of a schematic configuration of an image forming apparatus according to a modified example of the ninth embodiment.

FIG. 32 is a cross-sectional view illustrating a drive transmission mechanism in a state where a guide member is at a first position in a tenth embodiment.

FIG. 33 is a cross-sectional view illustrating the drive transmission mechanism in a state where the guide member is at a second position in the tenth embodiment.

FIG. 34 is a schematic cross-sectional view illustrating an example of a schematic configuration of an image forming apparatus in an eleventh embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment

### 1-1. Schematic Configuration of Apparatus

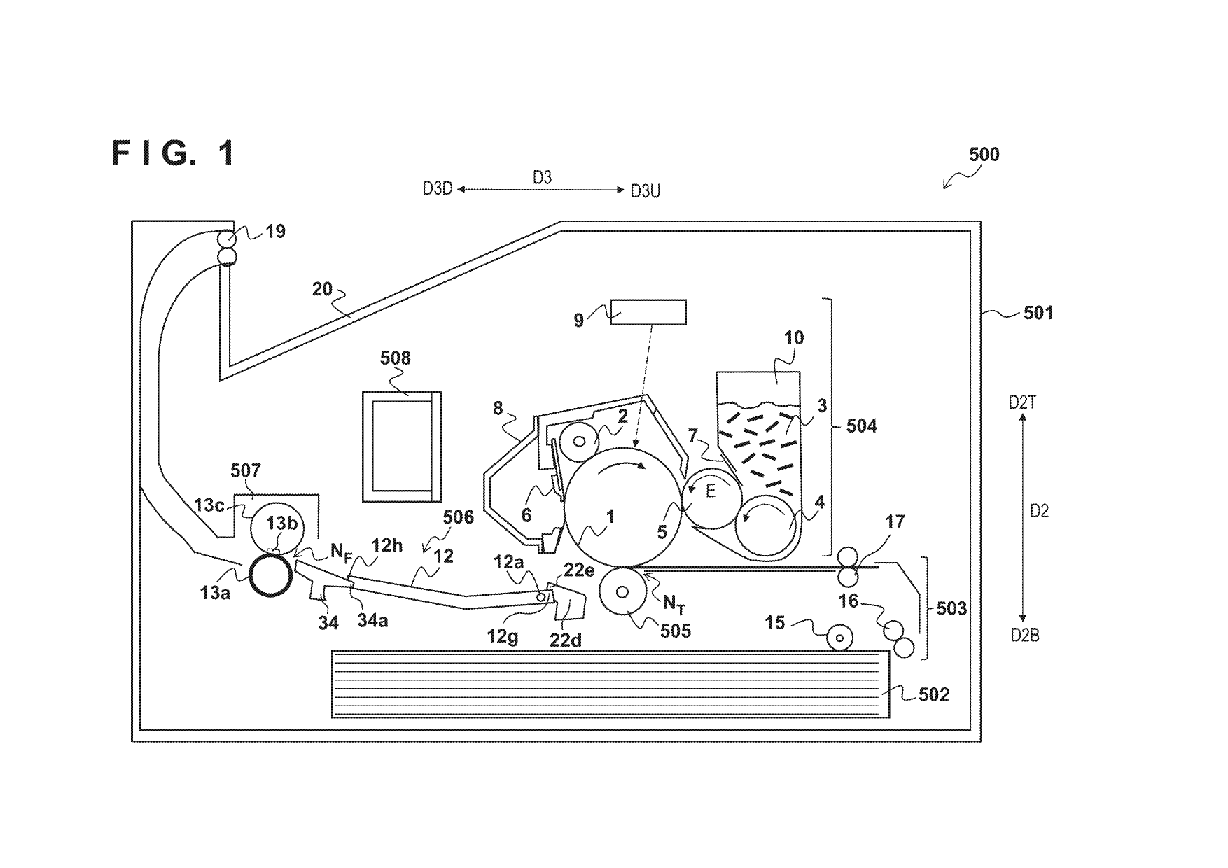

FIG. 1 is a schematic cross-sectional view illustrating an example of a schematic configuration of an image forming apparatus 500 in a first embodiment of the technology according to the present disclosure. Referring to FIG. 1, the image forming apparatus 500 includes a housing 501, a cassette 502, a conveyance mechanism 503, an image forming unit 504, a transfer roller 505, a conveyance guide 506, a fixing unit 507, and a duct 508. The housing 501 accommodates the cassette 502, the conveyance mechanism 503, the image forming unit 504, the transfer roller 505, the conveyance guide 506, and the fixing unit 507. A part of an upper surface of the housing 501 is used as a discharge tray 20, and a discharge port 19 is open toward the discharge tray 20.

In the example of FIG. 1, the image forming unit 504, which is configured as a process cartridge, includes a drum unit 8, an exposure unit 9, and a development unit 10. The drum unit 8 includes a photosensitive drum (also referred to as a photosensitive body) 1, a charging roller 2, and a cleaning blade 6. A surface of the photosensitive drum 1 is a photosensitive layer. The exposure unit 9 is configured as a scanner unit including, for example, a light source that emits a laser beam and a polygon mirror that deflects the laser beam emitted from the light source. The development unit 10 includes a toner storage 3, a supply roller 4, a development roller 5, and an application blade 7. The toner storage 3 stores toner.

A charging bias is applied to the charging roller 2 and the charging roller 2 uniformly charges the surface of the photosensitive drum 1 rotating at a predetermined process speed. The exposure unit 9 irradiates the photosensitive drum 1 with a laser beam modulated based on input image data while scanning the laser beam in a main scanning direction parallel to an axial direction of the photosensitive drum 1. This causes an electrostatic latent image to be formed on the surface of the photosensitive drum 1. The supply roller 4 supplies toner in the toner storage 3 to the development roller 5. The application blade 7 evenly applies the toner supplied by the supply roller 4 on a surface of the development roller 5. A development bias is applied to the development roller 5, and the development roller 5 develops the electrostatic latent image on the surface of the photosensitive drum 1 with the applied toner while rotating in a direction of an arrow E in the figure, and forms a toner image.

The cassette 502 is a container unit for containing a bundle of recording materials (also referred to as sheets). The conveyance mechanism 503 includes rollers disposed along a conveyance path, such as a feeding roller 15, a separation roller 16, and a registration roller 17. The feeding roller 15 picks up a recording material from the cassette 502 and feeds it to the conveyance path. The separation roller 16 separates recording materials to be fed from the sheet bundle one by one. The registration roller 17 corrects skew of a recording material conveyed along the conveyance path and sends the recording material to a transfer position (hereinafter, referred to as a transfer nip) N_{T} in synchronization with a timing at which the toner image on the rotating photosensitive drum 1 arrives at the transfer nip N_{T}.

The transfer roller 505 serves as a transfer unit and is disposed so as to face the photosensitive drum 1 at the transfer nip N_{T}. A transfer voltage is applied to the transfer roller 505 and the transfer roller 505 transfers the toner image on the surface of the photosensitive drum 1 onto the recording material passing through the transfer nip N_{T}. The cleaning blade 6 removes the toner remaining on the surface of the photosensitive drum 1 after the transfer of the toner image. Note that the cleaning blade 6 may be omitted from the configuration of the drum unit 8, and the toner remaining on the surface of the photosensitive drum 1 may be collected and reused for development.

The conveyance guide 506 is a guide unit that guides the recording material to which the transferred toner image has been transferred from the transfer nip N_{T} toward a fixing position (hereinafter, referred to as a fixing nip) N_{F} of the fixing unit 507. In the example of FIG. 1, a post-transfer guide 22d is disposed between the transfer roller 505 and the conveyance guide 506, and the recording material that has passed through the transfer nip N_{T} is passed from the transfer roller 505 through the post-transfer guide 22d to the conveyance guide 506. Note, however, that the post-transfer guide 22d may be omitted from the configuration of the image forming apparatus 500.

The conveyance guide 506 includes a guide member 12 extending in a width direction D1 of the guided recording material (direction perpendicular to the paper surface of FIG. 1) and a length direction D3 of the guided recording material. The guide member 12 is supported so as to be movable between two different positions in a movement direction D2 that is different from the width direction D1 and the length direction D3. In the present embodiment, the movement of the guide member 12 is realized as rotation around a rotation axis 12a of the guide member 12. In other words, the guide member 12 is rotatable between two different positions. A more detailed configuration of the guide member 12 will be further described below.

The fixing unit 507 includes a pressurizing roller 13a, a fixing film 13c, and a first fixed guide 34. The pressurizing roller 13a is disposed so as to face the fixing film 13c at the fixing nip N_{F}. The fixing film 13c, which is an endless film member, has a plate-like ceramic heater 13b inside thereof. The first fixed guide 34 is disposed in a fixed manner with respect to the fixing unit 507 and guides a recording material passed from the conveyance guide 506 to the fixing nip N_{F}.

When a fixing operation is performed, the pressurizing roller 13a is rotationally driven by a motor (not illustrated) and conveys, together with the fixing film 13c, the recording material that has reached the fixing nip N_{F} in a sandwiching manner while pressurizing the recording material. The ceramic heater 13b heats the fixing film 13c to a fixing temperature. The heat of the fixing film 13c melts the toner of the transferred toner image on the recording material, and the pressure from the pressurizing roller 13a fixes the toner image to the recording material. The recording material that has passed through the fixing nip N_{F} is further conveyed along the conveyance path and discharged from the discharge port 19 to the discharge tray 20.

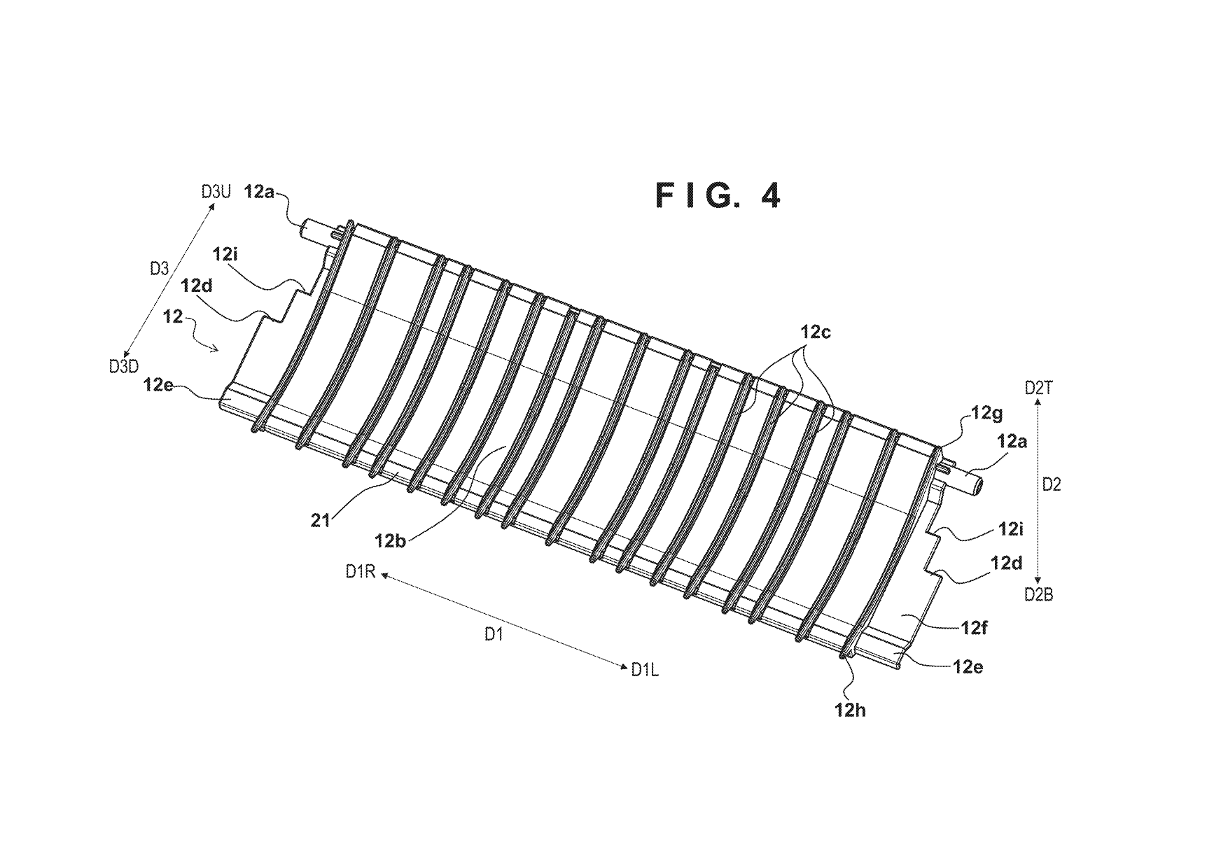

Hereinafter, the width direction D1 of the recording material and the guide member 12 is simply referred to as a direction D1. The direction D1 is parallel to a rotation axis of the photosensitive drum 1. The front side and the back side of the paper surface of FIG. 1 correspond to a left side and a right side, respectively, as viewed from an upstream toward a downstream of a conveyance direction of the recording material, and thus these sides are referred to as a left side D1L and a right side D1R, respectively (see FIG. 4). It should be noted that the terms 'left side D1L' and 'right side D1R' in the present specification do not necessarily indicate the left and right in the attached drawings. The length direction D3 of the recording material and the guide member 12 is simply referred to as a direction D3. Between the transfer nip N_{T} and the fixing nip N_{F}, the direction D3 is substantially the same as the conveyance direction of the recording material. Thus, the upstream side and the downstream side of the conveyance direction are referred to as an upstream side D3U and a downstream side D3D in the direction D3, respectively. In a direction D2 intersecting the direction D1 and the direction D3, an upward-facing side is referred to as an upper side D2T, and a downward-facing side is referred to as a lower side D2B (see FIG. 1).

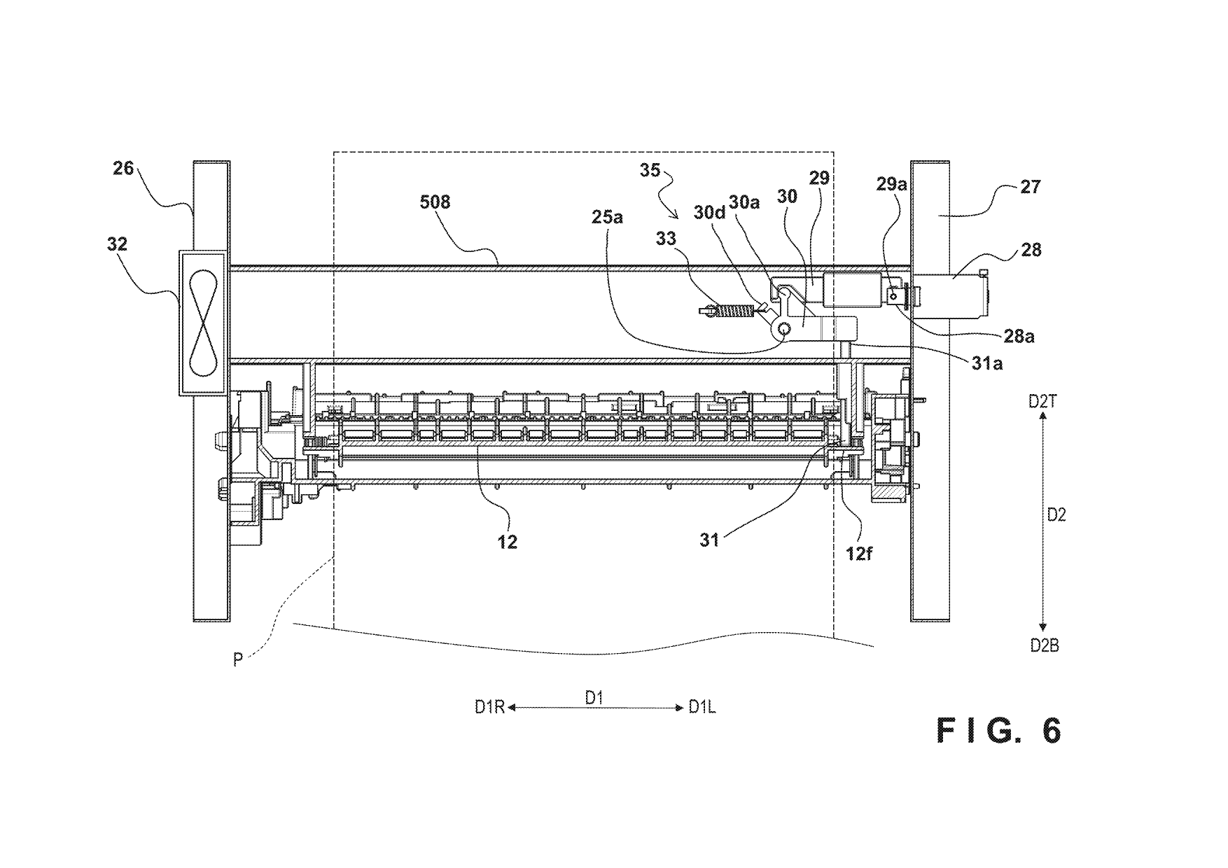

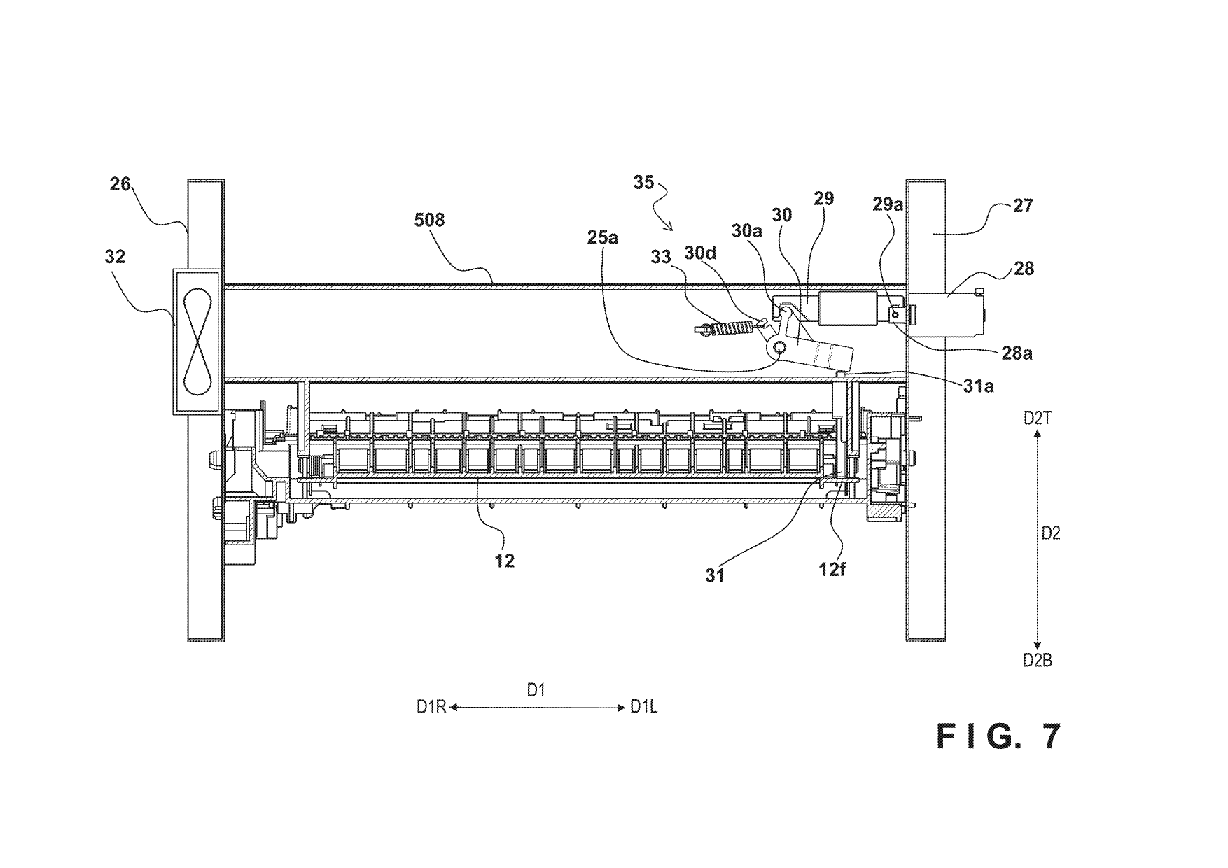

The duct 508, which is disposed between the image forming unit 504 and the fixing unit 507 and above the conveyance guide 506, is a tubular structure used for internal ventilation of the housing 501 of the image forming apparatus 500. As illustrated in FIGS. 6 and 7, the duct 508 spans from a right wall 26 to a left wall 27 of the housing 501. A fan 32 for discharging the air in the housing 501 is disposed at an end of the duct 508 (an end at the right side D1R in the example of FIGS. 6 and 7). The fan 32 discharges the air heated due to the fixing operation of the fixing unit 507 to the outside of the housing 501, thereby preventing abnormality such as thermal deformation of constituent elements of the image forming unit 504 and other units and denaturation of the toner.

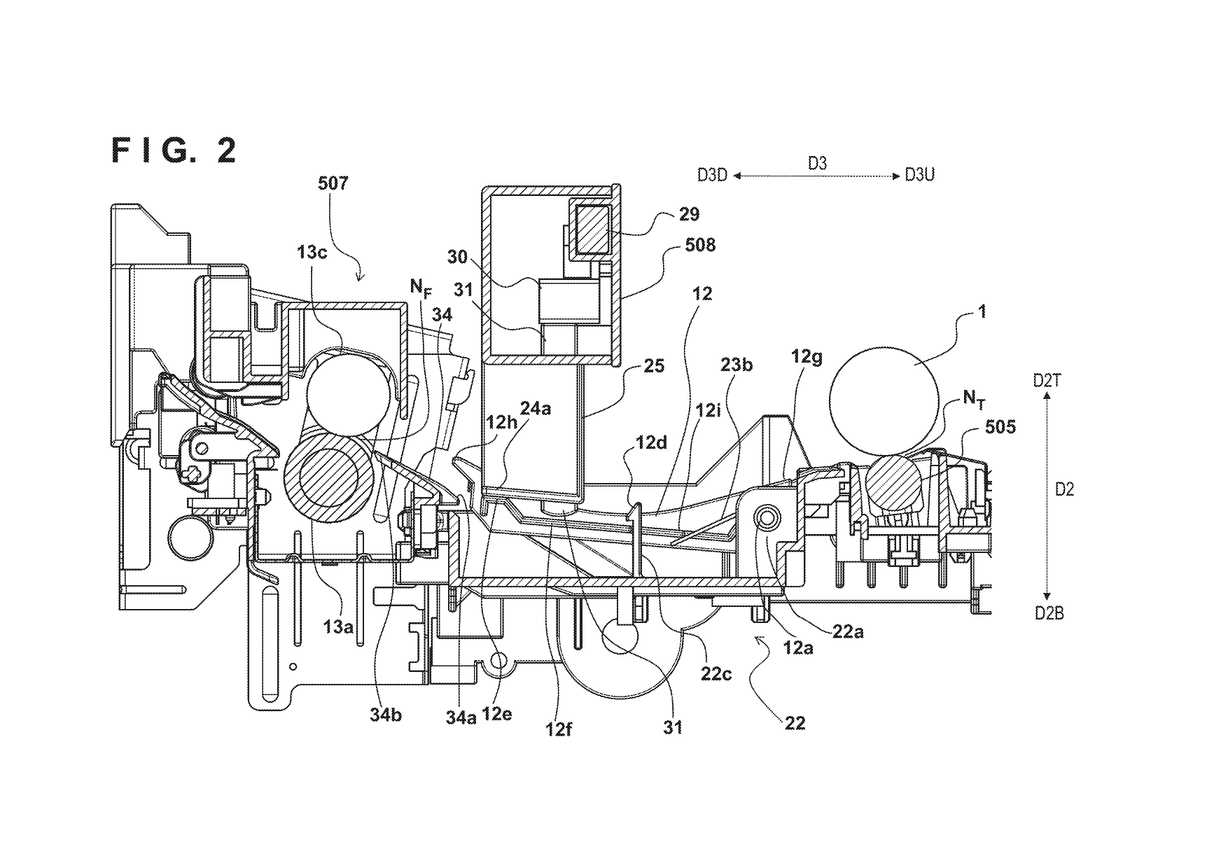

Further, in the present embodiment, the duct 508 contains a part of a mechanism for controlling movement of the guide member 12. Some constituent elements of such a mechanism are illustrated in FIG. 2. Controlling the movement of the guide member 12 will be described in detail below.

### 1-2. Movement of Guide Member

The pressurizing roller 13a of the fixing unit 507 is constituted by, for example, a core metal and a silicone rubber covering the core metal. When the pressurizing roller 13a changes from a low-temperature state to a high-temperature state along with repetitions of the fixing operation, the diameter of the pressurizing roller 13a increases due to expansion of the silicone rubber, and a conveyance speed of a recording material by the fixing unit 507 increases. If a conveyance speed V_{F} at the fixing nip N_{F} exceeds a conveyance speed V_{T} of a recording material at the transfer nip N_{T}, the fixing unit 507 pulls the recording material, resulting in degradation in the toner image transferred onto the recording material at the transfer nip N_{T}. In order to avoid the degradation, a rotation speed of the pressurizing roller 13a is previously set such that the maximum value V_{F_max} of the conveyance speed V_{F} at the fixing nip N_{F}, which fluctuates due to the expansion of the silicone rubber, is substantially equal to the conveyance speed V_{T} at the transfer nip N_{T}. Thus, when the pressurizing roller 13a is in the low-temperature state, the conveyance speed V_{F} at the fixing nip N_{F} is slower than the conveyance speed V_{T} at the transfer nip N_{T}. This speed difference causes a central portion of a recording material to be warped. If the space above the guide member 12 of the conveyance guide 506 is not sufficient to accommodate the length of the recording material being conveyed, the central portion of the recording material forms a loop protruding upward, and there is a risk of degradation of the toner image when an outer surface of the loop is rubbed by another structural body (for example, the drum unit 8). Therefore, in the present embodiment, as described above, the guide member 12 of the conveyance guide 506 is configured such that the guide member 12 can move between a first position and a second position in the direction D2, thereby securing the space for absorbing warp of recording materials.

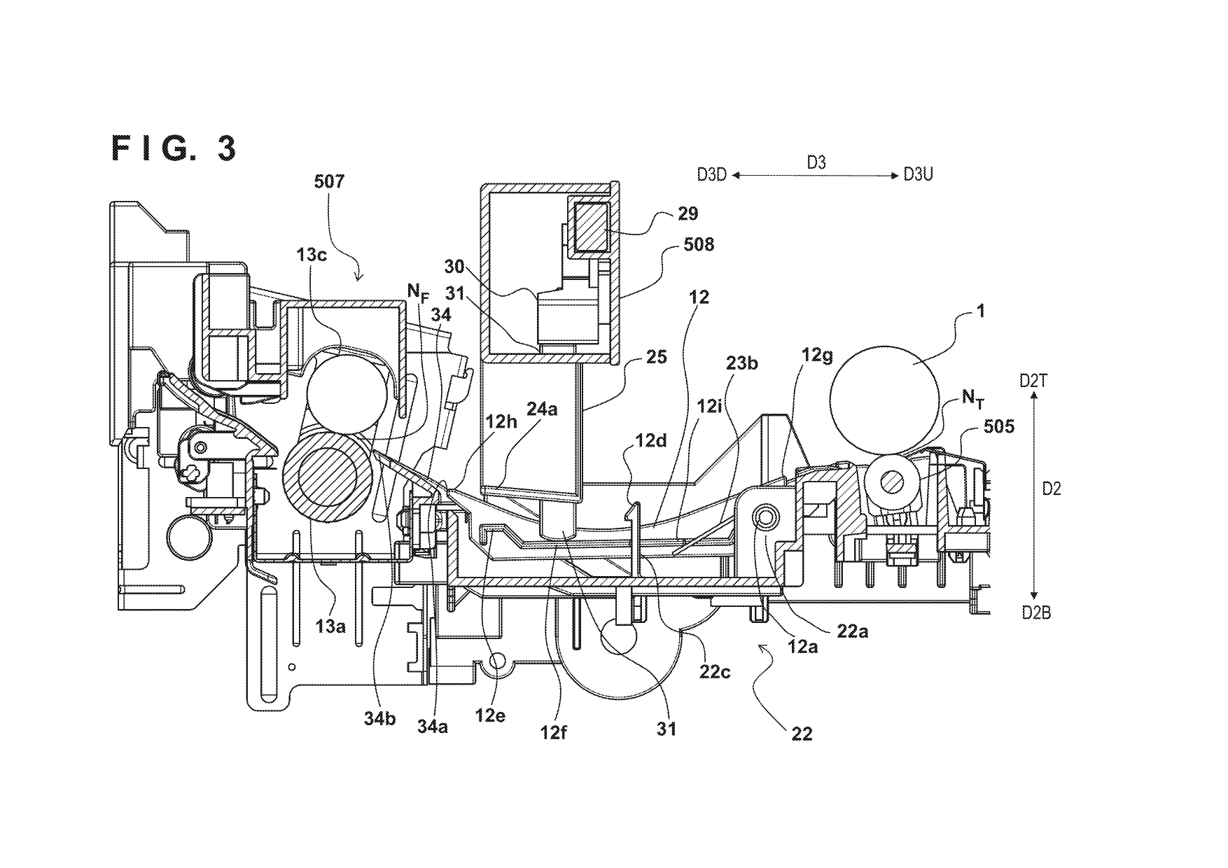

FIG. 2 is a partial cross-sectional view illustrating a state where the guide member 12 is at the first position, and FIG. 3 is a partial cross-sectional view illustrating a state where the guide member 12 is at the second position.

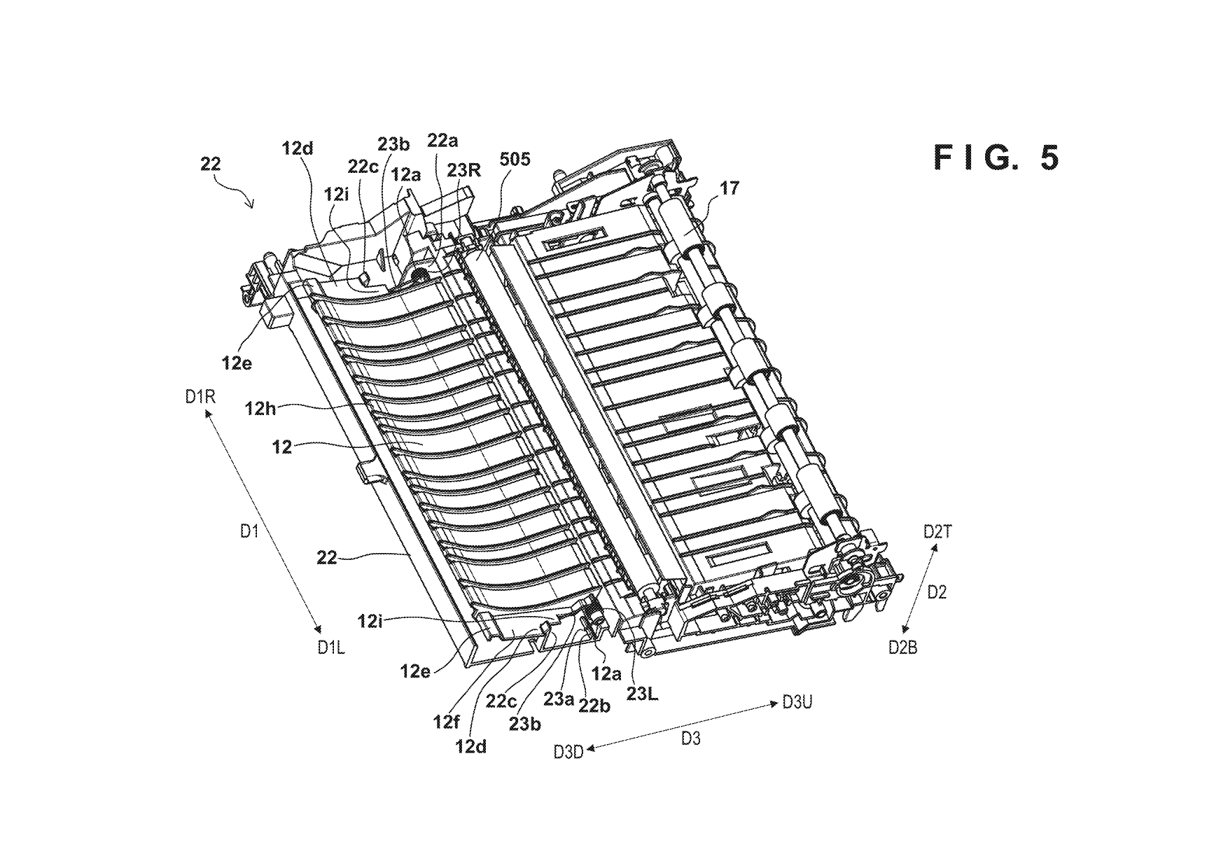

The image forming apparatus 500 includes an elastic member biasing the guide member 12 from the second position toward the first position. In the present embodiment, the elastic member is configured as a pair of guide springs 23L, 23R shown in FIG. 5, and an arm 23b extending from the guide spring 23L is shown in FIGS. 2 and 3. The arm 23b is in contact with a spring receiving portion 12i of the guide member 12 and pushes the spring receiving portion 12i upward, thereby biasing the guide member 12 toward the first position in the direction D2.

As illustrated in FIG. 2, the image forming apparatus 500 further includes at least one regulating member that is contacted by the guide member 12 at the first position and regulates the movement of the guide member 12 in the direction D2. In the present embodiment, the at least one regulating member includes duct legs 25 extending from both ends (both ends in the direction D1) of the duct 508 to the lower side D2B, or contacted portions 24a of lower surfaces of the duct legs 25. Meanwhile, the guide member 12 has a contacting portion 12e that is disposed at a position facing a contacted portion 24a and contacts the contacted portion 24a when the guide member 12 is at the first position. In the present embodiment, the guide member 12 has two contacting portions 12e that are located respectively at both ends of the guide member 12 in the direction D1. The guide member 12 is prevented from moving beyond the first position further to the upper side D2T by each of these contacting portions 12e contacting a corresponding contacted portion 24a of the regulating member, allowing the guide member 12 biased toward the first position to be positioned at the first position. Hereinafter, this first position is also referred to as a home position.

The guide member 12 further includes a pressed portion 12f that receives a pressing force that moves the guide member 12 from the first position to the second position. In addition, the image forming apparatus 500 includes a pressing member that moves the guide member 12 from the first position to the second position by pressing the pressed portion 12f of the guide member 12, and a driving unit that drives the pressing member to press the pressed portion 12f. In the present embodiment, the pressing member is configured as a reciprocating member 31 capable of advancing downward from a duct leg 25 and retracting upward. In the example of FIG. 3, as a result of the reciprocating member 31 advancing downward from the duct leg 25 and pressing the pressed portion 12f of the guide member 12, the guide member 12 is at the second position, and the contacting portion 12e of the guide member 12 is separated from the contacted portion 24a at this time. Hereinafter, this second position is also referred to as a lower position.

Although FIGS. 2 and 3 illustrate specific shapes of the contacting portion, the contacted portion, the regulating member, the pressed portion, and the pressing member, the shapes of these members and member parts are not limited to the illustrated examples. For example, a part illustrated as a convex shape in a certain embodiment may be formed as a concave shape in another embodiment, a part illustrated as a planar surface in a certain embodiment may be formed as a curved surface in another embodiment, and vice versa.

While the pressurizing roller 13a is in the low-temperature state, a controller (not illustrated) of the image forming apparatus 500 causes the reciprocating member 31 to advance downward to set the guide member 12 at the lower position. This secures space above the guide member 12 sufficient to such a degree that the length of a recording material being conveyed can be accommodated, and the central portion of the recording material forms a loop protruding downward. In this manner, interference between the outer surface of the loop and another structural body is avoided and degradation of the toner image is prevented. For example, the controller may detect a time point at which a front end (end portion on the downstream side D3D) of a recording material arrives at the fixing nip N_{F} with a sheet sensor (not illustrated) disposed at the fixing unit 507. In that case, the controller may encourage the recording material to form a loop protruding downward by maintaining the guide member 12 at the home position until the front end of the recording material arrives at the fixing nip N_{F} and moving the guide member 12 to the lower position from the time point of arrival at the fixing nip N_{F}. The controller may return the guide member 12 to the home position after a rear end (end portion on the upstream side D3U) of the recording material passes through the fixing nip N_{F}. These up-and-down movements of the guide member 12 may be repeated while the pressurizing roller 13a is in the low-temperature state. A period during which the up-and-down movements of the guide member 12 are performed may be dynamically determined based on a temperature of the pressurizing roller 13a or the conveyance speed V_{F} of a recording material.

### 1-3. Detailed Configuration Example of Conveyance Guide

FIG. 4 is a perspective view illustrating an example of a detailed configuration of the guide member 12 in the first embodiment. Referring to FIG. 4, the rotation axis 12a is located along a side on the upstream side D3U of the guide member 12. The contacting portions 12e and the spring receiving portions 12i exist at both the left side D1L and the right side D1R of the guide member 12. On the other hand, the pressed portion 12f exists only at the left side D1L of the guide member 12. The guide member 12 including the pressed portion 12f, a pair of contacting portions 12e, and a pair of spring receiving portions 12i is configured as an integral member. Thus, the entirety of the guide member 12 can be moved from the home position to the lower position by the one reciprocating member 31 pressing the pressed portion 12f.

The guide member 12 further includes a guide plate 12b and a plurality of ribs 12c extending in the direction D3 parallel to each other. The guide plate 12b is a plate-like member spanning an entire area from the upstream side D3U to the downstream side D3D in the direction D3 and from the left side D1L to the right side D1R in the direction D1. The plurality of ribs 12c extend along a plurality of slits provided in the guide plate 12b. Upper surfaces of the plurality of ribs 12c are located on the upper side D2T relative to an upper surface of the guide plate 12b. This causes a recording material conveyed on the guide member 12 to be supported by the plurality of ribs 12c and secures a gap between the recording material being conveyed and the upper surface of the guide plate 12b. The guide plate 12b has a conductive member 21 (for example, a metallic plate-like member) that attracts the recording material charged at the transfer nip N_{T} to the guide member 12 by an image force. Although not illustrated in FIG. 4, the conductive member 21 is directly or indirectly connected to ground. Thus, the recording material supported by the plurality of ribs 12c is conveyed while receiving the image force from the conductive member 21 and being attracted toward the guide member 12. At this time, since the recording material is conveyed in a state of being separated from the guide plate 12b, friction between the recording material and the guide member 12 is suppressed. With such a configuration of the guide member 12, an attitude of a recording material being conveyed is stabilized.

### 1-4 Detailed Configuration Example of Conveyance Frame Unit

FIG. 5 is a perspective view illustrating an example of a detailed configuration of a conveyance frame unit 22 including the guide member 12 in the first embodiment. Referring to FIG. 5, the conveyance frame unit 22 is a unit supporting the registration roller 17 (a subunit including it) and the transfer roller 505 as well as the guide member 12. By the conveyance frame unit 22 as a single unit supporting these rollers involved in the transfer of a toner images onto a recording material, it is possible to realize a highly-accurate relative positional relationship between the rollers and to achieve good conveyance performance and good image quality.

It should be noted that, in a modified example of the present embodiment, each of the registration roller 17 and the transfer roller 505 may be supported by a component different from the conveyance frame unit 22. For example, the image forming unit (process cartridge) 504 may support the transfer roller 505, and the housing 501 of the image forming apparatus 500 may support the registration roller 17.

The rotation axis 12a of the guide member 12 is rotatably supported by a bearing portion 22a disposed on a frame of the conveyance frame unit 22. Although bearing portions 22a are disposed at both the left side D1L and the right side D1R in the direction D1, only the bearing portion 22a at the right side D1R is shown in FIG. 5. The bearing portions 22a are disposed on the upstream side D3U of the guide member 12 in the direction D3. Thus, a downstream end 12h of the guide member 12 can move in an arc around the rotation axis 12a.

The pair of guide springs 23L, 23R described above are attached respectively to a pair of rotation axes 12a of the guide member 12. Each guide spring 23L, 23R may be, for example, a torsion coil spring and can be attached by inserting the rotation axis 12a in a coil portion. The guide springs 23L and 23R may be components symmetrical to each other or may be components of an identical shape. Two arms 23a and 23b extend from the guide spring 23L. The arm 23a is fixed to a spring receiving portion 22b at the left side D1L of the conveyance frame unit 22, and the arm 23b is in contact with the spring receiving portion 12i at the left side D1L of the guide member 12. Similarly, two arms extend also from the guide spring 23R. However, only one arm 23b in contact with the spring receiving portion 12i at the right side D1R of the guide member 12 is shown in FIG. 5. The other arm extending from the guide spring 23R is fixed to a spring receiving portion (not illustrated) at the right side D1R of the conveyance frame unit 22. In such an attachment state, the guide springs 23L, 23R bias the guide member 12 at both sides in the direction D1 from the lower position toward the home position (in a rotation direction around the rotation axis 12a).

As can be understood from the above description, in the present embodiment, the guide member 12 is positioned at the home position by the plurality of contacting portions 12e contacting the regulating members (or contacted portions 24a) at different positions in the direction D1, that is, the width direction of a recording material. Therefore, the attitude of the guide member 12 at the home position becomes stable, and the performance of conveying recording materials from the transfer nip N_{T} to the fixing nip N_{F} is enhanced. If a contacting portion 12e and a contacted portion 24a are disposed only at the left side D1L, the guide member 12 is not stably positioned at the right side D1R and is twisted due to a biasing force of the guide spring 23R. The same applies to the case in which the left and right are reversed. The twist of the guide member 12 could cause a twisted attitude of a recording material to be sent to the fixing nip N_{F} and result in fixing failure. In contrast, in the present embodiment, since the attitude of the guide member 12 at the home position is stabilized by the contacting portions 12e contacting the regulating members at both sides in the direction D1, the attitude of conveyed recording materials is stabilized, and the risk of fixing failure can be eliminated.

Incidentally, before the conveyance frame unit 22 is attached to the image forming apparatus 500, the regulating members that regulate the movement of the guide member 12 are absent, and thus the guide member 12 biased by the guide springs 23L, 23R will rotate beyond the home position. In view of this, in the present embodiment, the conveyance frame unit 22 has a pair of snap-fit units 22c at both sides in the direction D1. Each snap-fit unit 22c is an auxiliary regulating member that regulates the movement of the guide member 12 on the upper side D2T relative to the home position. The guide member 12 has a pair of snap-fit receiving portions 12d at both sides in the direction D1. Each snap-fit unit 22c contacts a corresponding snap-fit receiving portion 12d of the guide member 12 that has moved (rotated around the rotation axis 12a) from the lower position beyond the home position and positions the guide member 12 at a third position. The third position is on the upper side D2T relative to the home position and in the lower side D2B from a fourth position where the two arms of the guide springs 23L, 23R are fully open and the biasing force is lost. By positioning the guide member 12 at the vicinity of the home position in this manner in the unattached state of the conveyance frame unit 22, it is possible to avoid a situation where a large force is required for rotating the guide member 12 against the biasing force when attaching the conveyance frame unit 22. In addition, it is possible to eliminate the risk of component breakage due to excessive rotation of the guide member 12 before attaching the conveyance frame unit 22 or when detaching it from the image forming apparatus 500. Note that the conveyance frame unit 22 may have only one snap-fit unit 22c, not a pair of snap-fit units 22c. Similarly, the guide member 12 may have only one snap-fit receiving portion 12d, not a pair of snap-fit receiving portions 12d. These snap-fit unit 22c and snap-fit receiving portion 12d may be disposed at one side in the direction D1 or may be disposed at any other position.

### 1-5. Configuration Example of Drive Transmission Mechanism

FIG. 6 is a cross-sectional view illustrating a drive transmission mechanism 35 for moving the guide member 12 in a state where the guide member 12 is at the home position. FIG. 7 is a cross-sectional view illustrating the drive transmission mechanism 35 for moving the guide member 12 in a state where the guide member 12 is at the lower position. In the present embodiment, the drive transmission mechanism 35 is realized by a scheme in which a solenoid 28 displaces a plunger 28a.

As illustrated in FIGS. 6 and 7, the solenoid 28 is attached to the left wall 27 of the housing 501. The solenoid 28 can generate a magnetic field based on electric power supplied from a power supply (not illustrated) and displace the plunger 28a in the direction D1. The drive transmission mechanism 35 includes, in addition to the solenoid 28 and the plunger 28a, a first pressing member 29, a second pressing member 30, the reciprocating member 31, and a tension spring 33. The plunger 28a, the first pressing member 29, the second pressing member 30, and the tension spring 33 are located inside the duct 508.

The first pressing member 29 is supported by the duct 508 so as to be displaceable in the direction D1. The first pressing member 29 is coupled to the plunger 28a at a coupling point 29a and is displaced in the direction D1 in conjunction with the movement of the plunger 28a in the direction D1.

The second pressing member 30 is supported so as to be rotatable around a rotation axis 25a disposed in the duct 508. The second pressing member 30 is coupled to the first pressing member 29 at a coupling point 30a and rotates in conjunction with the movement of the first pressing member 29. An end of the tension spring 33 is fixed to the duct 508, and the other end of the tension spring 33 is engaged with a spring hook 30d of the second pressing member 30. The tension spring 33 biases the second pressing member 30 counterclockwise in the figure, and the first pressing member 29 is accordingly biased toward the right side D1R.

The reciprocating member 31 is a pressing member supported by the duct leg 25 so as to be displaceable in the direction D2. The reciprocating member 31, whose upper end has a contact point 31a in contact with the second pressing member 30, is displaced in the direction D2 in conjunction with the rotation of the second pressing member 30. A lower end of the reciprocating member 31 contacts the pressed portion 12f of the guide member 12. This causes the guide member 12 to move in conjunction with the advancement and retraction of the reciprocating member 31.

In the example of FIG. 6, the solenoid 28 does not generate a magnetic field, and the biasing force of the tension spring 33 maintains the first pressing member 29 and the plunger 28a at rightmost positions on the right side D1R. In addition, the contact point 31a between the second pressing member 30 and the reciprocating member 31 is maintained at an uppermost position on the upper side D2T. In this state, the guide member 12, whose movement is regulated by the regulating members, is positioned at the home position (see FIG. 2).

When lowering the guide member 12, the controller energizes and causes the solenoid 28 to generate a magnetic field, and the solenoid 28 attracts the plunger 28a to the left side D1L (see FIG. 7). Then, the first pressing member 29 is displaced to the left side D1L in conjunction with the plunger 28a. The second pressing member 30 rotates, in conjunction with the first pressing member 29, clockwise in the figure against the biasing force of the tension spring 33. The reciprocating member 31 advances to the lower side D2B in conjunction with the second pressing member 30. The lower end of the reciprocating member 31 pushes the pressed portion 12f down. In due course, when the plunger 28a stops at a leftmost position on the left side D1L, the reciprocating member 31 also stops advancing, and the guide member 12 is positioned at the lower position (see FIG. 3).

Contrarily, when returning the guide member 12 to the home position, the controller stops energizing the solenoid 28 and dissipates the magnetic field. Then, the biasing force of the tension spring 33 causes the second pressing member 30 to rotate counterclockwise in the figure. The first pressing member 29 and the plunger 28a are displaced to the right side D1R, and the reciprocating member 31 retracts to the upper side D2T. As a result, the guide member 12 is positioned at the home position again.

In general, a movement amount of a plunger driven by a solenoid is not large. In view of this, a ratio of the length Lb from the rotation axis 25a of the second pressing member 30 to the contact point 31a with respect to the length La from the rotation axis 25a to the coupling point 30a is desirably greater than at least one (La < Lb). By designing this ratio depending on a required stroke (reciprocation distance) of the reciprocating member 31, it is possible to secure a sufficient movement amount of the guide member 12 even with a small movement amount of the plunger.

As described above, the drive transmission mechanism 35 is partially disposed in an internal space of the duct 508. Hence, it is possible to realize the mechanism for moving the guide member 12 while efficiently using space to avoid an increase in size of the image forming apparatus 500. Note, however, that the technology according to the present disclosure is not limited to this example. In an embodiment in which a drive transmission mechanism 35 is disposed outside the duct 508, no member of the drive transmission mechanism 35 interferes with airflow in the duct 508, resulting in higher heat dissipation efficiency by the fan 32.

It should be noted that, by disposing the drive transmission mechanism 35 on a member identical to the member having the contacted portions 24a (for example, the duct 508 or another member), it is possible to eliminate influence of attachment error between members and enhance the accuracy of a positional relationship between the home position and the lower position of the guide member 12.

In FIG. 6, a contour of a recording material P conveyed by the conveyance guide 506 is partially illustrated by broken lines. As can be seen from this figure, in the present embodiment, the guide member 12 is wider than the recording material P. Thus, the two contacting portions 12e at both sides of the guide member 12 are located, in the direction D1, outside a region through which the recording material P passes (but inside the right wall 26 and the left wall 27). The same applies to the positions of the corresponding two contacted portions 24a. The reciprocating member 31 and the pressed portion 12f are also located, in the direction D1, outside the region through which the recording material P passes. Therefore, the entire mechanism for moving the guide member 12 does not interfere with conveyance of the recording material P. In the direction D3, the contacting portions 12e may be located on the downstream side D3D of the pressed portion 12f (see FIGS. 2 and 3). This secures a sufficient length from the rotation axis 12a of the guide member 12 to the contacting portion 12e, resulting in the increased positioning accuracy of the guide member 12 at the home position and the higher conveyance performance for recording materials.

The lower end of the reciprocating member 31 and the pressed portion 12f of the guide member 12 slide on each other when moving the guide member 12. For that reason, at least the lower end of the reciprocating member 31 is desirably formed of a material having high wear resistance such as, for example, polyacetal (POM). This can prevent scraping, wear, and abnormal sound due to the sliding from occurring.

### 1-6. Elasticity of Left and Right Guide Springs

As described above, in the present embodiment, the pair of contacting portions 12e of the guide member 12 respectively contact the regulating members at one end and the other end in the direction D1. When the spring constant of the guide spring 23L is k_{L} and the spring constant of the guide spring 23R is k_{R}, k_{L} = k_{R} may hold as an example. In this case, the force that biases the guide member 12 from the lower position toward the home position is distributed equally to both ends of the guide member 12. The guide spring 23L and the guide spring 23R can be provided as common components.

However, in the present embodiment, the reciprocating member 31 and the pressed portion 12f exist only at one end of the left side D1L in the direction D1. Consequently, when the reciprocating member 31 pushes guide member 12 down to the lower position, there is a possibility that the guide member 12 is twisted (positional difference between the left and right of the downstream end 12h occurs) due to the biasing force of the guide spring 23R. In view of this, as another example, the guide spring 23L may have a larger spring constant than the guide spring 23R (k_{L} > k_{R}).

More generally, the image forming apparatus 500 includes a first elastic member and a second elastic member (for example, the guide spring 23L and the guide spring 23R) attached to the guide member 12 at a first end and a second end in the direction D1, respectively. The first elastic member and the second elastic member bias the guide member 12 from the lower position toward the home position. The pressed portion 12f of the guide member 12 is located at the first end (for example, the left side D1L or the right side D1R) of the guide member 12. At this time, the first elastic member at the first end may have a larger modulus of elasticity than the second elastic member at the second end. Alternatively, the first elastic member at the first end may generate a larger biasing force than the second elastic member at the second end in the state where the guide member 12 is at the lower position. By the elastic member at the directly-pressed side having a larger modulus of elasticity or a larger biasing force in this manner, it is possible, when the reciprocating member 31 pushes the guide member 12 down to the lower position, to reduce the stress difference between the left and right to suppress the twist of the guide member 12. This can reduce a risk that the guide member at the lower position inhibits a recording material from warping downward or degrades the conveyance performance for recording materials. These moduli of elasticity of the elastic members (for example, spring constants of the guide springs 23L and 23R) may be selected so as to obtain biasing forces sufficient for the pair of contacting portions 12e to surely contact the regulating members at the home position even when there is a manufacturing tolerance (for example, warpage) in the guide member 12.

### 1-7. Positional Relationship between Conveyance Guide and Fixed Guide

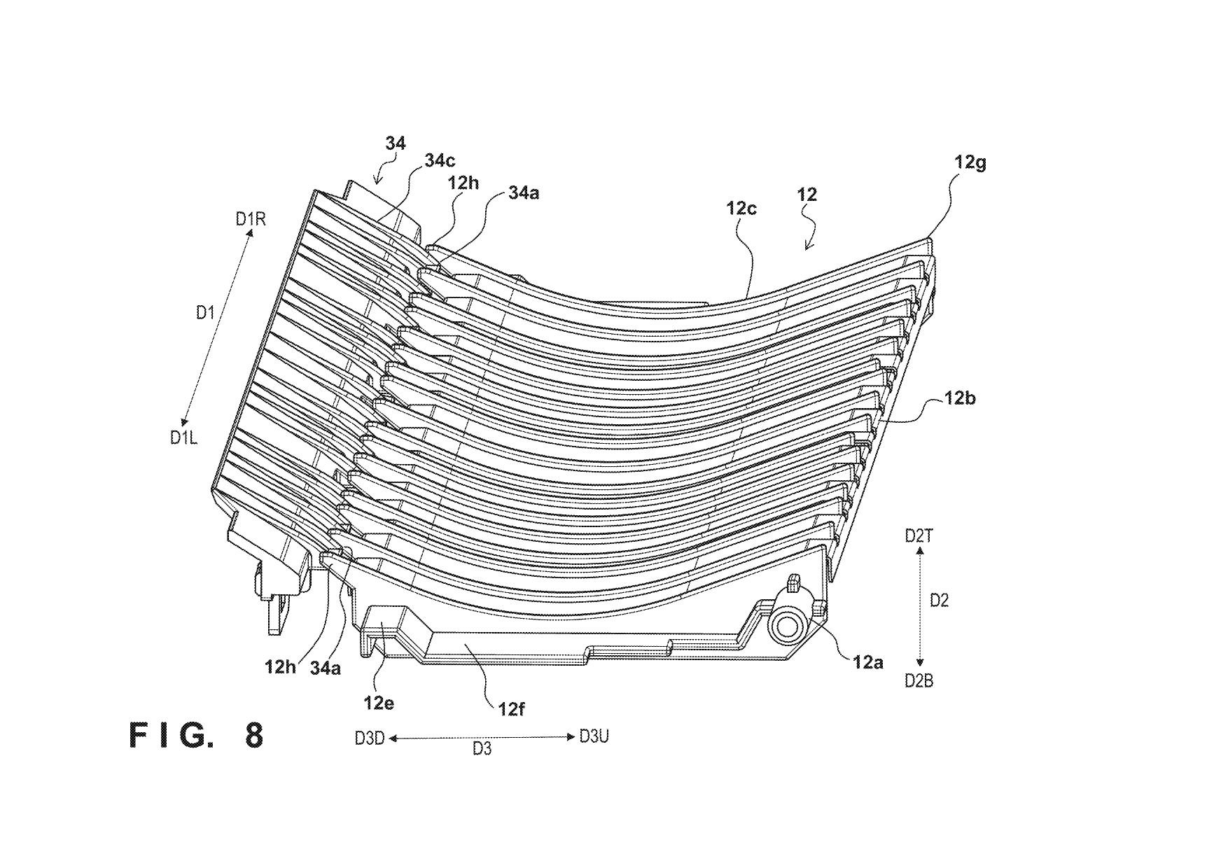

FIG. 8 is a perspective view illustrating an example of a positional relationship between the conveyance guide 506 and the first fixed guide 34 of the fixing unit 507 in the present embodiment. As described above, the first fixed guide 34 guides a recording material passed from the conveyance guide 506 to the fixing nip N_{F}. As illustrated in FIG. 8, in the direction D3, that is, in the conveyance direction of a recording material, an upstream end 34a of the first fixed guide is located on the upstream side D3U of the downstream end 12h of the guide member 12 at the lower position. Focusing on the movement direction D2, the downstream end 12h of the guide member 12 at the lower position, which is the lowest point of the guide member 12, is at the same level as or the upper side D2T of the upstream end 34a of the first fixed guide.

In order to realize the above-described positional relationship between the downstream end 12h of the guide member 12 and the upstream end 34a of the first fixed guide 34, the plurality of ribs 12c of the guide member 12 protrude further to the downstream side D3D than the guide plate 12b. In addition, the first fixed guide 34 includes a plurality of ribs 34c extending in the direction D3 parallel to each other, and the plurality of ribs 34c protrude to the upstream side D3U. The downstream ends 12h, which are end portions of the plurality of ribs 12c of the guide member 12, enter gaps between the plurality of ribs 34c of the first fixed guide 34 and approach closer to the fixing nip N_{F} than the upstream end 34a of the first fixed guide 34. As a result, the guide member 12 covers, in the direction D3, a range partially overlapping the first fixed guide 34.

At the home position, the downstream end 12h of the guide member 12 is located on the upper side D2T largely apart from the upstream end 34a of the first fixed guide 34 (see FIG. 2). As compared in the direction D3, since the downstream end 12h rises in an arc, the downstream end 12h at the home position is displaced to the further upstream side D3U than at the lower position. However, with an effect of the above-described overlapping, the downstream end 12h of the guide member 12 at the home position is still located on the downstream side D3D of the upstream end 34a of the first fixed guide 34.

Such a positional relationship between the guide member 12 and the first fixed guide 34 allows, both with the home position and the lower position, recording materials to be smoothly conveyed from the conveyance guide 506 on the upstream side to the fixing unit 507 on the downstream side. In addition, when at the lower position, there is no large step difference or no gap between the downstream end 12h of the guide member 12 and the upstream end 34a of the first fixed guide 34 (see FIGS. 3 and 8). Therefore, malfunction such as, for example, catching does not occur with a recording material that forms downward loop.

Although the positional relationship between the guide member 12 and the first fixed guide 34 is described here, the above-described positional relationship may be applied to any combination of two adjacent members that guide recording materials along the conveyance direction. For example, the post-transfer guide 22d illustrated in FIG. 1 may include a plurality of ribs extending in the direction D3 parallel to each other and having downstream ends 22e protruding to the downstream side D3D. The downstream ends 22e of the post-transfer guide 22d enter gaps between the plurality of ribs 12c of the guide member 12, and the post-transfer guide 22d covers, in the direction D3, a range partially overlapping the guide member 12. The downstream end 22e of the post-transfer guide 22d are at the same level as or on the upper side D2T of an upstream end 12g of the guide member 12.

### 2. Second Embodiment

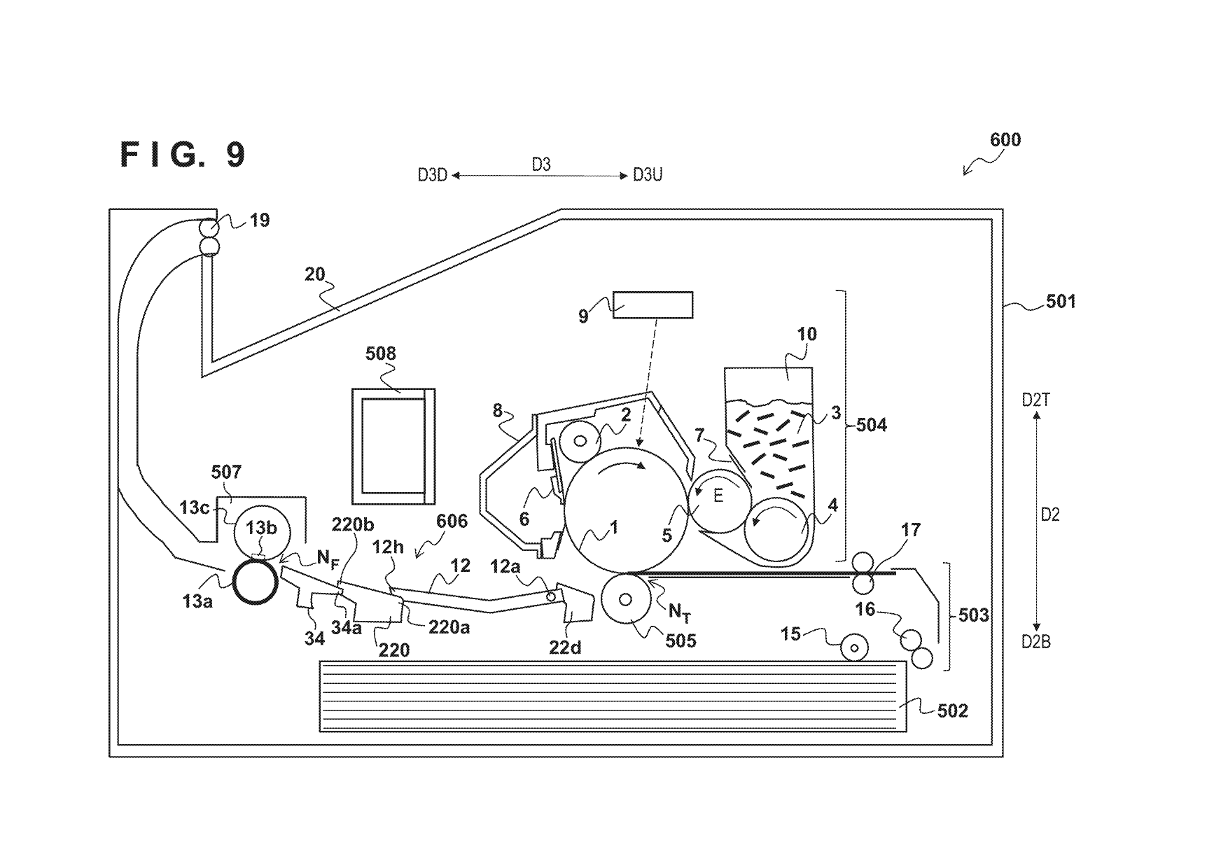

FIG. 9 is a schematic cross-sectional view illustrating an example of a schematic configuration of an image forming apparatus 600 in a second embodiment of the technology according to the present disclosure. Referring to FIG. 9, the image forming apparatus 600 includes a housing 501, a cassette 502, a conveyance mechanism 503, an image forming unit 504, a transfer roller 505, a conveyance guide 606, a fixing unit 507, and a duct 508.

The conveyance guide 606 is a guide unit that guides a recording material having a toner image transferred thereto from a transfer nip N_{T} toward a fixing nip N_{F} of the fixing unit 507. In the present embodiment, the conveyance guide 606 includes, in addition to a guide member 12 described above, a second fixed guide 220 disposed between the guide member 12 and a first fixed guide 34 of the fixing unit 507. On the downstream side D3D of the guide member 12, the second fixed guide 220 is disposed in a fixed manner on a frame (a conveyance frame unit 22 described above, not illustrated in FIG. 9) supporting the guide member 12. By disposing the second fixed guide 220 and the guide member 12 on the common frame, it is possible to enhance the accuracy of a positional relationship between these members. The second fixed guide 220 may be a part of the frame or may be a component separate from the frame. The first fixed guide 34 guides a recording material passed from the second fixed guide 220 to the fixing nip N_{F}.

The second fixed guide 220 includes a plurality of ribs extending in the direction D3 parallel to each other. The downstream ends 12h of the guide member 12 at the lower position enters gaps between the plurality of ribs of the second fixed guide 220. Thus, an upstream end 220a of the second fixed guide 220 is located on the upstream side D3U from the downstream end 12h of the guide member 12. That is, the guide member 12 covers, in the direction D3, a range partially overlapping the second fixed guide 220. In addition, the downstream end 12h of the guide member 12 is at the same level as or the upper side D2T of the upstream end 220a of the second fixed guide 220. The downstream ends 220b of the second fixed guide 220 are located in gaps between a plurality of ribs 34c of the first fixed guide 34. Thus, an upstream end 34a of the first fixed guide 34 is located on the upstream side D3U from the downstream end 220b of the second fixed guide 220. That is, the second fixed guide 220 covers, in the direction D3, a range partially overlapping the first fixed guide 34. In addition, in the direction D2, the downstream end 220b of the second fixed guide 220 is located at the same level as or on the upper side D2T of the upstream end 34a of the first fixed guide 34. Such a positional relationship between the guide member 12, the second fixed guide 220, and the first fixed guide 34 allows recording materials to be smoothly conveyed from the conveyance guide 606 to the fixing unit 507.

According to the configuration of the above-described second embodiment, it is possible to make a distance between the downstream end 12h of the movable guide member 12 and the fixing nip N_{F} larger than that in the first embodiment. In this manner, even when the guide member 12 is deformed (for example, twisted) while being lowered, it is possible to reduce a degree to which the deformation affects the conveyance of recording materials toward the fixing nip N_{F}.

As described above, while the first fixed guide 34 is disposed in the fixing unit 507, the second fixed guide 220 is disposed on the conveyance frame unit 22 (that is, a component separate from the fixing unit 507). The fixing unit 507 and the conveyance frame unit 22 are both attached to the housing 501.

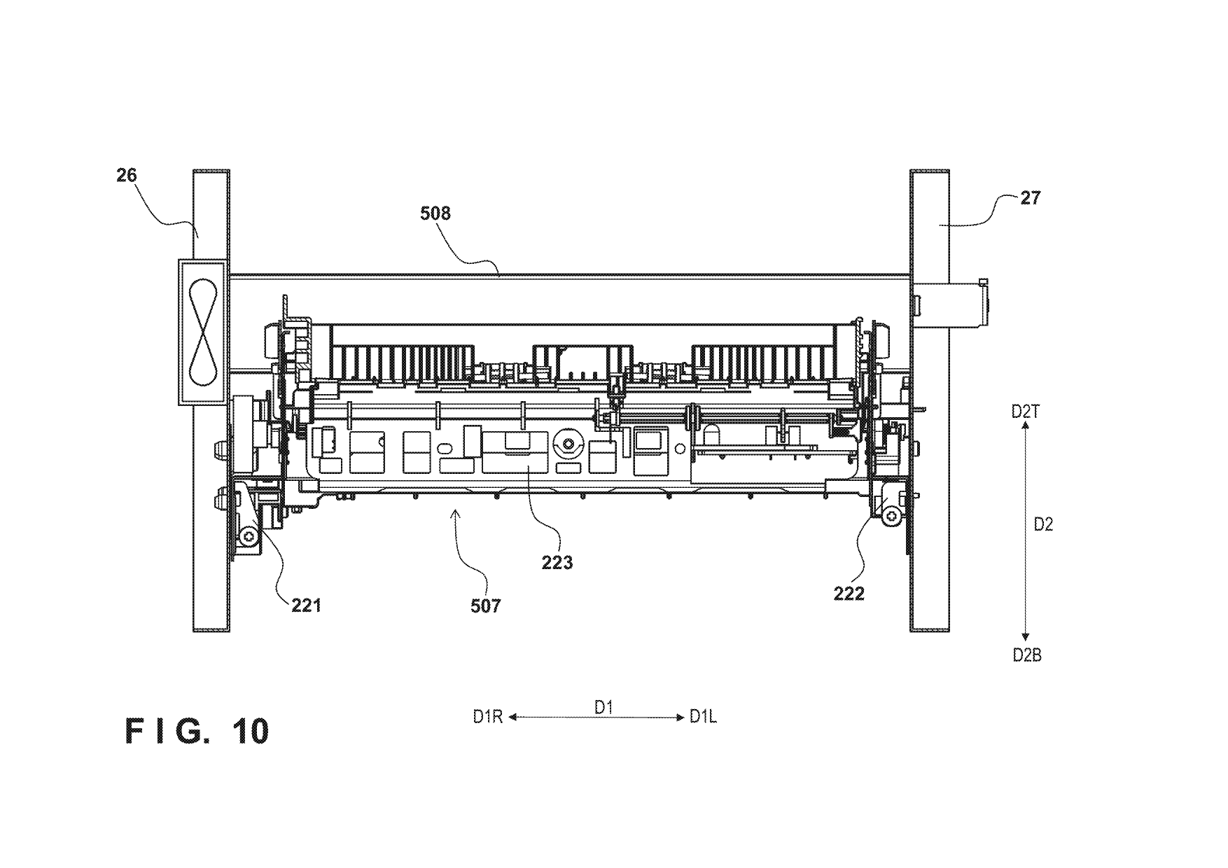

FIG. 10 is a cross-sectional view illustrating how the fixing unit 507 is attached to the housing 501 in the present embodiment. The fixing unit 507 has a configuration in which constituent elements such as a pressurizing roller 13a and a fixing film 13c are supported by a frame 223 having a right attachment portion 221 and a left attachment portion 222. The right attachment portion 221 is attached to a right wall 26 of the housing 501, and the left attachment portion 222 is attached to a left wall 27 of the housing 501. Meanwhile, as illustrated in FIGS. 6 and 7, the conveyance frame unit 22 is also attached to the right wall 26 and the left wall 27 of the housing 501 at both ends in the direction D1. By attaching the conveyance frame unit 22 and the fixing unit 507 to a common member in this manner, it is possible to secure the sufficient accuracy of a positional relationship between the first fixed guide 34 and the second fixed guide 220.

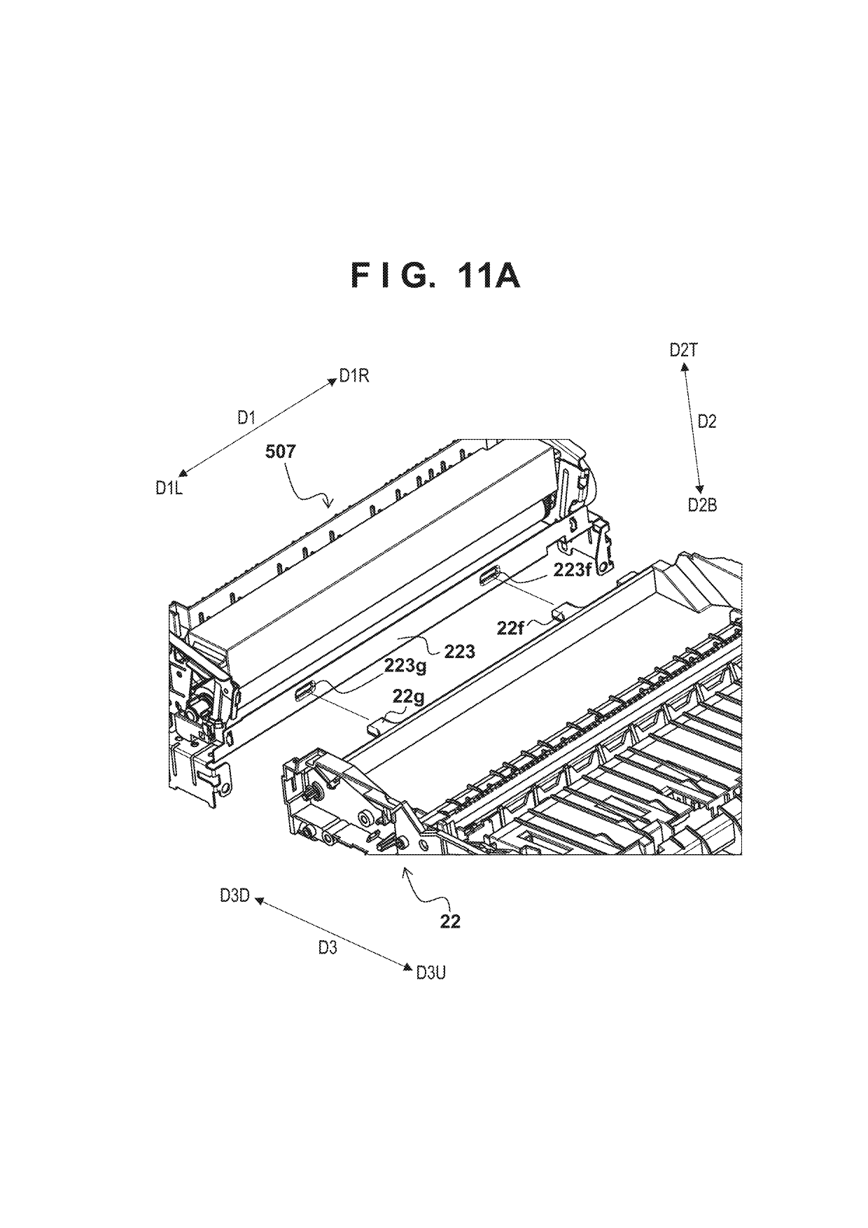

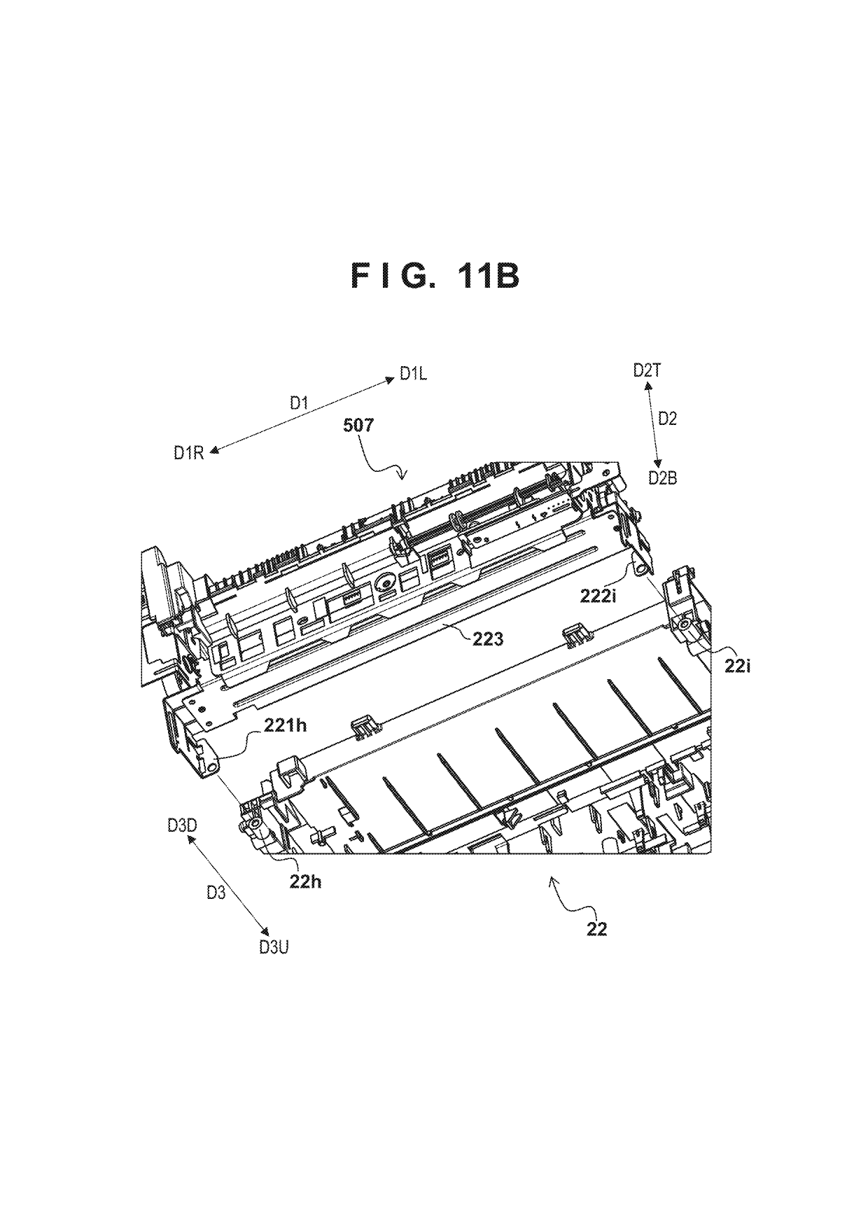

As a modified example of the second embodiment, the conveyance frame unit 22 may have a constituent element for positioning the conveyance frame unit 22 with respect to the fixing unit 507. FIGS. 11A and 11B are exploded perspective views illustrating how the conveyance frame unit 22 is positioned in such a modified example. FIG. 11A shows a connected portion between the conveyance frame unit 22 and the fixing unit 507 from the upper side D2T. Referring to FIG. 11A, the conveyance frame unit 22 has a pair of claws 22f, 22g on its surface facing the frame 223 of the fixing unit 507. The frame 223 of the fixing unit 507 has a pair of recesses 223f, 223g in its surface facing the conveyance frame unit 22. The claws 22f and 22g of the conveyance frame unit 22 engage with the recesses 223f and 223g of the frame 223 of the fixing unit 507, respectively. This causes a relative position of the conveyance frame unit 22 with respect to the fixing unit 507 in the direction D1 and the direction D2 to be fixed.

FIG. 11B shows the connected portion between the conveyance frame unit 22 and the fixing unit 507 from the lower side D2B. Referring to FIG. 11B, the conveyance frame unit 22 has a pair of projections 22h, 22i provided on its lower surface at a downstream end. The frame 223 of the fixing unit 507 has a pair of holes 223h, 223i in its lower surface at an upstream end. The projections 22h and 22i of the conveyance frame unit 22 fit in the holes 223h and 223i of the frame 223 of the fixing unit 507, respectively. This causes a relative position of the conveyance frame unit 22 with respect to the fixing unit 507 in the direction D3 to be fixed as well.

A configuration may be adopted which includes only one of the configurations for positioning described with reference to FIGS. 11A and 11B. By allowing the conveyance frame unit 22 to be positioned with respect to the fixing unit 507 as described above, it is possible to enhance the accuracy of a relative positional relationship of the second fixed guide 220 with respect to the first fixed guide 34 and achieve even higher conveyance performance for recording materials.

### 3. Third Embodiment

In the above-described first embodiment and second embodiment, when the guide member 12 returns from the lower position to the home position, the contacting portions 12e of the guide member 12 collide with the regulating members after being accelerated by biasing forces of springs. In a third embodiment described in this section, a structure for mitigating a collision sound due to such a collision is introduced in the apparatus.

### 3-1. First Configuration Example

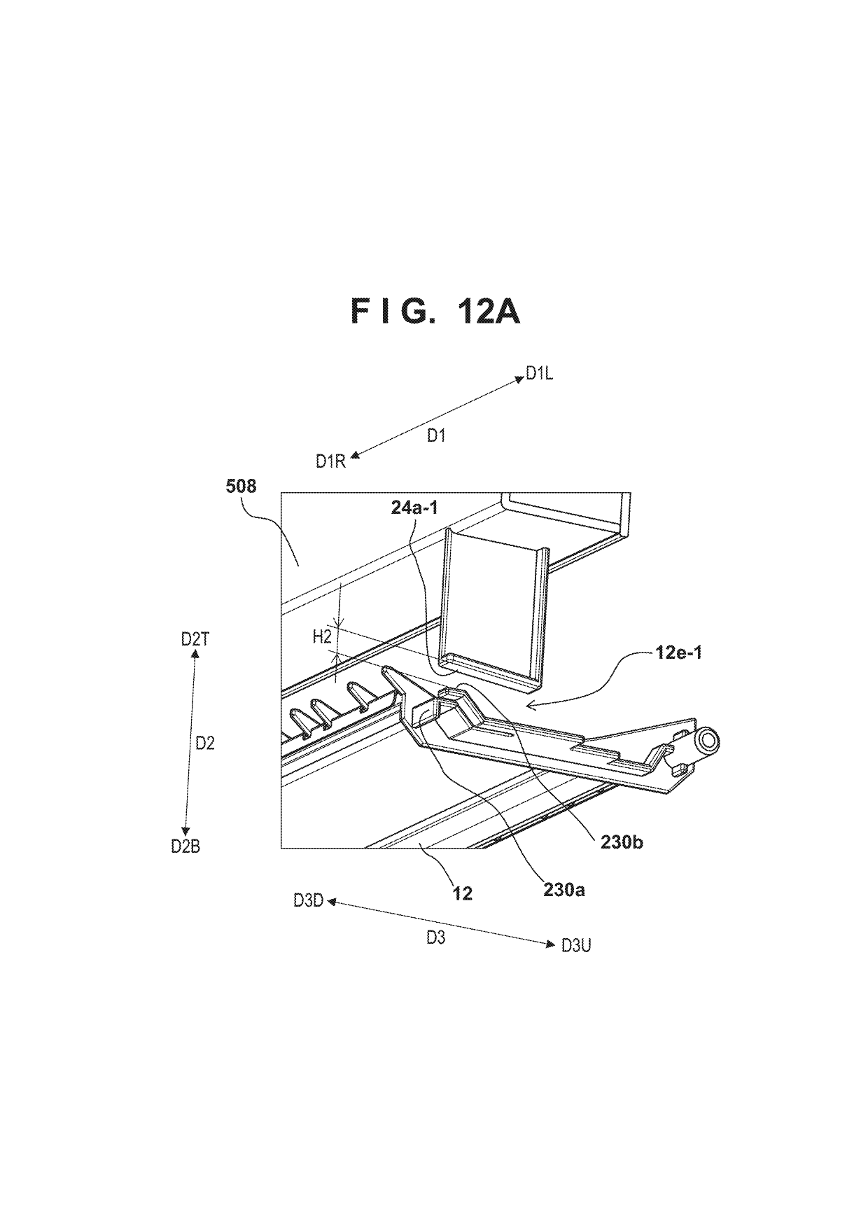

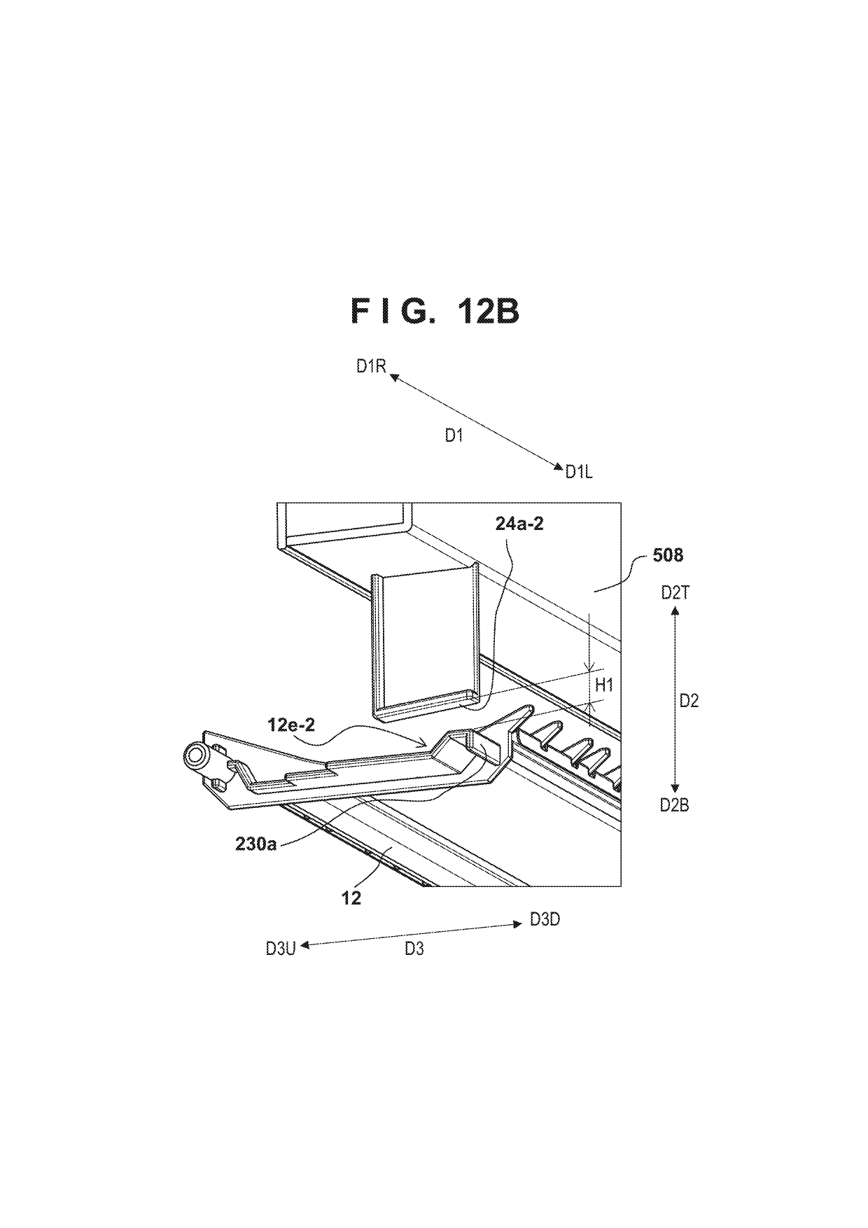

FIGS. 12A and 12B are perspective views illustrating a first configuration example for mitigating a collision sound in the third embodiment. FIG. 12A illustrates a partially enlarged view of left surfaces of a guide member 12 and a duct 508. FIG. 12B illustrates a partially enlarged view of right surfaces of the guide member 12 and the duct 508. In the first configuration example, at least a first contacting portion 12e-1 out of two contacting portions 12e is formed in a flexible shape. The first contacting portion 12e-1 absorbs an impact by bowing when colliding with a contacted portion 24a, thereby mitigating a collision sound.

More specifically, the first contacting portion 12e-1 illustrated in FIG. 12A has a positioning portion 230a and a flexible portion 230b, and a slit exists between the positioning portion 230a and the flexible portion 230b. The flexible portion 230b branches off from the positioning portion 230a and extends to the downstream side D3D substantially parallel to the positioning portion 230a while inclining upward. A downstream end of the positioning portion 230a is fixed to the guide member 12. Meanwhile, a downstream end of the flexible portion 230b located at an outer side is a free end and is located slightly to the upper side D2T from the downstream end of the positioning portion 230a. The distance between an upper surface of the flexible portion 230b of the first contacting portion 12e-1 of the guide member 12 at the lower position and a corresponding first contacted portion 24a-1 is, for example, H2.

On the other hand, a second contacting portion 12e-2 illustrated in FIG. 12B has a positioning portion 230a and no flexible portion 230b. The positioning portion 230a extends to the downstream side D3D while inclining upward. A downstream end of the positioning portion 230a is fixed to the guide member 12. The distance between upper surfaces of the positioning portions 230a of the first contacting portion 12e-1 and the second contacting portion 12e-2 of the guide member 12 at the lower position and corresponding first contacted portion 24a-1 and second contacted portion 24a-2 is, for example, H1.

In the first configuration example, the distances H1 and H2 satisfy the relationship H2 < H1. That is, the flexible portion 230b of the first contacting portion 12e-1 protrudes to the upper side D2T than the positioning portions 230a. Therefore, when the guide member 12 moves from the lower position to the home position, the flexible portion 230b of the first contacting portion 12e-1 collides with the regulating member earlier than the second contacting portion 12e-2 and earlier than the positioning portion 230a of the first contacting portion 12e-1. Since the downstream end of the flexible portion 230b is a free end, the flexible portion 230b bows downward while absorbing an impact and, in due course, the positioning portion 230a of the first contacting portion 12e-1 and the second contacting portion 12e-2 contact the regulating members.

At least the flexible portion 230b of the guide member 12 may be made of a material such as, for example, acrylonitrile butadiene styrene (ABS) resin or polycarbonate/acrylonitrile butadiene styrene (PC/ABS) resin. ABS resin has high impact resistance, and PC/ABS resin has higher strength. Hence, notwithstanding repetitive impacts, using such a material can prevent breakage and plastic deformation of the flexible portion 230b.

In a modified example of the first configuration example, the first contacting portion 12e-1 formed in a flexible shape may be a separate component attached to the guide member 12, not a part of the guide member 12.

### 3-2. Second Configuration Example

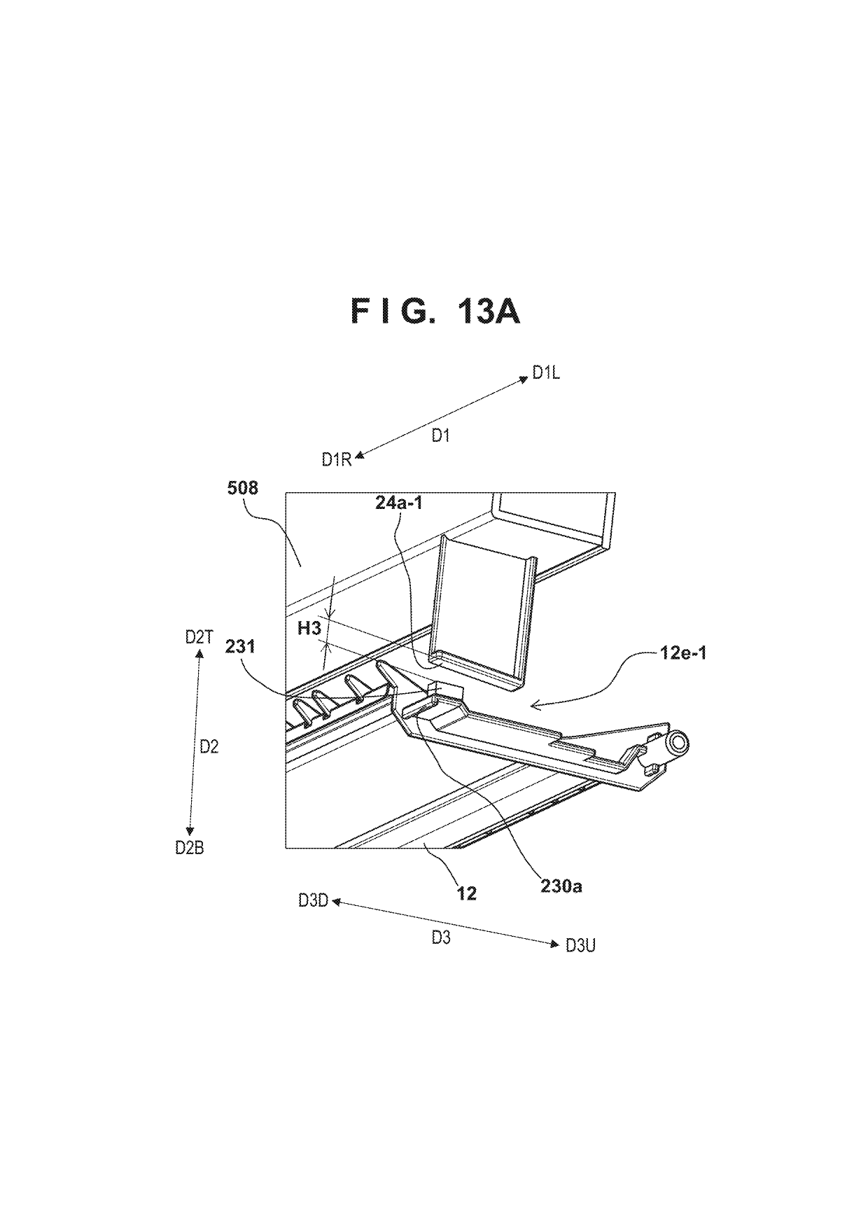

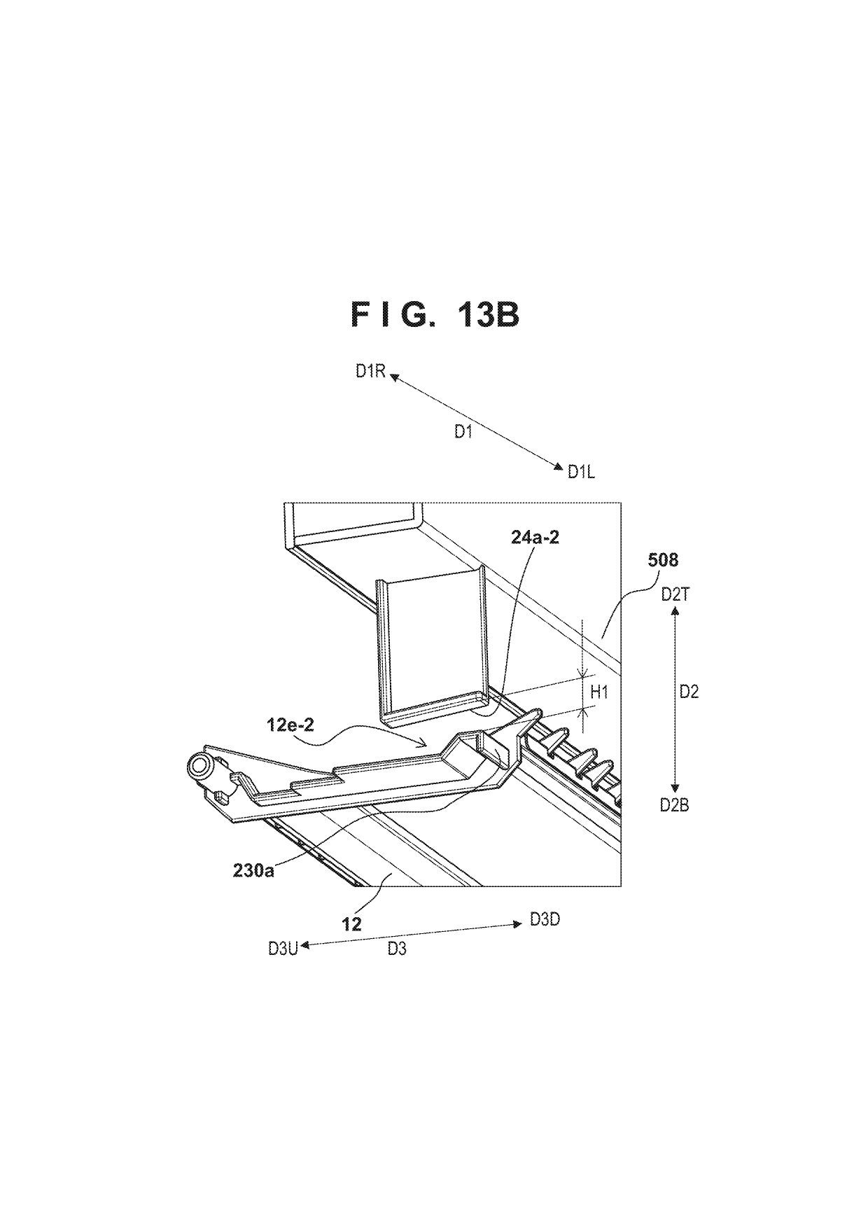

FIGS. 13A and 13B are perspective views illustrating a second configuration example for mitigating a collision sound in the third embodiment. FIG. 13A illustrates a partially enlarged view of the left surfaces of the guide member 12 and the duct 508. FIG. 13B illustrates a partially enlarged view of the right surfaces of the guide member 12 and the duct 508. In the second configuration example, the guide member 12 further includes a first compressible member 231 adhered to at least a first contacting portion 12e-1 out of two contacting portions 12e. The first contacting portion 12e-1 contacts a regulating member via the first compressible member 231. The first compressible member 231 absorbs an impact by contracting when colliding with a contacted portion 24a, thereby mitigating a collision sound.

More specifically, the first contacting portion 12e-1 illustrated in FIG. 13A has a positioning portion 230a, and the positioning portion 230a extends to the downstream side D3D while inclining upward. A downstream end of the positioning portion 230a is fixed to the guide member 12. The first compressible member 231 is disposed in a fixed manner on an upper surface of the positioning portion 230a. A method of fixing the first compressible member 231 onto the upper surface of the positioning portion 230a may be any method such as using, for example, double-sided tape or adhesive. The first compressible member 231 may be made of, for example, rubber, foam rubber, or nonwoven fabric. The distance between an upper surface of the first compressible member 231 of the first contacting portion 12e-1 of the guide member 12 at the lower position and a corresponding first contacted portion 24a-1 is, for example, H3.

On the other hand, a second contacting portion 12e-2 illustrated in FIG. 13B has a positioning portion 230a similar to the first contacting portion 12e-1. However, no compressible member is disposed on the positioning portion 230a of the second contacting portion 12e-2. The distance between an upper surface of the positioning portion 230a of the second contacting portion 12e-2 of the guide member 12 at the lower position and a corresponding second contacted portion 24a-2 is H1.

In the second configuration example, the distances H1 and H3 satisfy the relationship H3 < H1. Therefore, when the guide member 12 moves from the lower position to the home position, the positioning portion 230a of the first contacting portion 12e-1 collides with the first contacted portion 24a-1 via the first compressible member 231 earlier than the positioning portion 230a of the second contacting portion 12e-2. Then, the first compressible member 231 contracts while absorbing an impact and, in due course, the second contacting portion 12e-2 contacts the second contacted portion 24a-2.

### 3-3. Third Configuration Example

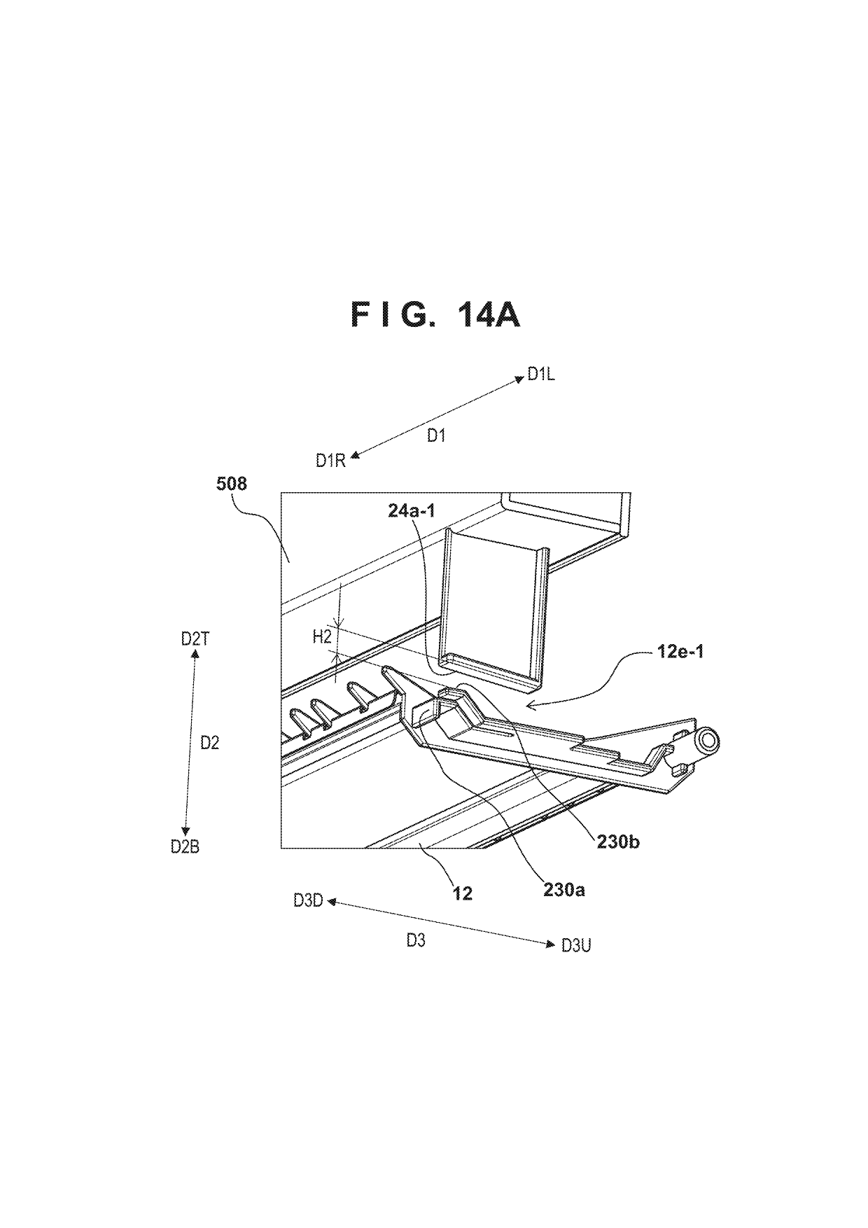

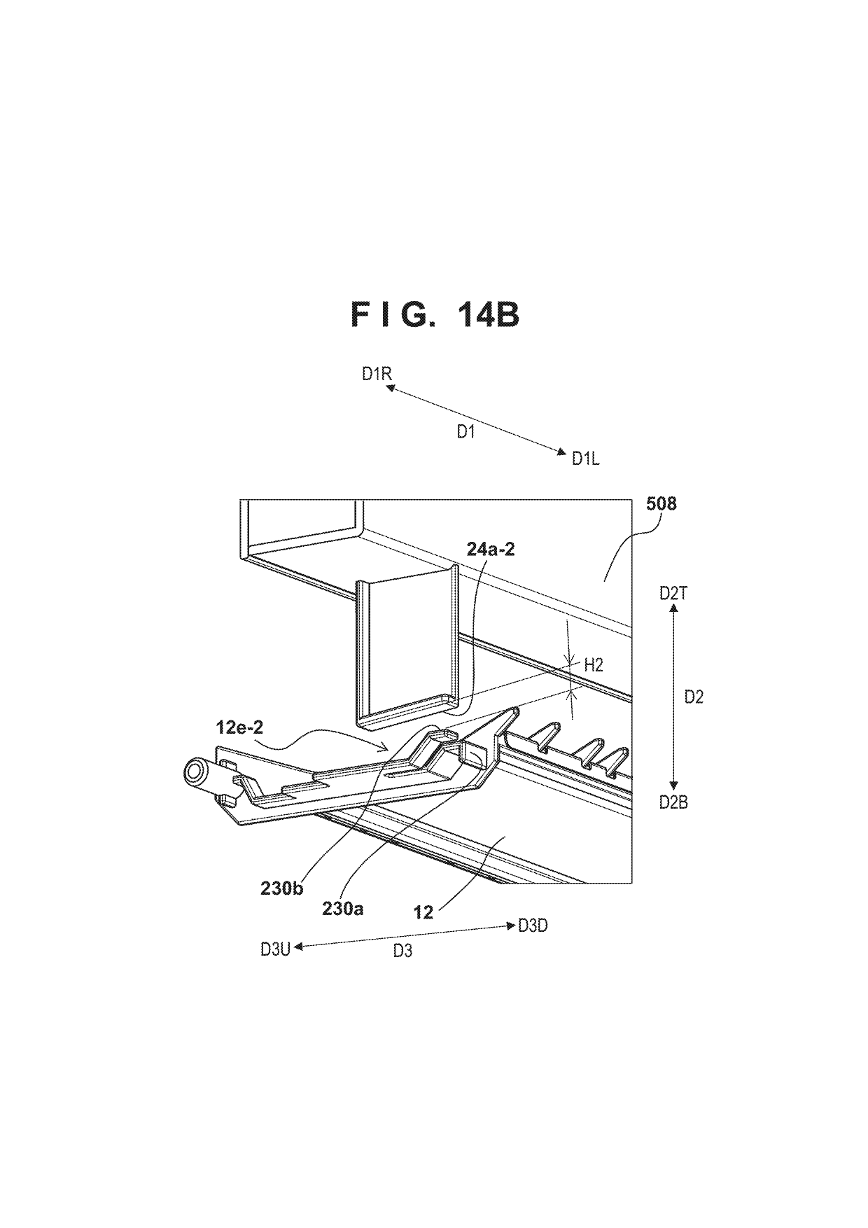

FIGS. 14A and 14B are perspective views illustrating a third configuration example for mitigating a collision sound in the third embodiment. FIG. 14A illustrates a partially enlarged view of the left surfaces of the guide member 12 and the duct 508. FIG. 14B illustrates a partially enlarged view of the right surfaces of the guide member 12 and the duct 508. In the third configuration example, both a first contacting portion 12e-1 and a second contacting portion 12e-2 out of two contacting portions 12e are formed in a flexible shape. The first contacting portion 12e-1 and the second contacting portion 12e-2 together absorb an impact by bowing when colliding with regulating members, thereby mitigating a collision sound.

More specifically, the configuration of the first contacting portion 12e-1 illustrated in FIG. 14A is identical to that illustrated in FIG. 12A. The second contacting portion 12e-2 illustrated in FIG. 14B has a positioning portion 230a and a flexible portion 230b, and a slit exists between the positioning portion 230a and the flexible portion 230b. The flexible portion 230b branches off from the positioning portion 230a and extends to the downstream side D3D substantially parallel to the positioning portion 230a while inclining upward. A downstream end of the positioning portion 230a is fixed to the guide member 12. Meanwhile, a downstream end of the flexible portion 230b located at an outer side is a free end and is located slightly to the upper side D2T from the downstream end of the positioning portion 230a. The distance between an upper surface of the flexible portion 230b of the second contacting portion 12e-2 of the guide member 12 at the lower position and a corresponding second contacted portion 24a-2 is, for example, H2.

In the third configuration example, when the guide member 12 moves from the lower position to the home position, the respective flexible portions 230b of the first contacting portion 12e-1 and the second contacting portion 12e-2, whose downstream ends are free ends, collide with the regulating members and then bow downward while absorbing an impact. In due course, the respective positioning portions 230a of the first contacting portion 12e-1 and the second contacting portion 12e-2 also contact the regulating members. In the present configuration example, since the two flexible portions 230b absorb an impact, the effect of mitigating a collision sound can be further enhanced.

In a modified example of the third configuration example, the first contacting portion 12e-1 and the second contacting portion 12e-2 formed in a flexible shape may be separate components attached to the guide member 12, not parts of the guide member 12.

### 3-4. Fourth Configuration Example

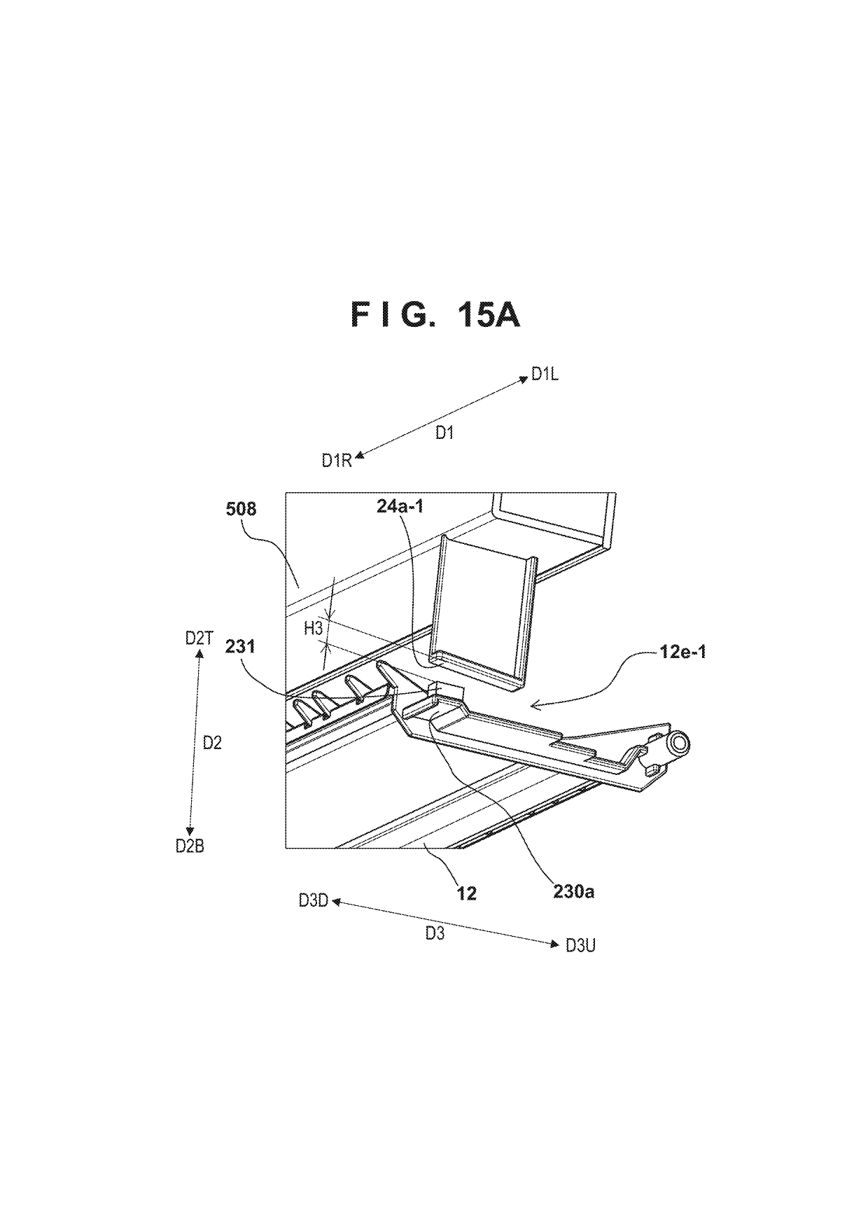

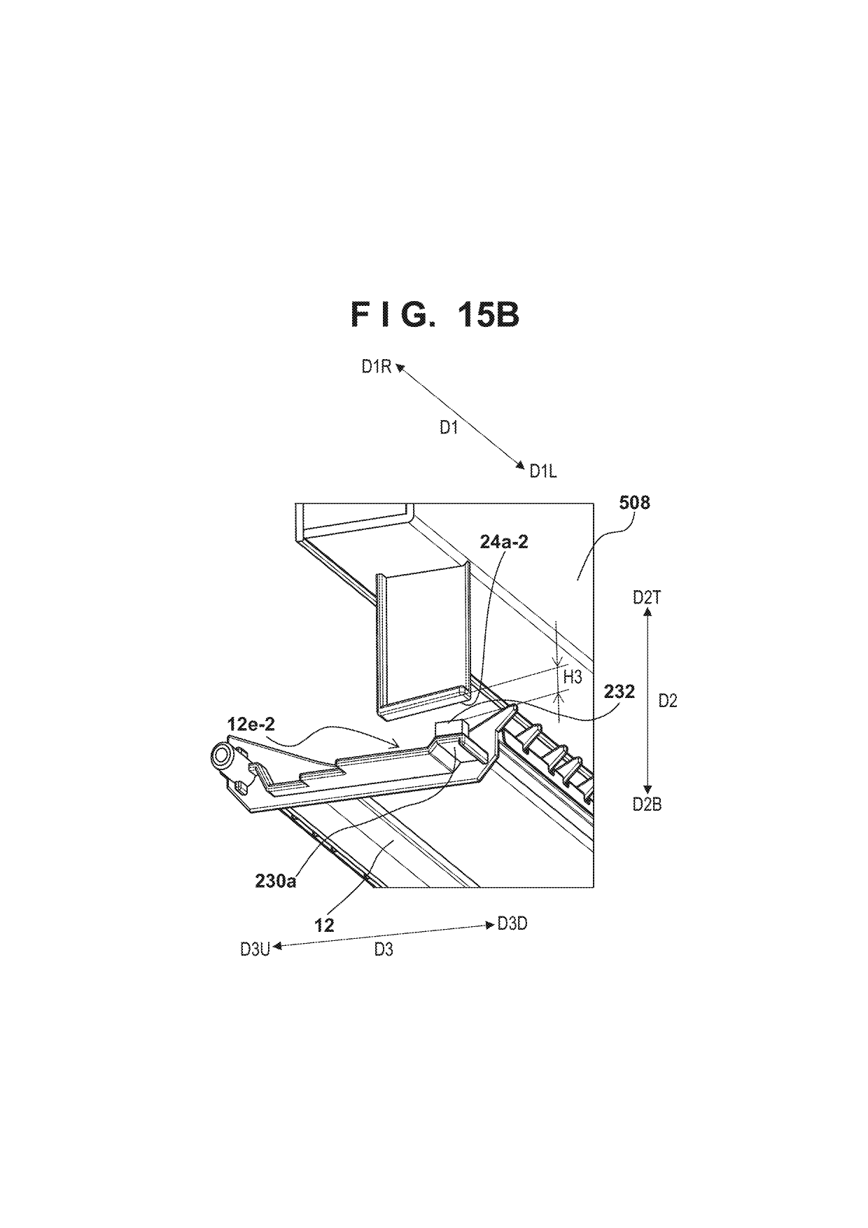

FIGS. 15A and 15B are perspective views illustrating a fourth configuration example for mitigating a collision sound in the third embodiment. FIG. 15A illustrates a partially enlarged view of the left surfaces of the guide member 12 and the duct 508. FIG. 15B illustrates a partially enlarged view of the right surfaces of the guide member 12 and the duct 508. In the fourth configuration example, the guide member 12 includes a first compressible member 231 adhered to a first contacting portion 12e-1 and a second compressible member 232 adhered to a second contacting portion 12e-2.

More specifically, the configuration of the first contacting portion 12e-1 illustrated in FIG. 15A is identical to that illustrated in FIG. 13A. The second contacting portion 12e-2 illustrated in FIG. 15B has a positioning portion 230a, and the positioning portion 230a extends to the downstream side D3D while inclining upward. A downstream end of the positioning portion 230a is fixed to the guide member 12. The second compressible member 232 is disposed in a fixed manner on an upper surface of the positioning portion 230a. The distance between an upper surface of the second compressible member 232 of the second contacting portion 12e-2 of the guide member 12 at the lower position and a corresponding second contacted portion 24a-2 is, for example, H3.

In the fourth configuration example, when the guide member 12 moves from the lower position to the home position, the first contacting portion 12e-1 contacts a regulating member via the first compressible member 231, and the second contacting portion 12e-2 contacts a regulating member via the second compressible member 232. The first compressible member 231 and the second compressible member 232 absorb an impact by contracting when pressed, thereby mitigating a collision sound. In the present configuration example, since the two compressible members are used, the effect of mitigating a collision sound can be further enhanced.

### 4. Fourth Embodiment

Although the structure for mitigating a collision sound is introduced in the guide member 12 in the above-described third embodiment, a similar structure may be introduced in a regulating member, not a guide member 12. In this section, such an example will be described as a fourth embodiment.

### 4-1. First Configuration Example

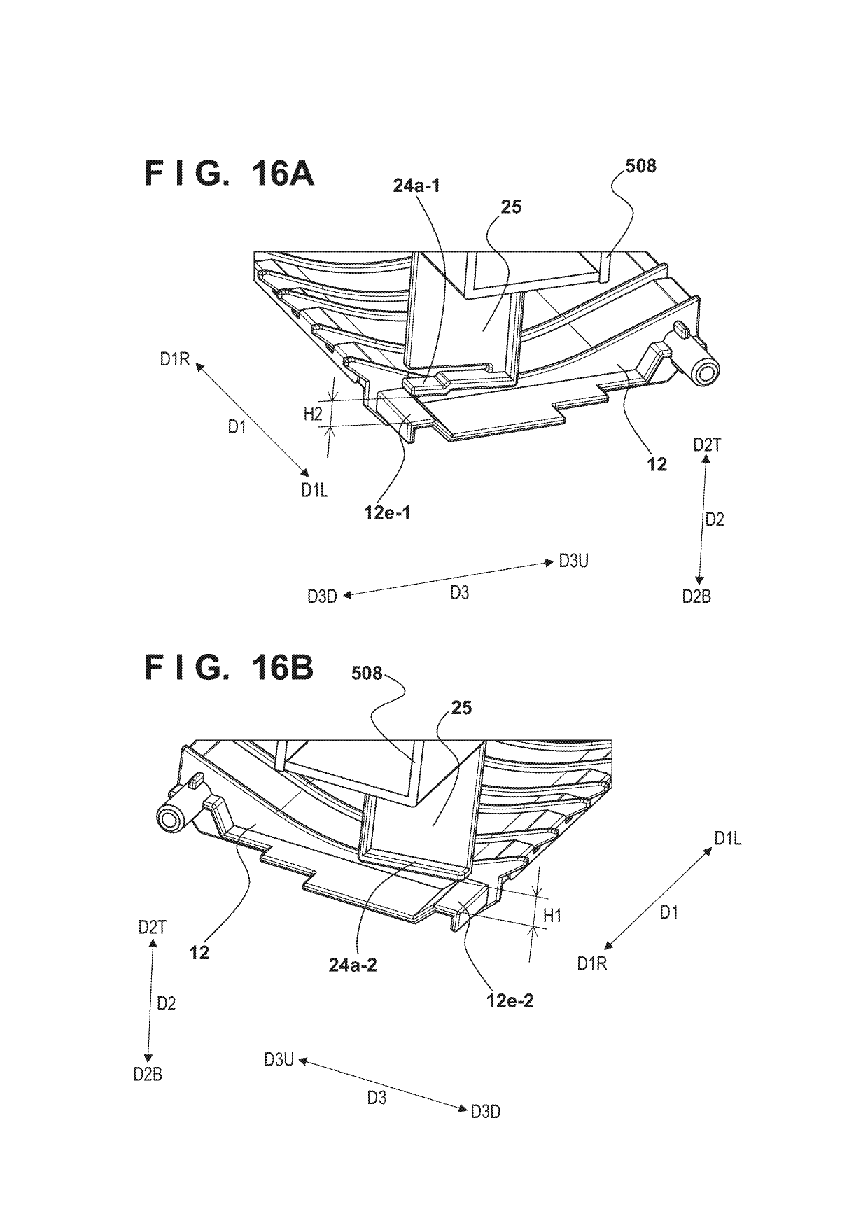

FIGS. 16A and 16B are perspective views illustrating a first configuration example for mitigating a collision sound in the fourth embodiment. FIG. 16A illustrates a partially enlarged view of left surfaces of a guide member 12 and a duct 508. FIG. 16B illustrates a partially enlarged view of right surfaces of the guide member 12 and the duct 508. In the first configuration example, at least a first contacted portion 24a-1 out of two contacted portions 24a is formed in a flexible shape. The first contacted portion 24a-1 absorbs an impact by bowing when colliding with a first contacting portion 12e-1, thereby mitigating a collision sound between the guide member 12 and regulating members.

More specifically, the first contacted portion 24a-1 illustrated in FIG. 16A is formed as a plate-like cantilever beam that branches off from a duct leg 25 and extends to the downstream side D3D. A slit exists between the first contacted portion 24a-1 and the duct leg 25. A downstream end of the first contacted portion 24a-1 is a free end. In a state where the guide member 12 is at the lower position, the distance between the downstream end of the first contacted portion 24a-1 and an upper surface of the first contacting portion 12e-1 of the guide member 12 is, for example, H2.

On the other hand, a second contacted portion 24a-2 illustrated in FIG. 16B constitutes a lower surface of a duct leg 25 without branching off from the duct leg 25. In the state where the guide member 12 is at the lower position, the distance between the second contacted portion 24a-2 and an upper surface of a second contacting portion 12e-2 of the guide member 12 is, for example, H1.

In the first configuration example, the distances H1 and H2 satisfy the relationship H2 < H1. Therefore, when the guide member 12 moves from the lower position to the home position, the first contacting portion 12e-1 collides with the first contacted portion 24a-1 earlier than the second contacting portion 12e-2 collides with the second contacted portion 24a-2. Since the downstream end of the first contacted portion 24a-1 is a free end, the first contacted portion 24a-1 bows upward while absorbing an impact and, in due course, the second contacting portion 12e-2 contacts the second contacted portion 24a-2.

At least the first contacted portion 24a-1 of the regulating members may be made of a material such as, for example, ABS resin or PC/ABS resin. Notwithstanding repetitive impacts, using such a material can prevent breakage and plastic deformation of the first contacted portion 24a-1.

It should be noted that, in a modified example of the first configuration example, the first contacted portion 24a-1 formed in a flexible shape may be a separate component attached to the duct leg 25, not a part of the duct leg 25.

### 4-2. Second Configuration Example

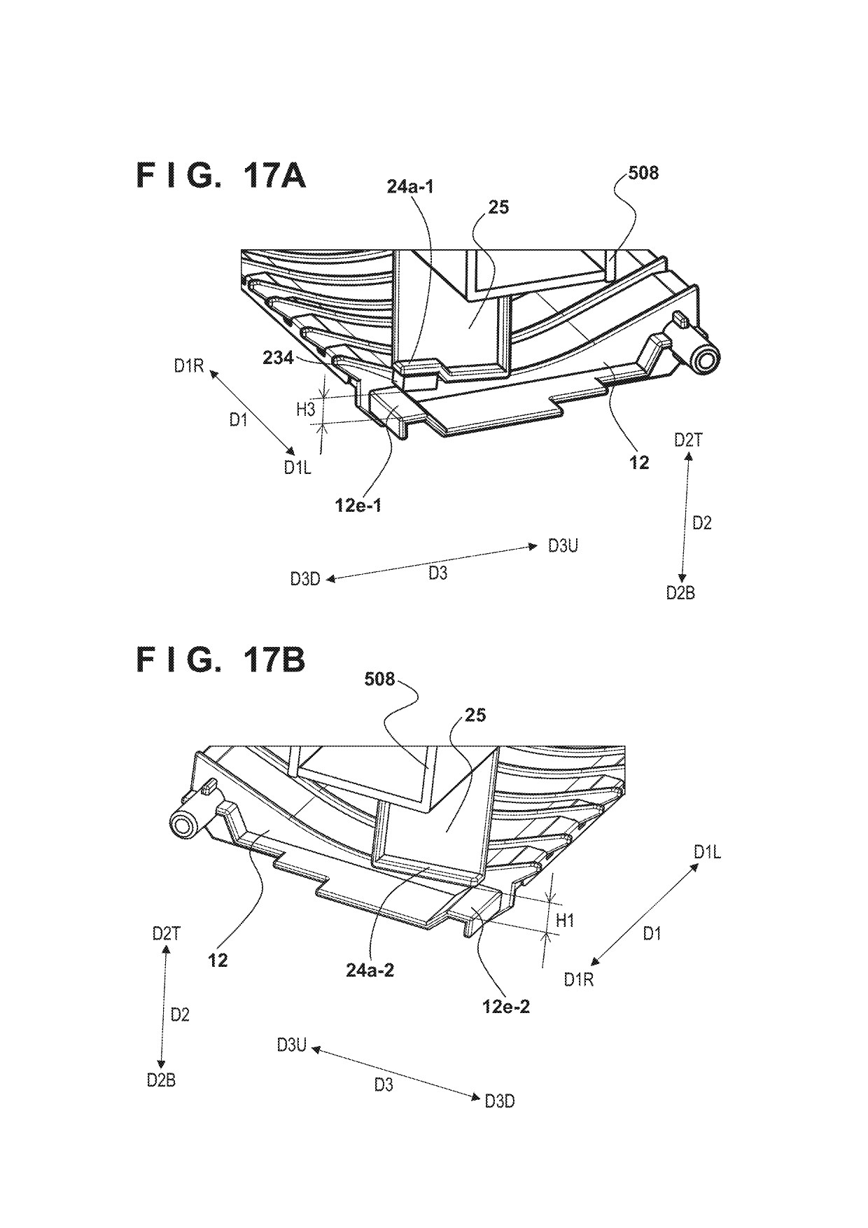

FIGS. 17A and 17B are perspective views illustrating a second configuration example for mitigating a collision sound in the fourth embodiment. FIG. 17A illustrates a partially enlarged view of the left surfaces of the guide member 12 and the duct 508. FIG. 17B illustrates a partially enlarged view of the right surfaces of the guide member 12 and the duct 508. In the second configuration example, the regulating members further include a first compressible member 234 disposed on at least a first contacted portion 24a-1 out of two contacted portions 24a. A first contacting portion 12e-1 contacts the first contacted portion 24a-1 via the first compressible member 234. The first compressible member 234 absorbs an impact by contracting when colliding with the first contacting portion 12e-1, thereby mitigating a collision sound.

More specifically, referring to FIG. 17A, the first compressible member 234 is disposed in a fixed manner on the first contacted portion 24a-1 that is a lower surface of the duct leg 25 of the duct 508. A method of fixing the first compressible member 234 onto the first contacted portion 24a-1 may be any method such as using, for example, double-sided tape or adhesive. The first compressible member 234 may be made of, for example, rubber, foam rubber, or nonwoven fabric. The distance between an upper surface of the first contacting portion 12e-1 of the guide member 12 at the lower position and a lower surface of the first compressible member 234 is, for example, H3.

On the other hand, referring to FIG. 17B, no compressible member is disposed on a second contacted portion 24a-2 that is a lower surface of the duct leg 25. The distance between an upper surface of a second contacting portion 12e-2 of the guide member 12 at the lower position and a lower surface of the second contacted portion 24a-2 is H1.

In the second configuration example, the distances H1 and H3 satisfy the relationship H3 < H1. Therefore, when the guide member 12 moves from the lower position to the home position, the first contacting portion 12e-1 collides with the first contacted portion 24a-1 via the first compressible member 234 earlier than the second contacting portion 12e-2. Then, the first compressible member 234 contracts while absorbing an impact and, in due course, the second contacting portion 12e-2 contacts the second contacted portion 24a-2.

### 4-3. Third Configuration Example

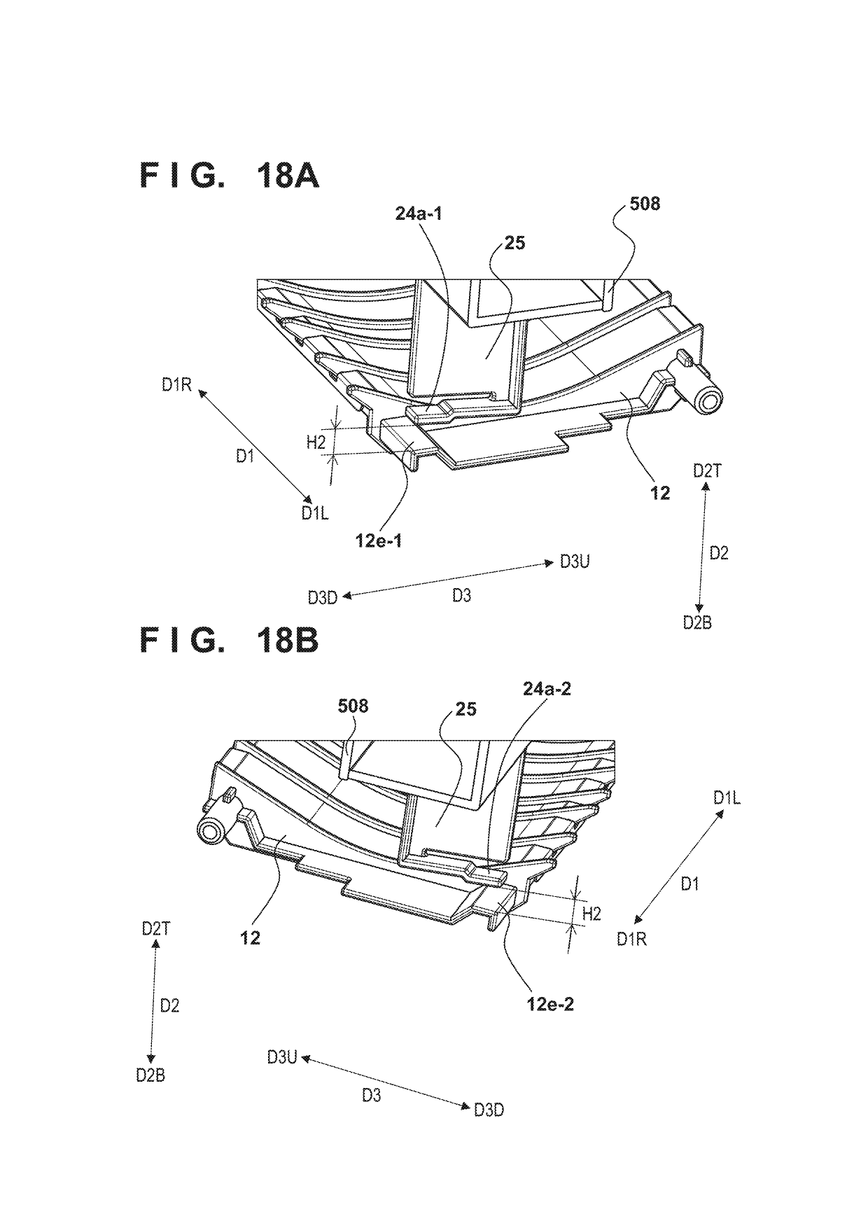

FIGS. 18A and 18B are perspective views illustrating a third configuration example for mitigating a collision sound in the fourth embodiment. FIG. 18A illustrates a partially enlarged view of the left surfaces of the guide member 12 and the duct 508. FIG. 18B illustrates a partially enlarged view of the right surfaces of the guide member 12 and the duct 508. In the third configuration example, both a first contacted portion 24a-1 and a second contacted portion 24a-2 out of two contacted portions 24a are formed in a flexible shape. The first contacted portion 24a-1 and the second contacted portion 24a-2 together absorb an impact by bowing when colliding with corresponding contacting portions 12e-1, 12e-2 of the guide member 12, thereby mitigating a collision sound.

More specifically, the configuration of the first contacted portion 24a-1 illustrated in FIG. 18A is identical to that illustrated in FIG. 16A. The second contacted portion 24a-2 illustrated in FIG. 18B is formed as a plate-like cantilever beam that branches off from the duct leg 25 and extends to the downstream side D3D. A slit exists between the second contacted portion 24a-2 and the duct leg 25. A downstream end of the second contacted portion 24a-2 is a free end. In the state where the guide member 12 is at the lower position, the distance between the downstream end of the second contacted portion 24a-2 and an upper surface of the second contacting portion 12e-2 of the guide member 12 is, for example, H2.

In the third configuration example, when the guide member 12 moves from the lower position to the home position, the first contacted portion 24a-1 and the second contacted portion 24a-2 collide with the first contacting portion 12e-1 and the second contacting portion 12e-2, respectively, and then bow upward while absorbing an impact. In the present configuration example, since the two contacted portions 24a absorb an impact, the effect of mitigating a collision sound can be further enhanced.

It should be noted that, in a modified example of the third configuration example, the first contacted portion 24a-1 and the second contacted portion 24a-2 formed in a flexible shape may be separate components attached to the duct legs 25, not parts of the duct legs 25.

### 4-4. Fourth Configuration Example

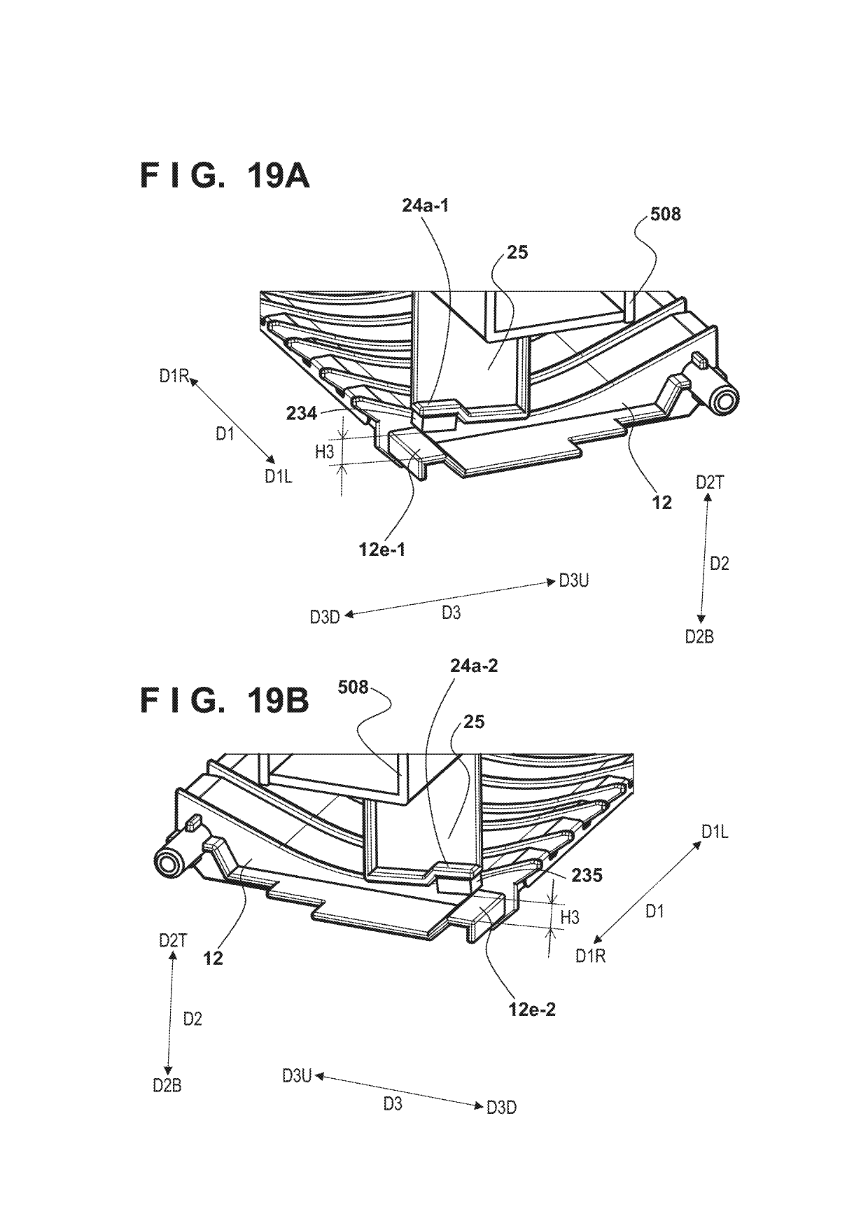

FIGS. 19A and 19B are perspective views illustrating a fourth configuration example for mitigating a collision sound in the fourth embodiment. FIG. 19A illustrates a partially enlarged view of the left surfaces of the guide member 12 and the duct 508. FIG. 19B illustrates a partially enlarged view of the right surfaces of the guide member 12 and the duct 508. In the fourth configuration example, the regulating members include a first compressible member 234 disposed on a first contacted portion 24a-1 and a second compressible member 235 disposed on a second contacted portion 24a-2.

More specifically, the configuration of the first contacted portion 24a-1 illustrated in FIG. 19A is identical to that illustrated in FIG. 17A. Referring to FIG. 19B, the second compressible member 235 is disposed in a fixed manner on the second contacted portion 24a-2 that is a lower surface of the duct leg 25 of the duct 508. The distance between an upper surface of the second contacting portion 12e-2 of the guide member 12 at the lower position and a lower surface of the second compressible member 235 is, for example, H3.

In the fourth configuration example, when the guide member 12 moves from the lower position to the home position, a first contacting portion 12e-1 contacts the first contacted portion 24a-1 via the first compressible member 234, and the second contacting portion 12e-2 contacts the second contacted portion 24a-2 via the second compressible member 235. The first compressible member 234 and the second compressible member 235 absorb an impact by contracting when pressed, thereby mitigating a collision sound. In the present configuration example, since the two compressible members are used, the effect of mitigating a collision sound can be further enhanced.

Naturally, the present configuration example is applicable to a case where a member different from the duct 508 is used as a regulating member. As in the present configuration example, by disposing a structure (for example, compressible member) for mitigating a collision sound not a movable guide member 12 but on a fixed regulating member, it is possible to reduce a risk of malfunction such as falling off of the structure.

### 5. Fifth Embodiment

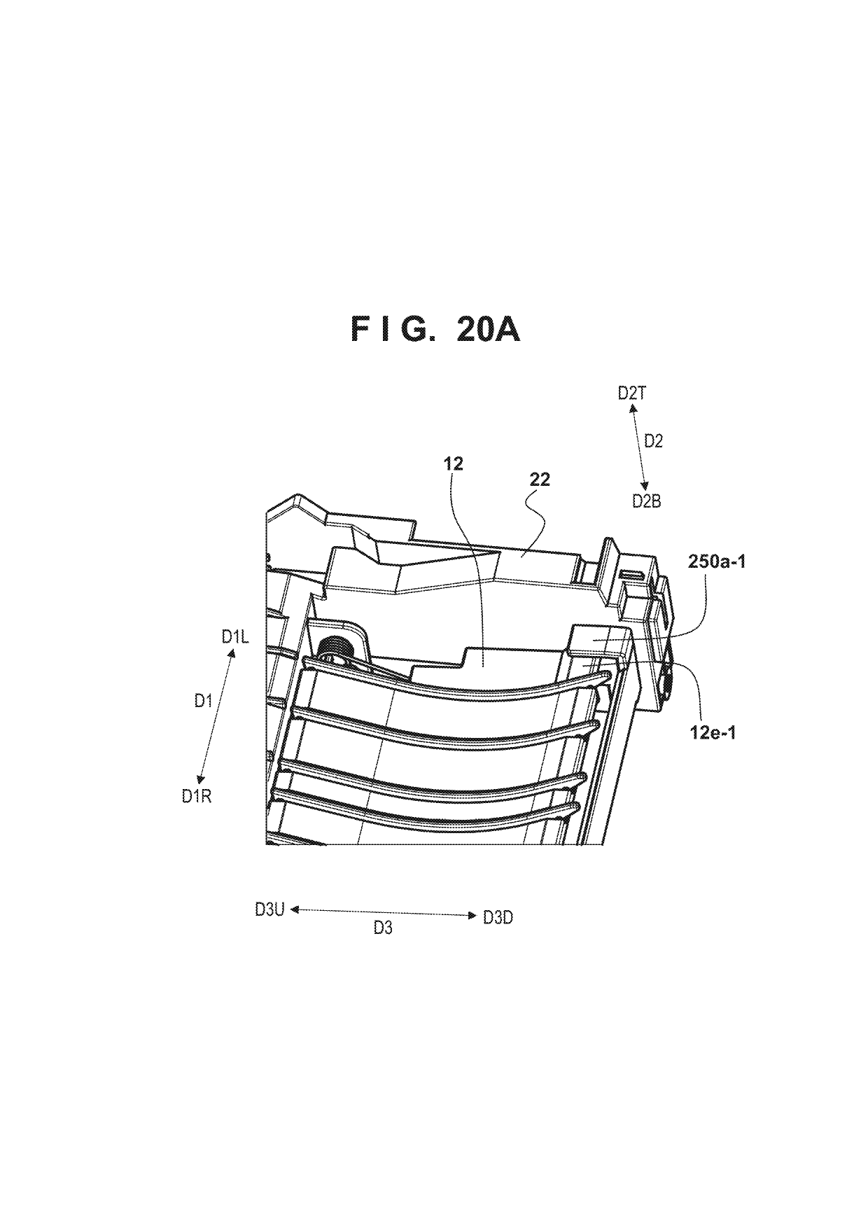

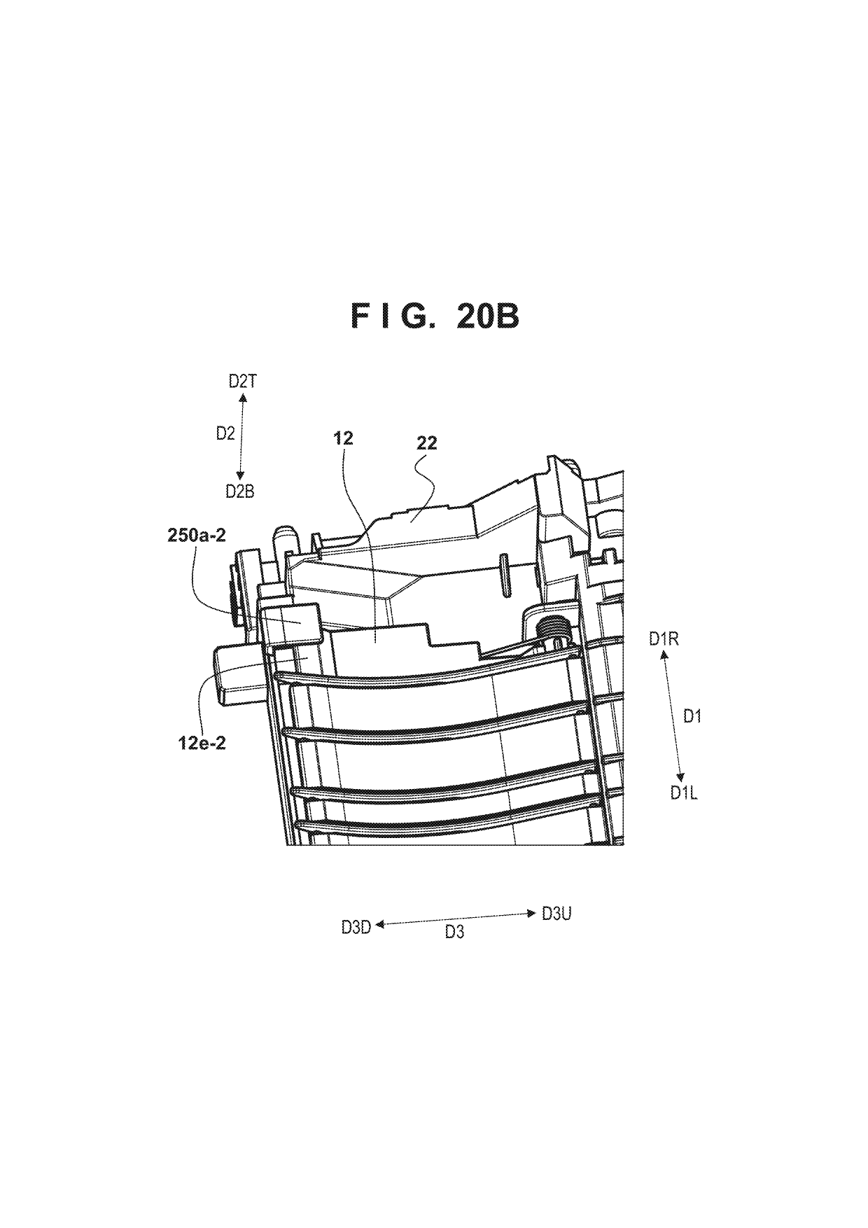

In the first embodiment described above, the duct 508 serves as a regulating member that regulates the movement of the guide member 12. However, in a fifth embodiment described in this section, a constituent element of the conveyance frame unit 22 serves as a regulating member. FIGS. 20A and 20B are partial perspective views illustrating an example of a configuration of a regulating member in the fifth embodiment. FIG. 20A illustrates a partially enlarged view of a left end of the conveyance frame unit 22 in a state where the guide member 12 is at the lower position. FIG. 20B illustrates a partially enlarged view of a right end of the conveyance frame unit 22 in the state where the guide member 12 is at the lower position.

Referring to FIG. 20A, the conveyance frame unit 22 has a first regulating member 250a-1 located above a first contacting portion 12e-1 at a left end of the downstream side D3D of the guide member 12. The first regulating member 250a-1 includes a plate-like portion that is substantially parallel to the direction D1 and the direction D3. Referring to FIG. 20B, the conveyance frame unit 22 has a second regulating member 250a-2 located above a second contacting portion 12e-2 at a right end of the downstream side D3D of the guide member 12. The second regulating member 250a-2 includes a plate-like portion that is substantially parallel to the direction D1 and the direction D3 as with the first regulating member 250a-1. When the guide member 12 moves from the lower position to the home position, the first contacting portion 12e-1 contacts a lower surface of the first regulating member 250a-1, and the second contacting portion 12e-2 contacts a lower surface of the second regulating member 250a-2. This causes the guide member 12 to be positioned at the home position. In the present embodiment, the conveyance frame unit 22 movably supports the guide member 12 and includes the regulating members that regulate the movement of the guide member 12, resulting in the enhanced positioning accuracy of the guide member 12 at the home position and the higher conveyance performance for recording materials.

### 6. Sixth Embodiment

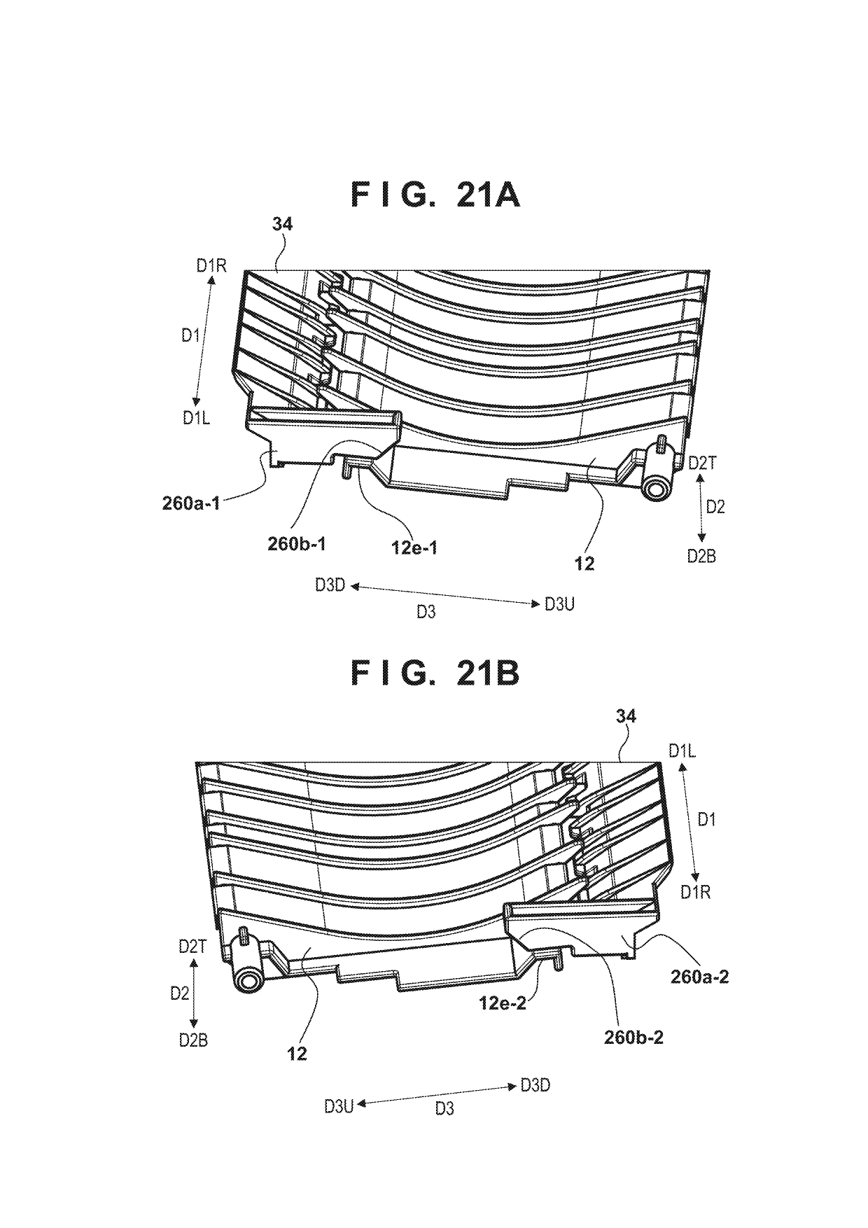

In a sixth embodiment described in this section, a constituent element of the fixing unit 507 serves as a regulating member. FIGS. 21A and 21B are partial perspective views illustrating an example of a configuration of a regulating member in the sixth embodiment. FIG. 21A illustrates a partially enlarged view of left ends of the conveyance guide 506 and the fixing unit 507 in a state where the guide member 12 is at the home position. FIG. 21B illustrates a partially enlarged view of right ends of the conveyance guide 506 and the fixing unit 507 in the state where the guide member 12 is at the home position.

Referring to FIG. 21A, the first fixed guide 34 of the fixing unit 507 includes a first regulating member 260a-1 located above a first contacting portion 12e-1 at a left end of the downstream side D3D of the guide member 12 of the conveyance guide 506. The first regulating member 260a-1 is a cantilever beam-like member extending to the upstream side D3U in the direction D3 and, on the lower side D2B of an upstream end thereof, has a first contacted portion 260b-1 inclined in a tapered shape. Referring to FIG. 21B, the first fixed guide 34 of the fixing unit 507 includes a second regulating member 260a-2 located above a second contacting portion 12e-2 at a right end of the downstream side D3D of the guide member 12 of the conveyance guide 506. The second regulating member 260a-2 is a cantilever beam-like member extending to the upstream side D3U in the direction D3 and, on the lower side D2B of an upstream end thereof, has a second contacted portion 260b-2 inclined in a tapered shape. When the guide member 12 moves from the lower position to the home position, the first contacting portion 12e-1 contacts the first contacted portion 260b-1 of the first regulating member 260a-1, and the second contacting portion 12e-2 contacts the second contacted portion 260b-2 of the second regulating member 260a-2. This causes the guide member 12 to be positioned at the home position. In the present embodiment, the fixing unit 507 includes the regulating members that regulate the movement of the guide member 12, resulting in the enhanced accuracy of a relative positional relationship of the guide member 12 at the home position with respect to the fixing nip N_{F} and the higher conveyance performance for recording materials.

Incidentally, fixing units require frequent replacement due to causes such as the end of lifetime or failure. For that reason, in many cases, fixing units are configured so as to be attachable to and detachable from an image forming apparatus. In the present embodiment, it is assumed that the fixing unit 507 is attached and detached in the direction D3. That is, when the fixing unit 507 is detached from an image forming apparatus 500, the fixing unit 507 is withdrawn toward the downstream side D3D. On the other hand, when the fixing unit 507 is mounted to the image forming apparatus 500, the fixing unit 507 is inserted toward the upstream side D3U.

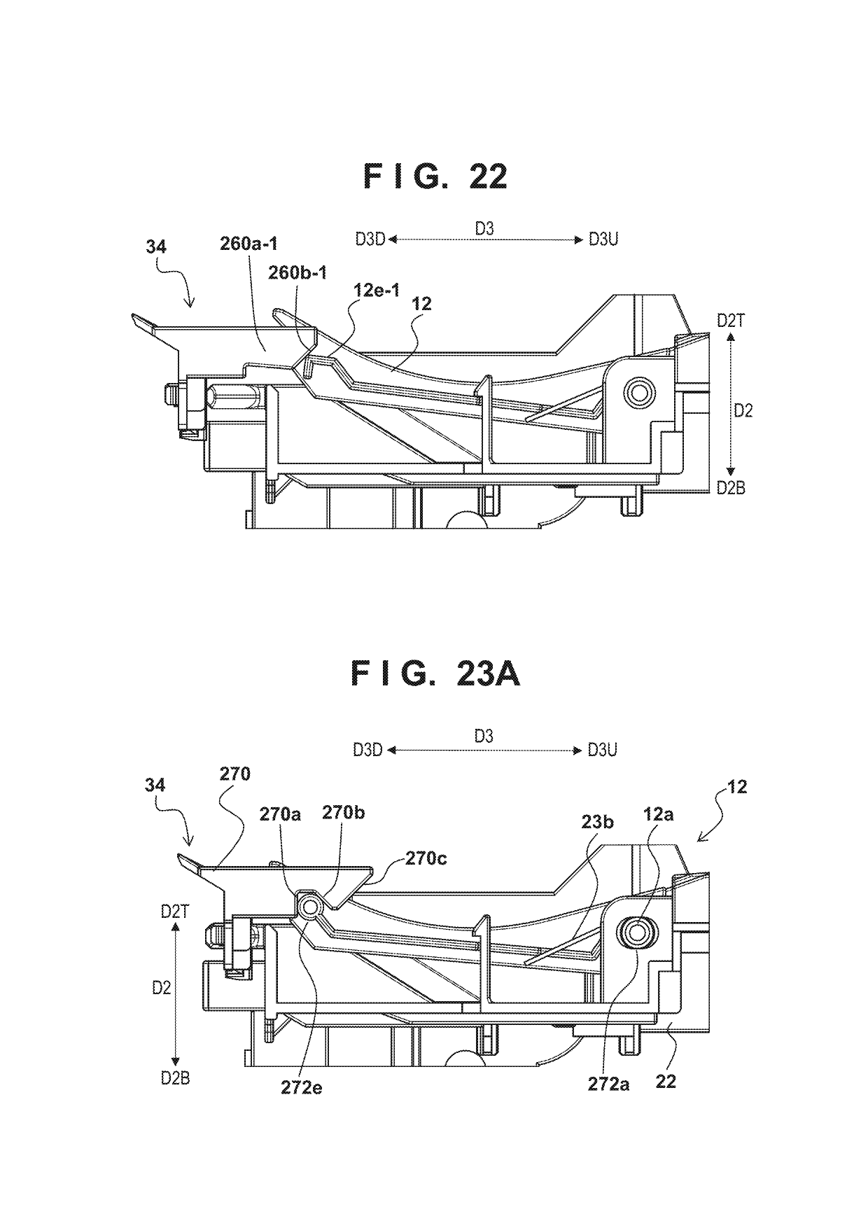

FIG. 22 is a partial cross-sectional view for describing mounting of the fixing unit 507 to the image forming apparatus 500 in the sixth embodiment. As illustrated in FIG. 22, when the fixing unit 507 is mounted to the image forming apparatus 500, a downstream end of the first contacting portion 12e-1 of the guide member 12 contacts the first contacted portion 260b-1 of the first regulating member 260a-1 of the first fixed guide 34. Since the first contacted portion 260b-1 is inclined with respect to an insertion direction of the fixing unit 507 (that is, the direction D3), the first contacted portion 260b-1 pushes the first contacting portion 12e-1 down when the fixing unit 507 is inserted toward the upstream side D3U. As a result, the first contacting portion 12e-1 of the guide member 12 can be located below the first regulating member 260a-1 of the first fixed guide 34 without inhibiting the mounting of the fixing unit 507. Although not illustrated, the second contacting portion 12e-2 of the guide member 12 also behaves in a similar manner with respect to the second regulating member 260a-2 of the first fixed guide 34.

As in the present embodiment, by inclining surfaces of an attachable and detachable unit to be contacted by the contacting portions 12e of the guide member 12 with respect to the mounting direction of the unit, it is possible to reduce a possibility of occurrence of malfunction such as an attachment defect or member breakage in an operation of mounting the unit. This leads to enhanced efficiency of operations such as, for example, assembling the image forming apparatus 500 and replacing the fixing unit 507. It should be noted that, although an example has been described above in which the regulating members that regulate the movement of the guide member 12 are provided with inclined surfaces, the contacting portions 12e of the guide member 12 (or both the regulating members and the contacting portions 12e) may be provided with inclined surfaces.

### 7. Seventh Embodiment

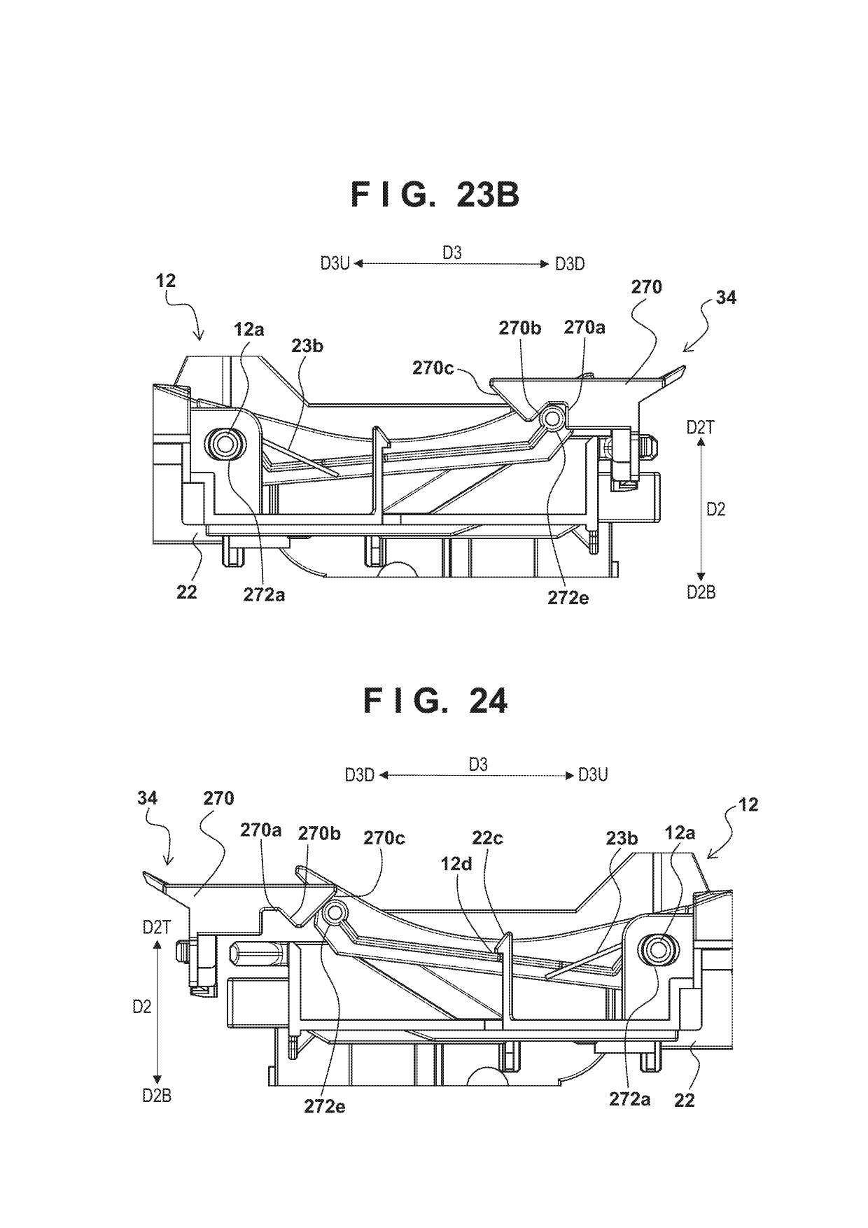

In a seventh embodiment described in this section, as in the sixth embodiment, a constituent element of the fixing unit 507 serves as a regulating member. FIGS. 23A and 23B are partial cross-sectional views illustrating an example of a configuration of a regulating member in the seventh embodiment. FIG. 23A illustrates a partially enlarged view of left ends of the conveyance guide 506 and the fixing unit 507 in a state where the guide member 12 is at the home position. FIG. 23B illustrates a partially enlarged view of right ends of the conveyance guide 506 and the fixing unit 507 in the state where the guide member 12 is at the home position.

Referring to FIGS. 23A and 23B, a rotation axis 12a of the guide member 12 is rotatably supported by a bearing portion 272a disposed on a frame of a conveyance frame unit 22. The bearing portion 272a may be a tubular hole extending in the direction D1. A cross section of the tubular hole of the bearing portion 272a is a rounded rectangle having a major axis extending in the direction D3, and gaps allowing the rotation axis 12a to be displaced in the direction D3 exist on the upstream side D3U and the downstream side D3D of the rotation axis 12a.

The guide member 12 has a contacting portion 272e formed in a cylindrical shape having a circular cross section as viewed from the direction D1. Meanwhile, a first fixed guide 34 of the fixing unit 507 has a pair of regulating members 270 of a cantilever beam-like shape extending to the upstream side D3U in the direction D3. A lower surface of each regulating member 270 has an inclined surface 270c inclined in a tapered shape and a recess 270a at a position facing the contacting portion 272e. An inner surface 270b of the recess 270a on the upstream side D3U is inclined at an angle opposite to that of the inclined surface 270c. Thus, when the guide member 12 is at the home position, the contacting portion 272e of the guide member 12 fits in the recess 270a of the regulating member 270 and contacts the inner surface of the recess 270a at at least two points. In the present embodiment, although the guide member 12 is rotatable in the direction D2 and is displaceable in the direction D3, the above-described contact between the contacting portion 272e and the recess 270a regulates the movement of the guide member 12 at the home position in both the direction D2 and the direction D3. This makes it possible to further enhance the accuracy of a positional relationship between the first fixed guide 34 and the guide member 12 disposed on the separate units and improve the conveyance performance for recording materials.

In addition, the inclined surface 270c of the regulating member 270 provides effects similar to those described in the sixth embodiment, such as preventing an attachment defect or member breakage and enhancing the efficiency of assembling and replacement operations.

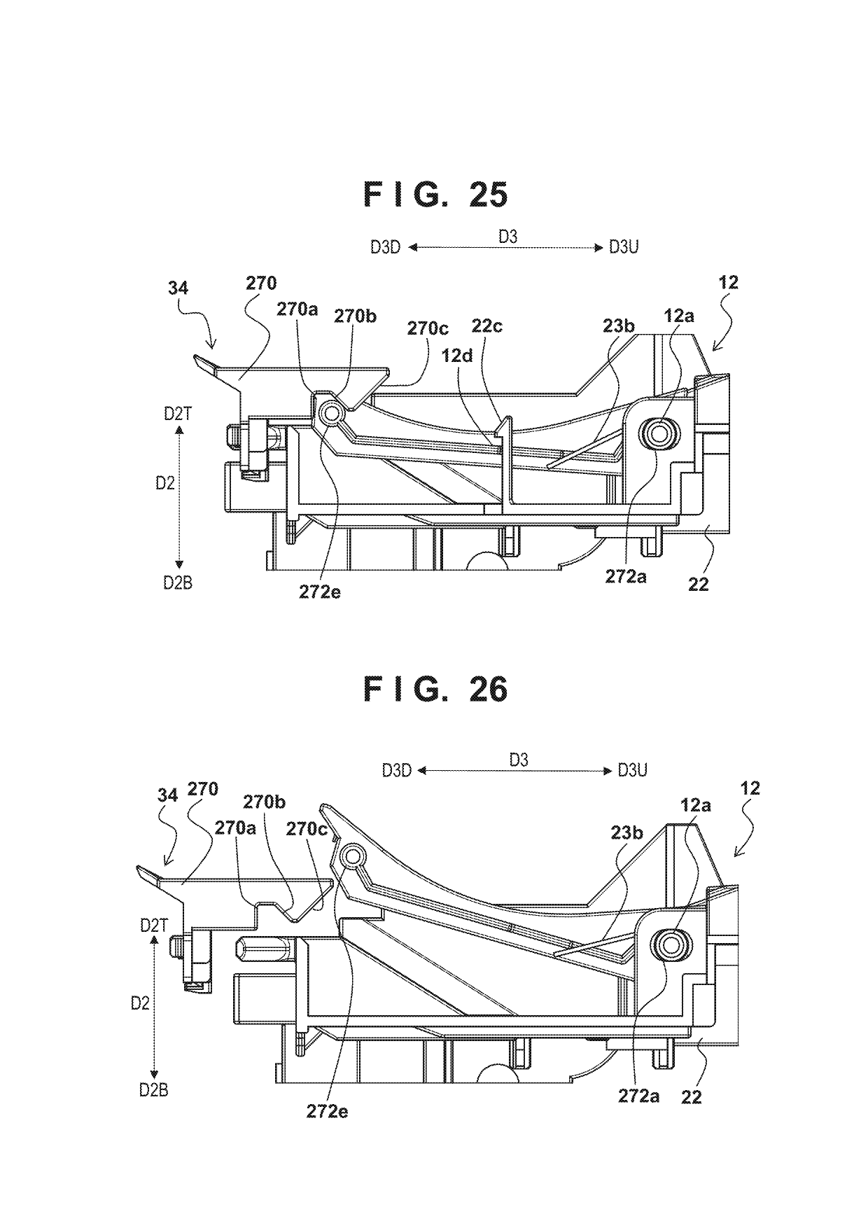

FIGS. 24 and 25 are partial cross-sectional views for describing attachment and detachment of the fixing unit 507 to and from an image forming apparatus 500 in the present embodiment. As illustrated in FIG. 24, when the fixing unit 507 is mounted to the image forming apparatus 500, a cylindrical surface of the contacting portion 272e of the guide member 12 contacts the inclined surface 270c of the regulating member 270 of the first fixed guide 34. When the fixing unit 507 is inserted toward the upstream side D3U, the inclined surface 270c pushes the contacting portion 272e down. In due course, when the contacting portion 272e overcomes a lower end of the inclined surface 270c, the contacting portion 272e enters the recess 270a as illustrated in FIG. 25, and thus the guide member 12 is pushed by an arm 23b and rises to the upper side D2T. Then, the contacting portion 272e contacts the inner surface of the recess 270a at at least two points, and the movement of the guide member 12 stops.

Contrarily, when the fixing unit 507 is detached from the image forming apparatus 500, the cylindrical surface of the contacting portion 272e of the guide member 12 contacts the inner surface 270b of the recess 270a of the regulating member 270 of the first fixed guide 34 as illustrated in FIG. 25. When the fixing unit 507 is pulled toward the downstream side D3D, the inner surface 270b pushes the contacting portion 272e down. In due course, when the contacting portion 272e escapes from the recess 270a, as illustrated in FIG. 24, the guide member 12 is pushed by the arm 23b and rises to the upper side D2T. Then, a snap-fit receiving portion 12d of the guide member 12 engages with a snap-fit unit 22c, and the movement of the guide member 12 stops.

As in the present embodiment, by inclining surfaces of an attachable and detachable unit to be contacted by the contacting portion 272e of the guide member 12 with respect to the attachment and detachment direction, operations of attaching and detaching the unit become smoother, and a risk of occurrence of malfunction such as an attachment defect or member breakage is reduced. This leads to enhanced efficiency of operations such as, for example, assembling the image forming apparatus 500 and replacing the fixing unit 507. It should be noted that, although an example has been described in which the regulating members that regulate the movement of the guide member 12 are provided with recesses, the contacting portion 272e of the guide member 12 may be provided with recesses.

FIG. 26 is a partial cross-sectional view related to a comparative example in which the conveyance frame unit 22 has no snap-fit unit 22c. In this comparative example, when the fixing unit 507 is detached from the image forming apparatus 500, the fixing unit 507 is pulled toward the downstream side D3D, and the contacting portion 272e escapes from the recess 270a. Then, the guide member 12 is pushed by the arm 23b and rises to the upper side D2T. However, since the conveyance frame unit 22 has no snap-fit unit 22c, the guide member 12 does not stop at the position of FIG. 24 and further rises to the upper side D2T (rotates counterclockwise in the figure). In due course, the contacting portion 272e reaches the upper side D2T above an upstream end of the regulating member 270. When the arm 23b is fully open and no biasing force of a guide spring works, the movement of the guide member 12 stops. In this state, when the fixing unit 507 is mounted to the image forming apparatus 500, it is necessary to insert the fixing unit 507 to the upstream side D3U with the guide member 12 manually pressed against the biasing force. By contrast, in the example illustrated in FIG. 24, the snap-fit receiving portion 12d of the guide member 12 engages with the snap-fit unit 22c and prevents the guide member 12 from rotating further, which eliminates the need to press the guide member 12 against the biasing force during mounting the fixing unit 507. This leads to further enhanced efficiency of operations such as assembling the image forming apparatus 500 and replacing the fixing unit 507.

A height of the snap-fit unit 22c (or engagement position with the snap-fit receiving portion 12d) may be determined such that a height of the contacting portion 272e during the engagement does not exceed a height of the upstream end of the regulating member 270 of the first fixed guide 34 and exceeds a height of the contacting portion 272e at the home position.

### 8. Eighth Embodiment

In the first embodiment, an example has been described in which the pair of guide springs 23L, 23R attached to both ends of the guide member 12 in the direction D1 are used as elastic members that bias the guide member 12 toward the home position. In contrast, in an eighth embodiment described in this section, a guide spring as an elastic member is attached only to one end of a guide member 12 in the direction D1.

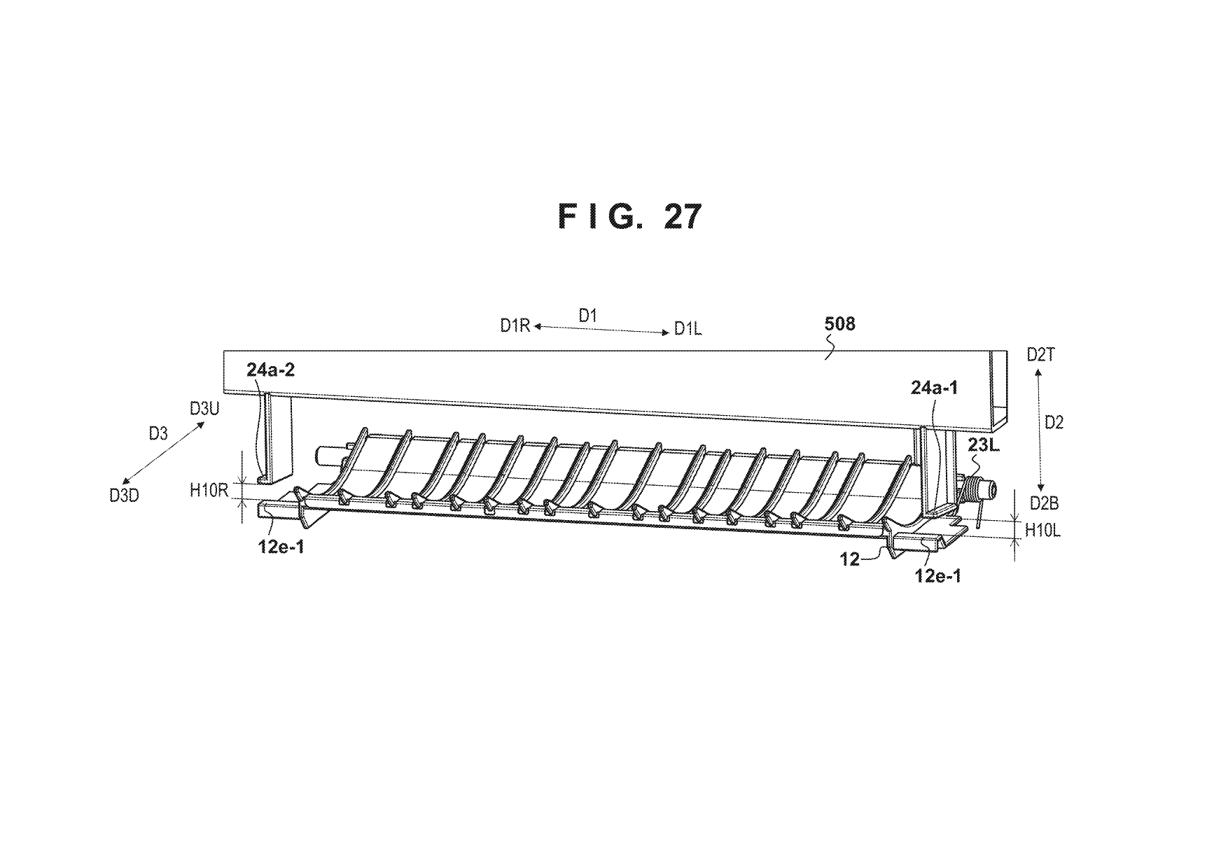

FIG. 27 is a partial perspective view illustrating an example of a configuration of the guide member 12 in the eighth embodiment in a state where the guide member 12 is at the lower position. Referring to FIG. 27, while a guide spring 23L is attached to a left end of the upstream side D3U of the guide member 12, no guide spring is attached to a right end. In this state, the distance between a first contacting portion 12e-1 of the guide member and a first contacted portion 24a-1 of the duct 508 is denoted by H10L, and the distance between a second contacting portion 12e-2 of the guide member and a second contacted portion 24a-2 of the duct 508 is denoted by H10R.

Here, assume that the guide member 12 has no deformation and no dimensional error and H10L = H10R holds. In this case, even when only the guide spring 23L is an elastic member that biases the guide member 12, the contacting portions 12e-1, 12e-2 at both ends of the guide member 12 that has moved from the lower position to the home position contact the corresponding contacted portions 24a-1, 24a-2, respectively.

On the other hand, in a case where the guide member 12 is, for example, warped and H10L > H10R holds, when the guide member 12 moves to the home position, the second contacting portion 12e-2 contacts the second contacted portion 24a-2 earlier than the first contacting portion 12e-1 contacts the first contacted portion 24a-1. However, a biasing force of the guide spring 23L further pushes the first contacting portion 12e-1 up and, in due course, the first contacting portion 12e-1 also contacts the first contacted portion 24a-1. Contrarily, in a case where H10L < H10R holds, a guide spring 23R is desirably attached to the right end of the upstream side D3U of the guide member 12 instead of the guide spring 23L (or an attachment position is changed). This allows the contacting portions 12e-1, 12e-2 at both ends of the guide member 12 that has moved to the home position to contact the corresponding contacted portions 24a-1, 24a-2, respectively.

In this manner, even in a case where one of the guide springs 23L, 23R is omitted, the guide member 12 can be positioned at the home position. When one of the guide springs 23L, 23R is omitted, manufacturing cost is reduced by the reduction of the number of components, and miniaturization of the apparatus is also promoted.

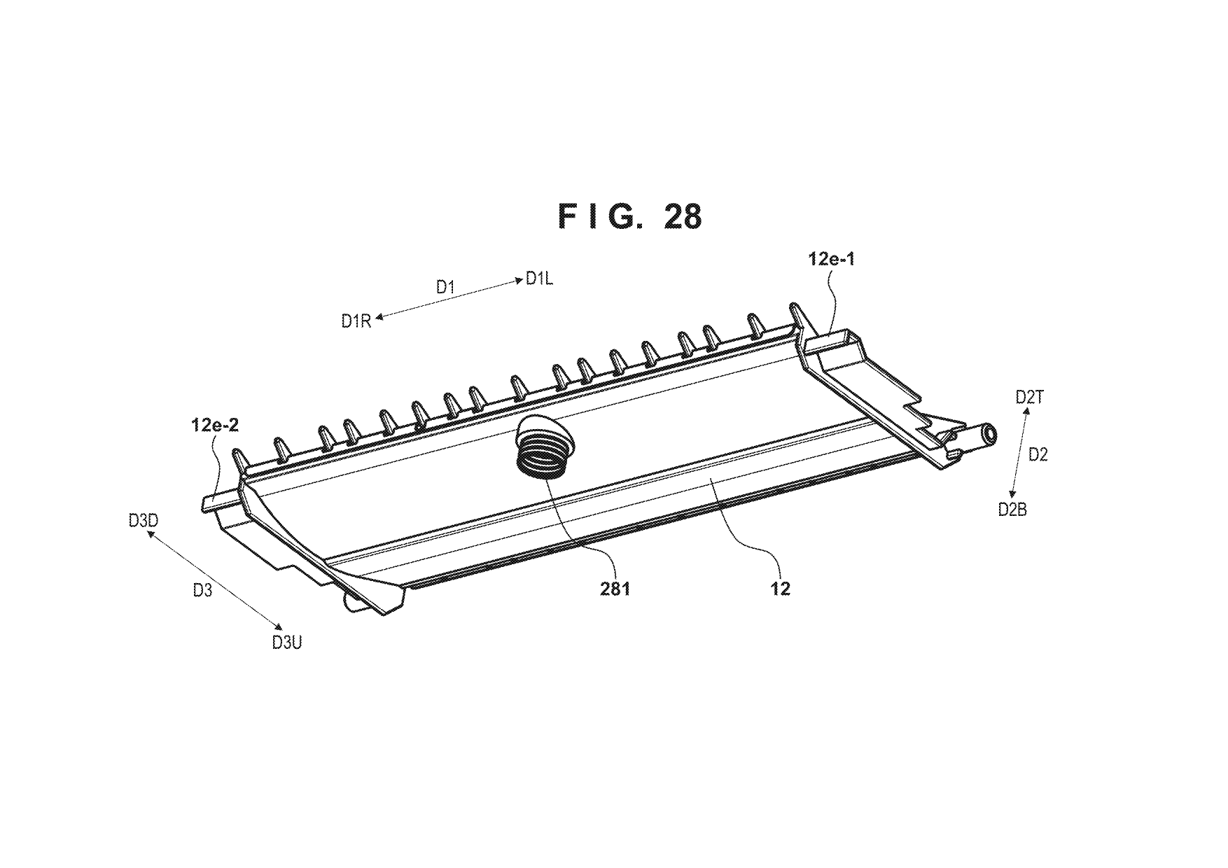

Note that an elastic member that biases the guide member 12 toward the home position may be attached to the vicinity of the middle, not an end portion, of the guide member 12 in the direction D1. FIG. 28 is a partial perspective view illustrating an example of a configuration of the guide member 12 according to such a modified example. Referring to FIG. 28, a guide spring 281 is attached to the middle of the downstream side D3D of a lower surface of the guide member 12. The guide spring 281 is a compression spring. Although not illustrated, a lower end of the guide spring 281 is attached to the conveyance frame unit 22. In this state, as in FIG. 27, the distance between the first contacting portion 12e-1 of the guide member and the first contacted portion 24a-1 of the duct 508 is denoted by H10L, and the distance between the second contacting portion 12e-2 of the guide member and the second contacted portion 24a-2 of the duct 508 is denoted by H10R.

In a case where the guide member 12 has no deformation and no dimensional error and H10L = H10R holds, the contacting portions 12e-1, 12e-2 at both ends of the guide member 12 that has moved from the lower position to the home position simultaneously contact the corresponding regulating members.

On the other hand, in a case where the guide member 12 is, for example, warped and H10L > H10R holds, when the guide member 12 moves to the home position, the second contacting portion 12e-2 contacts the regulating member earlier than the first contacting portion 12e-1 contacts the regulating member. However, a biasing force of the guide spring 281 further pushes the first contacting portion 12e-1 up and, in due course, the first contacting portion 12e-1 also contacts the regulating member. Alternatively, by arranging the attachment position of the guide spring 281 to be adjustable and attaching the guide spring 281 to a position offset to the left side D1L from the middle, it is possible to correct the difference between the left and right of the guide member 12 and make both ends of the guide member 12 more surely contact the regulating members. The same applies to the case where H10L < H10R holds.

In this manner, even in a case where the guide spring is attached to the vicinity of the middle of the guide member 12, the guide member 12 can be positioned at the home position. In the present modified example, since there is no need to secure space for attachment of guide springs at both ends of the guide member 12, miniaturization of the apparatus can be further promoted.

### 9. Ninth Embodimen

In the first embodiment, an example has been described in which, in the drive transmission mechanism 35, the solenoid 28 displaces the plunger 28a in the direction D1. In contrast, in a ninth embodiment described in this section, a solenoid of a drive transmission mechanism displaces a plunger in a direction different from the direction D1.

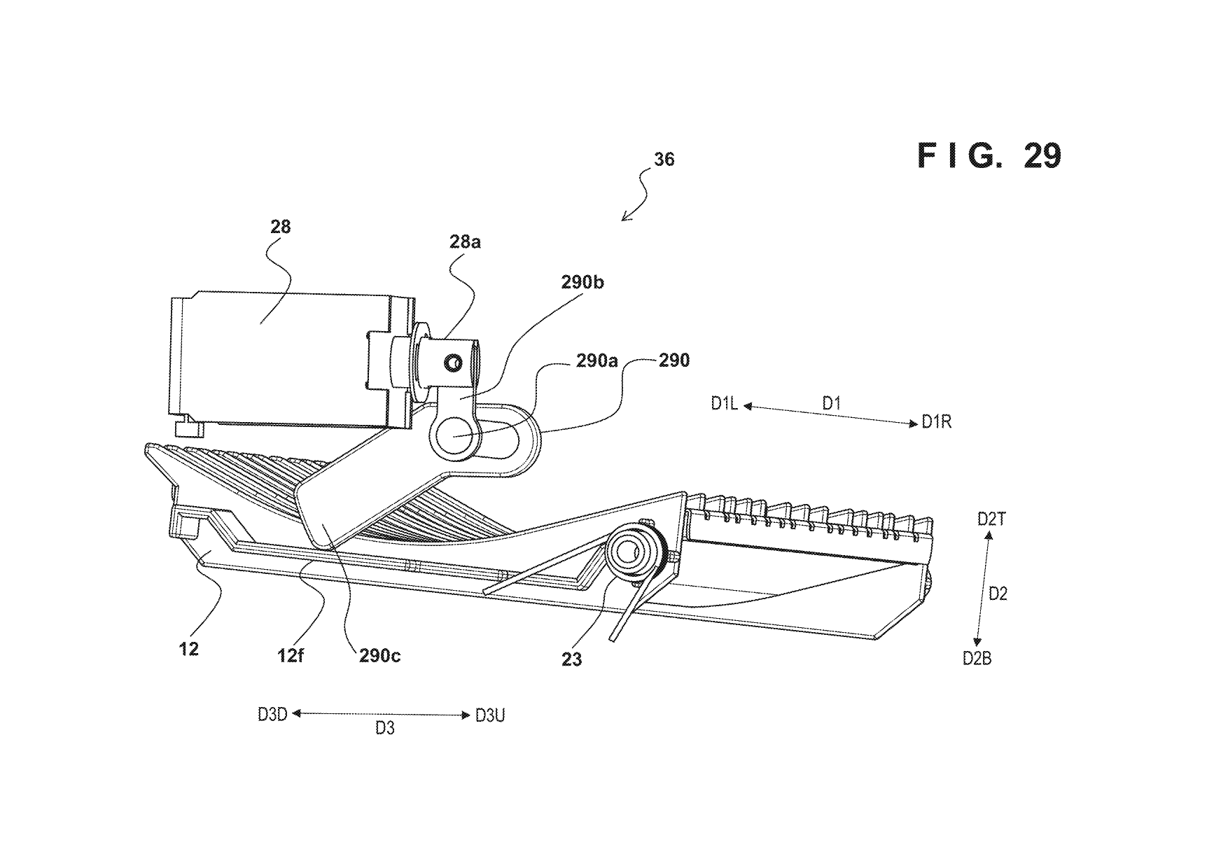

FIG. 29 is a partial perspective view illustrating a drive transmission mechanism 36 for moving the guide member 12 in a state where the guide member 12 is at the home position. In the example of FIG. 29, a solenoid 28 is attached to a left wall 27 (not illustrated) of the housing 501. The solenoid 28 can generate a magnetic field based on electric power supplied from a power supply (not illustrated) and displace a plunger 28a in the direction D3. The drive transmission mechanism 36 includes, in addition to the solenoid 28 and the plunger 28a, a fourth pressing member 290. The fourth pressing member 290 is rotatably supported by a rotation axis 290a fixed to the left wall 27 of the housing 501, and has a coupling portion 290b coupled to the plunger 28a and a pressing portion 290c in contact with a pressed portion 12f of the guide member 12.

In the example of FIG. 29, the solenoid 28 does not generate a magnetic field, and the guide member 12 biased toward the upper side D2T by a guide spring 23 is maintained at the home position by a regulating member regulating the movement thereof. At this time, the plunger 28a is maintained at a most advanced position on the upstream side D3U.

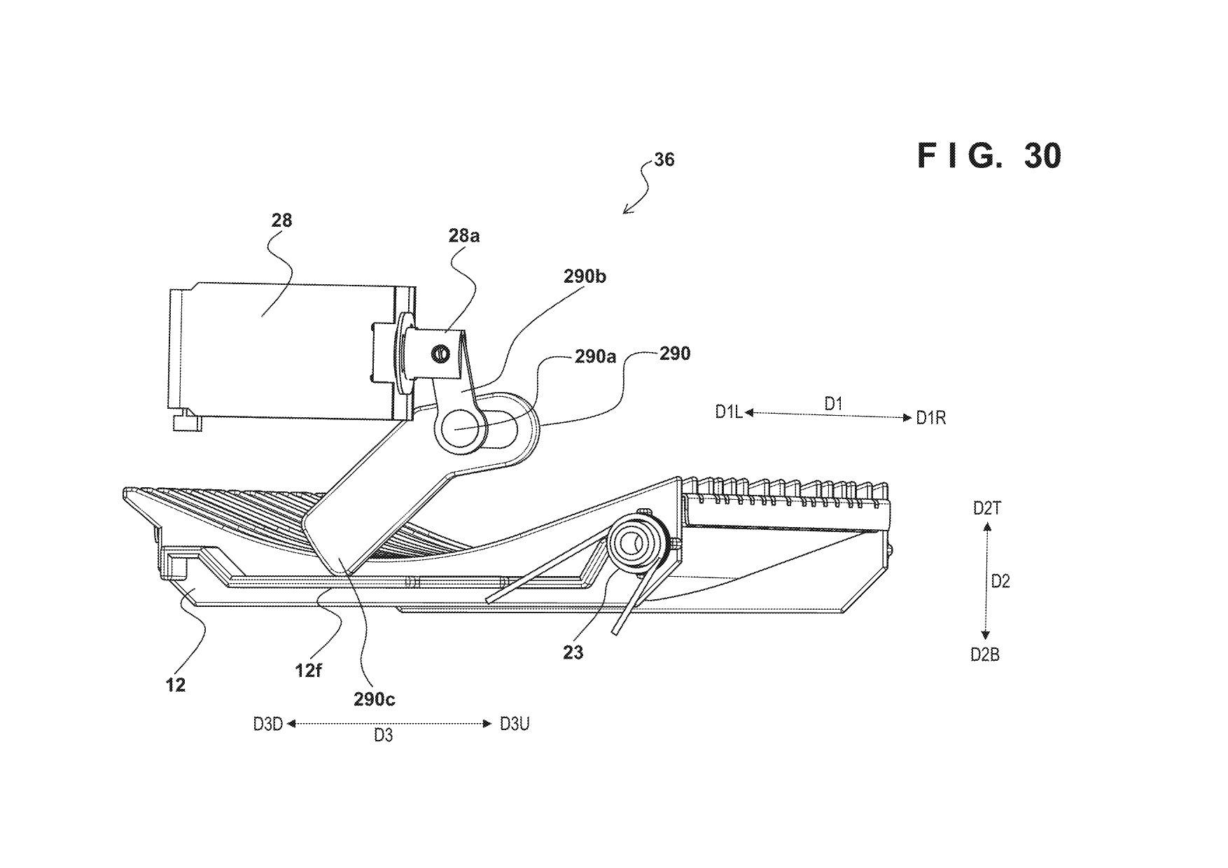

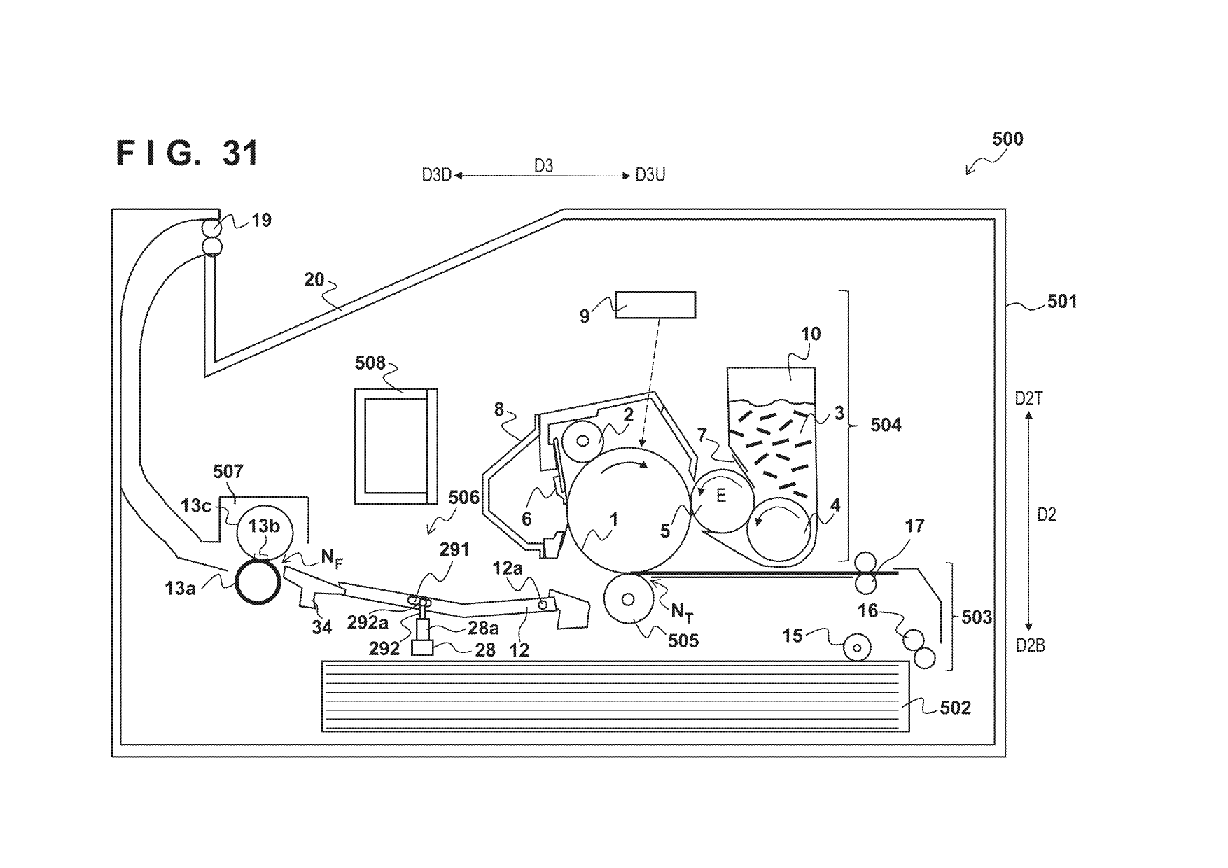

When lowering the guide member 12, a controller energizes and causes the solenoid 28 to generate a magnetic field, and the solenoid 28 attracts the plunger 28a to the downstream side D3D. Then, the fourth pressing member 290 rotates, in conjunction with the plunger 28a, counterclockwise in the figure, and the pressing portion 290c of the fourth pressing member 290 pushes the pressed portion 12f of the guide member 12 down. In due course, when the plunger 28a stops at a most retracted position on the downstream side D3D, the fourth pressing member 290 also stops rotating, and the guide member 12 is positioned at the lower position (see FIG. 30).

Contrarily, when returning the guide member 12 to the home position, the controller stops energizing the solenoid 28 and dissipates the magnetic field. Then, the biasing force of the guide spring 23 causes the fourth pressing member 290 to rotate clockwise in the figure, and the plunger 28a advances toward the upstream side D3U in conjunction with the coupling portion 290b of the fourth pressing member 290. As a result, the guide member 12 is positioned at the home position again.

In general, a movement amount of a plunger driven by a solenoid is not large. However, by properly designing a ratio of the length of the pressing portion 290c with respect to the length of the coupling portion 290b from the rotation axis 290a of the fourth pressing member 290, it is possible to secure a sufficient movement amount of the guide member 12 even with a small movement amount of the plunger.

The pressing portion 290c of the fourth pressing member 290 and the pressed portion 12f of the guide member 12 slide on each other when moving the guide member 12. For that reason, at least the pressing portion 290c of the fourth pressing member 290 is desirably formed of a material having high wear resistance such as, for example, polyacetal (POM). This can prevent scraping, wear, and abnormal sound due to the sliding from occurring.

FIG. 31 is a schematic cross-sectional view illustrating an example of a schematic configuration of an image forming apparatus according to a modified example of the ninth embodiment. In this modified example, a solenoid that displaces a plunger in the direction D2 is introduced.

In the example of FIG. 31, a conveyance guide 506 includes the guide member 12 extending in the direction D1 and the direction D3. The guide member 12 is supported so as to be rotatable around a rotation axis 12a in the direction D2. A solenoid 28 is disposed on the lower side D2B of the guide member 12. A plunger 28a of the solenoid 28 is displaceable in the direction D2. The plunger 28a is coupled to a fifth pressing member 292 displaceable in the direction D2. The fifth pressing member 292 has a boss 292a at its upper end. The guide member 12 has a tubular hole 291. An inner surface of the tubular hole 291 acts as a pressed portion. The boss 292a of the fifth pressing member 292 fits in the tubular hole 291 of the guide member 12. It should be noted that a method of coupling the fifth pressing member 292 to the guide member 12 is not limited to the above-described method, and may be any method.

In the present modified example, when lowering the guide member 12, the controller energizes and causes the solenoid 28 to generate a magnetic field, and the solenoid 28 attracts the plunger 28a to the lower side D2B. Then, the fifth pressing member 292 is displaced toward the lower side D2B in conjunction with the plunger 28a, and the guide member 12 is lowered in conjunction therewith. In due course, when the plunger 28a stops at a most retracted position on the lower side D2B, the fifth pressing member 292 also stops, and the guide member 12 is positioned at the lower position.

Contrarily, when returning the guide member 12 to the home position, the controller stops energizing the solenoid 28 and dissipates the magnetic field. Then, the biasing force of the guide spring, not illustrated in FIG. 31, raises the guide member 12, and the guide member 12 contacts the regulating member to be positioned at the home position.

In the present modified example, the size of the image forming apparatus 500 in the direction D1 can be decreased, and manufacturing cost can be reduced by the reduction of the number of components.

In this specification, a scheme in which a solenoid is used as an element that constitutes a drive transmission mechanism for moving a guide member 12 has been mainly described. However, instead of a solenoid, another type of actuator such as, for example, a motor and a cam may be used. The placement of members constituting a drive transmission mechanism depends on restrictions on shape and size required for an image forming apparatus 500, and may be modified in any way.

### 10. Tenth Embodiment

In the first embodiment, an example has been described in which, in order to move the guide member 12 from the home position to the lower position, the pressed portion 12f located at the left side D1L of the guide member 12 is pressed by the reciprocating member 31. However, the technology according to the present disclosure is not limited to this example. In the tenth embodiment described in this section, in order to move a guide member 12 from the home position to the lower position, pressed portions located at both sides of the guide member 12 are simultaneously pressed by corresponding reciprocating members 31, 41.

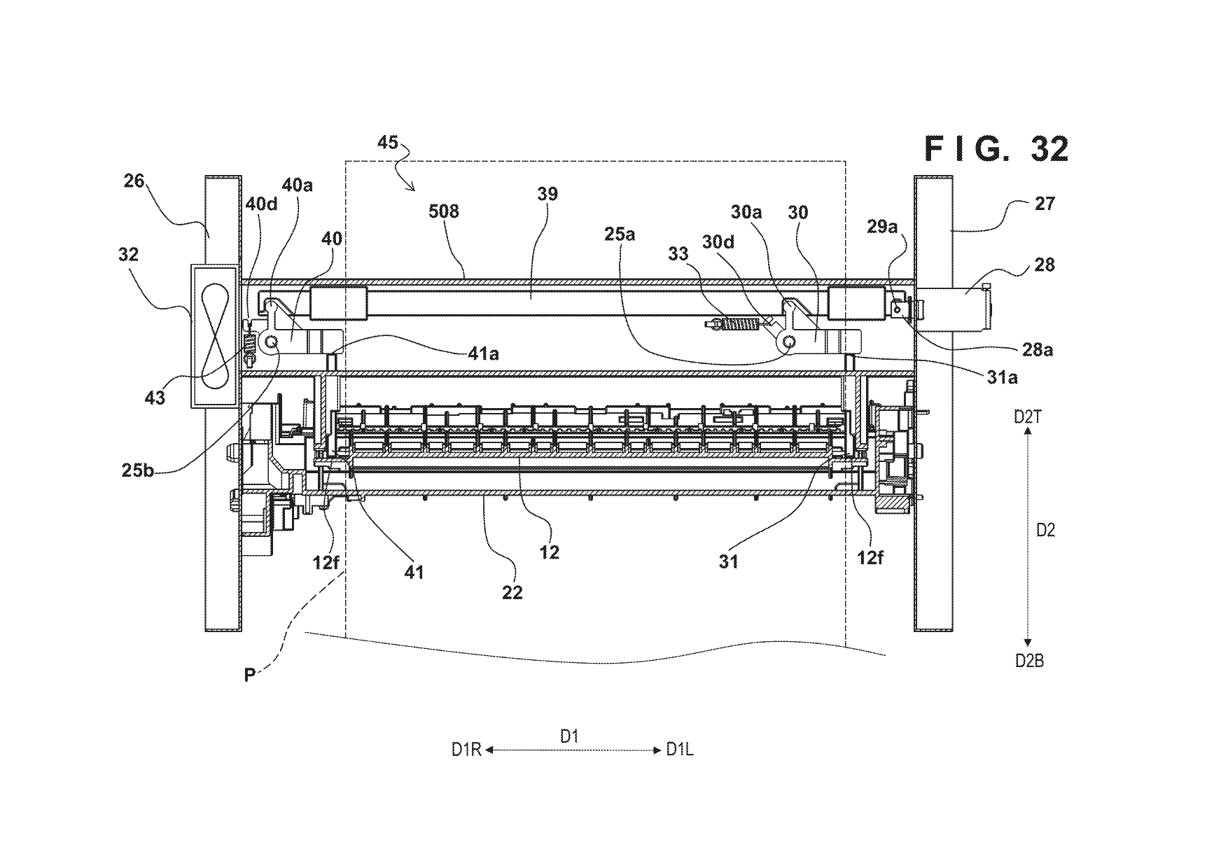

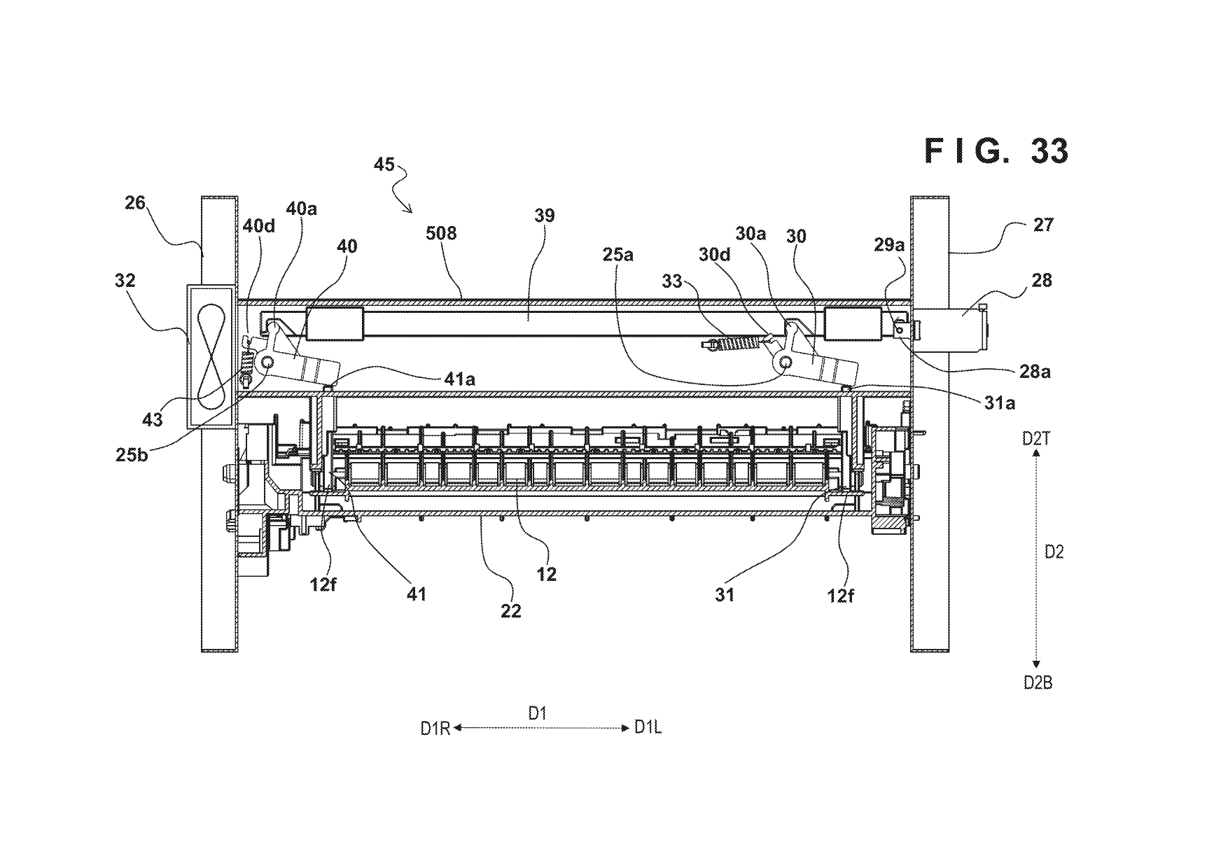

FIG. 32 is a cross-sectional view illustrating a drive transmission mechanism 45 for moving the guide member 12 in a state where the guide member 12 is at the home position. FIG. 33 is a cross-sectional view illustrating the drive transmission mechanism 45 for moving the guide member 12 in a state where the guide member 12 is at the lower position. In the present embodiment, the drive transmission mechanism 45 is realized by a scheme in which a solenoid 28 displaces a plunger 28a.

As illustrated in FIGS. 32 and 33, the solenoid 28 is attached to the left wall 27 of the housing 501. The solenoid 28 can generate a magnetic field based on electric power supplied from a power supply (not illustrated) and displace the plunger 28a in the direction D1. The drive transmission mechanism 45 includes, in addition to the solenoid 28 and the plunger 28a, a second pressing member 30, a reciprocating member 31, a tension spring 33, a horizontal pressing member 39, a seventh pressing member 40, a reciprocating member 41, and a tension spring 43. The plunger 28a, the second pressing member 30, the tension spring 33, the horizontal pressing member 39, the seventh pressing member 40, and the tension spring 43 are located inside a duct 508.

The horizontal pressing member 39 is supported by the duct 508 so as to be displaceable in the direction D1. The horizontal pressing member 39 is coupled to the plunger 28a at a coupling point 29a and is displaced in the direction D1 in conjunction with the movement of the plunger 28a in the direction D1.

The second pressing member 30 is supported so as to be rotatable around a rotation axis 25a disposed in the duct 508. The second pressing member 30 is coupled to the horizontal pressing member 39 at a coupling point 30a and rotates in conjunction with the motion of the horizontal pressing member 39.

The movement of the second pressing member 30 and the reciprocating member 31 in conjunction with the horizontal pressing member 39 is similar to the movement of the second pressing member 30 and the reciprocating member 31 in conjunction with the first pressing member 29 in the first embodiment.

The seventh pressing member 40 is supported so as to be rotatable around a rotation axis 25b disposed in the duct 508. The seventh pressing member 40 is coupled to the horizontal pressing member 39 at a coupling point 40a and rotates in conjunction with the movement of the horizontal pressing member 39. An end of the tension spring 43 is fixed to the duct 508, and the other end of the tension spring 43 is engaged with a spring hook 40d of the seventh pressing member 40. The tension spring 43 biases the seventh pressing member 40 counterclockwise in the figure, and the horizontal pressing member 39 is accordingly biased toward the right side D1R.

The reciprocating member 41 is a pressing member supported by the duct 508 so as to be displaceable in the direction D2. The reciprocating member 41, whose upper end has a contact point 41a in contact with the seventh pressing member 40, is displaced in the direction D2 in conjunction with the rotation of the seventh pressing member 40. A lower end of the reciprocating member 41 contacts a pressed portion 12f of the guide member 12. This causes the guide member 12 to move in conjunction with the advancement and retraction of the reciprocating members 31 and 41.

In the example of FIG. 32, the solenoid 28 does not generate a magnetic field, and biasing forces of the tension springs 33 and 43 maintain the horizontal pressing member 39 and the plunger 28a at rightmost positions on the right side D1R. In addition, the reciprocating members 31 and 41 are maintained at uppermost positions on the upper side D2T. In this state, the guide member 12, whose movement is regulated by regulating members, is positioned at the home position.

When lowering the guide member 12, a controller energizes and causes the solenoid 28 to generate a magnetic field, and the solenoid 28 attracts the plunger 28a to the left side D1L (see FIG. 33). Then, the horizontal pressing member 39 is displaced to the left side D1L in conjunction with the plunger 28a. The second pressing member 30 rotates, in conjunction with the horizontal pressing member 39, clockwise in the figure against the biasing force of the tension spring 33. The reciprocating member 31 advances to the lower side D2B in conjunction with the second pressing member 30. The lower end of the reciprocating member 31 pushes the pressed portion 12f down.

The seventh pressing member 40 also rotates, in conjunction with the horizontal pressing member 39, clockwise in the figure against the biasing force of the tension spring 43. The reciprocating member 41 advances to the lower side D2B in conjunction with the seventh pressing member 40. The lower end of the reciprocating member 41 contacts the pressed portion 12f of the guide member 12 midway through the advancement and pushes the pressed portion 12f down. In due course, when the plunger 28a stops at a leftmost position on the left side D1L, the reciprocating members 31 and 41 also stop advancing, and the guide member 12 is positioned at the lower position.

Contrarily, when returning the guide member 12 to the home position, the controller stops energizing the solenoid 28 and dissipates the magnetic field. Then, the biasing force of the tension spring 33 and the biasing force of the tension spring 43 cause the second pressing member 30 and the seventh pressing member 40 to rotate counterclockwise in the figure, respectively. Then, the horizontal pressing member 39 and the plunger 28a are displaced to the right side D1R, and the reciprocating members 31 and 41 retract to the upper side D2T. As a result, the guide member 12 is positioned at the home position again.

As described above, the drive transmission mechanism 45 is partially disposed in an internal space of the duct 508. Hence, it is possible to realize the mechanism for moving the guide member 12 while efficiently using space to avoid an increase in size of the image forming apparatus 500. However, in another embodiment, a drive transmission mechanism 45 may be disposed outside a duct 508. In that case, no member of the drive transmission mechanism 45 interferes with airflow in the duct 508, resulting in the higher heat dissipation efficiency by a fan 32.

It should be noted that, by disposing the drive transmission mechanism 45 on a member identical to the member having the contacted portions 24a, it is possible to eliminate influence of attachment error between members and enhance the accuracy of a positional relationship between the home position and the lower position of the guide member 12.

In FIG. 32, a contour of a recording material P conveyed by a conveyance guide 506 is partially illustrated by broken lines. Also in the present embodiment, the guide member 12 is wider than the recording material P. Thus, the two contacting portions 12e at both sides of the guide member 12 are located, in the direction D1, outside a region through which the recording material P passes (but inside the right wall 26 and the left wall 27). The reciprocating members 31 and 41 are also located, in the direction D1, outside the region through which the recording material P passes. Therefore, the entire mechanism for moving the guide member 12 does not interfere with conveyance of the recording material P. Also in the present embodiment, in the direction D3, the contacting portions 12e may be located on the downstream side D3D of the pressed portions 12f. This secures a sufficient length from the rotation axis 12a of the guide member 12 to the contacting portion 12e, resulting in the increased positioning accuracy of the guide member 12 at the home position and the higher conveyance performance for recording materials.

As with the reciprocating member 31, the lower end of the reciprocating member 41 (and the corresponding pressed portion 12f) is desirably formed of a material having high wear resistance such as, for example, polyacetal (POM). This can prevent scraping, wear, and abnormal sound due to the sliding from occurring.

According to the present embodiment, the guide member 12 is pressed equally at both the right side D1R and the left side D1L of the guide member 12, which can prevent deformation of the guide member 12. That is, since difference in height between left and right does not occur at a downstream end of the guide member 12, it is possible to stably form space for accepting downward warp of a recording material in the state where the guide member 12 is at the lower position and further enhance the conveyance performance for recording materials.

### 11. Eleventh Embodiment

Although the above-described embodiments have been described mainly with an example in which a recording material is conveyed substantially horizontally from the transfer nip N_{T} to the fixing nip N_{F}, the technology according to the present disclosure is not limited to this example.

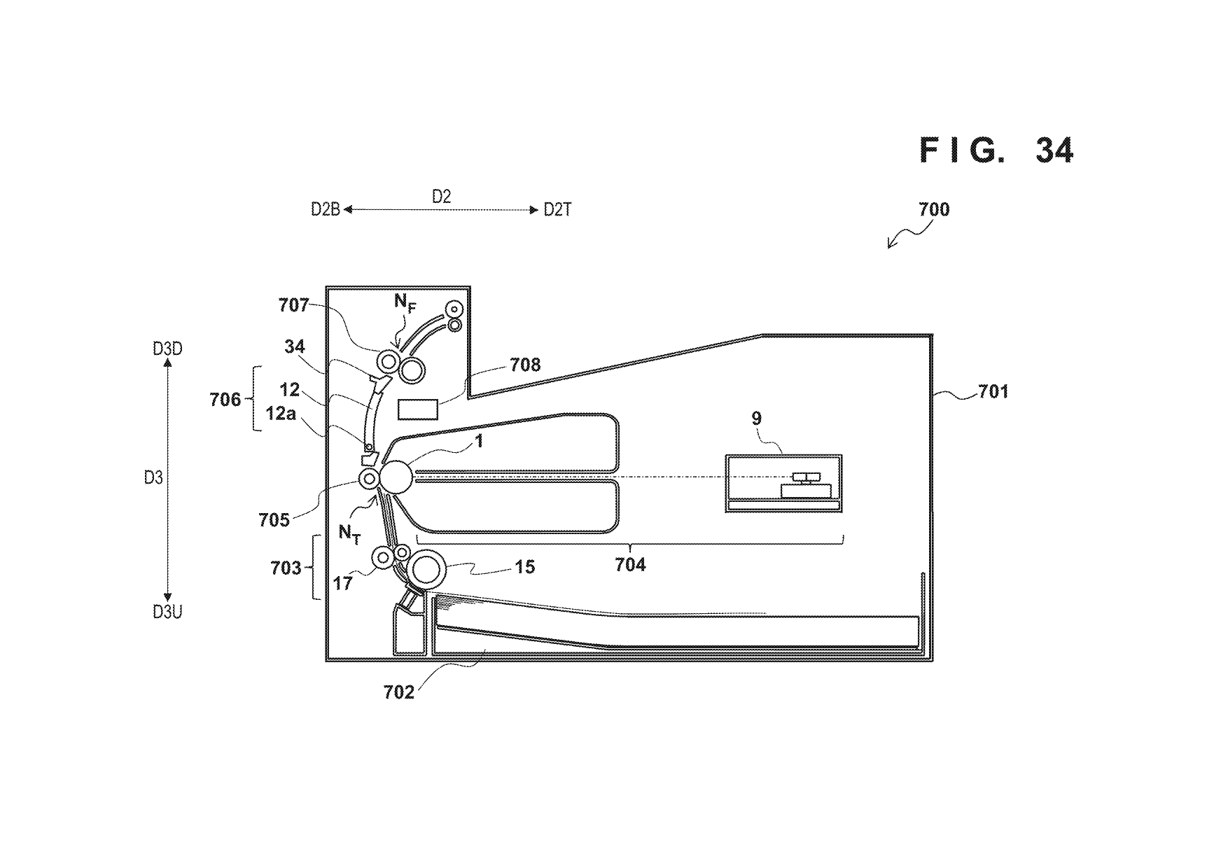

FIG. 34 is a schematic cross-sectional view illustrating an example of a schematic configuration of an image forming apparatus 700 in an eleventh embodiment. Referring to FIG. 34, the image forming apparatus 700 includes a housing 701, a cassette 702, a conveyance mechanism 703, an image forming unit 704, a transfer roller 705, a conveyance guide 706, a fixing unit 707, and a regulating member 708. The housing 701 accommodates the cassette 702, the conveyance mechanism 703, the image forming unit 704, the transfer roller 705, the conveyance guide 706, the fixing unit 707, and the regulating member 708.

The cassette 702 is a container unit that contains a bundle of recording materials. The conveyance mechanism 703 includes rollers such as, for example, a feeding roller 15 and a registration roller 17, conveys a recording material picked up from the cassette 702 along a conveyance path, and sends the recording material to a transfer nip N_{T}. As with the case of the above-described image forming unit 504, the image forming unit 704 forms images by an electrophotographic method.

The transfer roller 705 serves as a transfer unit that transfers a toner image formed on a surface of a photosensitive drum 1 onto the recording material at the transfer nip N_{T}.

The conveyance guide 706 is a guide unit that guides the recording material having a toner image transferred thereon from the transfer nip N_{T} toward a fixing nip N_{F} of the fixing unit 707.

The conveyance guide 706 includes a guide member 12 extending in a width direction D1 of the guided recording material (not illustrated in FIG. 34) and a length direction D3 of the guided recording material. The guide member 12 is supported so as to be movable between two different positions in a movement direction D2 that is different from the width direction D1 and the length direction D3. In the present embodiment, unlike the above-described embodiments, the direction D2 is parallel to a bottom surface of the housing 701, and the direction D3 is orthogonal to the bottom surface of the housing 701.

The fixing unit 707 conveys the recording material that has reached the fixing nip N_{F} in a sandwiching manner while heating and pressurizing the recording material. This causes toner of the transferred toner image on the recording material to melt and the toner image is fixed to the recording material. The recording material that has passed through the fixing nip N_{F} is discharged to a discharge tray.

In the present embodiment, the guide member 12 of the conveyance guide 706 is configured such that the guide member 12 can move between a first position and a second position in the direction D2. The image forming apparatus 700 further includes an elastic member (not illustrated) biasing the guide member 12 from the second position toward the first position (for example, rightward in the figure). The regulating member 708 is contacted by the guide member 12 at the first position and regulates the movement of the guide member 12 in the direction D2. In addition, the image forming apparatus 700 includes a pressing member (not illustrated) that moves the guide member 12 from the first position to the second position by pressing the guide member 12, and a driving unit (not illustrated) that drives the pressing member. The driving unit reciprocates the pressing member under control of a controller, resulting in the guide member 12 moving between the first position and the second position by the pressing force from the pressing member and the biasing force from the elastic member.

Any feature that has been described in relation to the first to tenth embodiments may be combined with the image forming apparatus 700 of the eleventh embodiment in any form, and respective advantages of the embodiments can be equally enjoyed in such a combination.

According to the present disclosure, the recording material can be stably conveyed toward the fixing apparatus in an image forming apparatus.

### 12. Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012297, filed January 28, 2025 which is hereby incorporated by reference herein in its entirety.

What is claimed is:

1. An image forming apparatus comprising:
a transfer unit configured to transfer a toner image to a recording material at a transfer position;
a fixing unit configured to fix the toner image to the recording material at a fixing position;
a guide unit configured to guide the recording material from the transfer position toward the fixing position, the guide unit including a guide member extending in a width direction and a length direction of the guided recording material, the guide member being supported so as to be movable between a first position and a second position in a movement direction that is different from the width direction and the length direction;
an elastic member configured to bias the guide member from the second position toward the first position; and
at least one regulating member configured to regulate movement of the guide member in the movement direction by contacting the guide member when the guide member is positioned in the first position,
wherein the guide member includes a pressed portion configured to receive a pressing force for movement of the guide member from the first position to the second position, and a plurality of contacting portions configured to contact the regulating member at different positions in the width direction, and
wherein the pressed portion and the plurality of contacting portions are formed integrally with the guide member.

2. The image forming apparatus according to claim 1, wherein the plurality of contacting portions include two contacting portions that are located respectively at both ends of the guide member in the width direction.

3. The image forming apparatus according to claim 2, wherein the two contacting portions are located, in the width direction, outside a region through which the recording material passes.

4. The image forming apparatus according to claim 2, wherein at least a first contacting portion out of the two contacting portions is formed in a flexible shape to mitigate a collision sound between the guide member and the at least one regulating member.

5. The image forming apparatus according to claim 4, wherein the first contacting portion protrudes in the movement direction beyond a second contacting portion that is different from the first contacting portion out of the two contacting portions, and the first contacting portion is configured to collide with the at least one regulating member earlier than the second contacting portion when the guide member moves from the second position to the first position.

6. The image forming apparatus according to claim 4, wherein a second contacting portion that is different from the first contacting portion out of the two contacting portions is formed in a flexible shape to mitigate, together with the first contacting portion, a collision sound between the guide member and the at least one regulating member.

7. The image forming apparatus according to claim 2, wherein the guide unit further includes a first compressible member disposed on at least a first contacting portion out of the two contacting portions,
the first contacting portion is configured to contact the at least one regulating member via the first compressible member, and
the first compressible member is configured to mitigate a collision sound between the guide member and the at least one regulating member.

8. The image forming apparatus according to claim 7, wherein no compressible member is disposed on a second contacting portion that is different from the first contacting portion out of the two contacting portions, and
wherein the first contacting portion is configured to collide with the at least one regulating member via the first compressible member earlier than the second contacting portion when the guide member moves from the second position to the first position.

9. The image forming apparatus according to claim 7, wherein the guide unit further includes a second compressible member disposed on a second contacting portion that is different from the first contacting portion out of the two contacting portions,
the second contacting portion is configured to contact the at least one regulating member via the second compressible member, and
the second compressible member is configured to mitigate, together with the first compressible member, a collision sound between the guide member and the at least one regulating member.

10. The image forming apparatus according to claim 2, wherein the at least one regulating member includes a first contacted portion configured to be contacted by at least a first contacting portion out of the two contacting portions, the first contacted portion being formed in a flexible shape, and
wherein the first contacted portion is configured to mitigate a collision sound between the guide member and the at least one regulating member.

11. The image forming apparatus according to claim 2, wherein the at least one regulating member further includes a first compressible member disposed on a first contacted portion configured to be contacted by at least a first contacting portion out of the two contacting portions,
the first contacting portion is configured to contact the first contacted portion via the first compressible member, and
the first compressible member is configured to mitigate a collision sound between the guide member and the at least one regulating member.

12. The image forming apparatus according to claim 1, further comprising:
a first elastic member configured to bias the guide member from the second position toward the first position at a first end in the width direction and a second elastic member configured to bias the guide member from the second position toward the first position at a second end in the width direction,
wherein the pressed portion is located at the first end of the guide member, and
the first elastic member has a larger modulus of elasticity than the second elastic member.

13. The image forming apparatus according to claim 1, further comprising:
a pressing member configured to move the guide member from the first position to the second position by pressing the pressed portion; and
a driving unit configured to drive the pressing member to press the pressed portion.

14. The image forming apparatus according to claim 1, wherein the guide member further includes a plurality of ribs that extend in the length direction parallel to each other and are configured to support the recording material, and a conductive member configured to attract the recording material to the guide member with a voltage applied in a state where the conductive member is located apart from the recording material supported by the plurality of ribs.

15. The image forming apparatus according to claim 1, further comprising:
a first fixed guide disposed in a fixed manner with respect to the fixing unit and configured to guide the recording material passed from the guide unit to the fixing position,
wherein, in a conveyance direction of the recording material, an upstream end of the first fixed guide is located in an upstream side from a downstream end of the guide member at the second position.

16. The image forming apparatus according to claim 1, further comprising:
a second fixed guide disposed in a fixed manner on a frame supporting the guide member; and
a first fixed guide disposed in a fixed manner with respect to the fixing unit and configured to guide the recording material passed from the second fixed guide to the fixing position,
wherein, in a conveyance direction, an upstream end of the second fixed guide is located in an upstream side from a downstream end of the guide member at the second position, and
in the conveyance direction, an upstream end of the first fixed guide is located in an upstream side from a downstream end of the second fixed guide.
